(19) United States
(12) Patent Application Publication
(10) Pub. No.: US 2023/0279170 A1
(43) Pub. Date: Sep. 7, 2023

(54) CHIRAL-SUBSTITUTED POLY-N-VINYLPYRROLIDINONES AND COMPLEXES WITH BIMETALLIC NANOCLUSTERS AND USES THEREOF

(71) Applicant: Kansas State University Research Foundation, Manhattan, KS (US)

(72) Inventor: Duy H. Hua, Manhattan, KS (US)

(21) Appl. No.: 18/177,488

(22) Filed: Mar. 2, 2023

Related U.S. Application Data
(60) Provisional application No. 63/315,723, filed on Mar. 2, 2022.

(51) Int. Cl. C08F 226/10; B01J 35/00; B01J 37/00; B01J 23/44; B01J 23/52; B01J 23/72

(52) U.S. Cl. CPC C08F 226/10; B01J 35/0013; B01J 37/0072; B01J 23/44; B01J 23/52; B01J 23/72

(57) ABSTRACT

Synthesis of chiral polyvinylpyrrolidinone (CSPVP) compounds, complexes of CSPVP with a core species, such as a bimetallic nanocluster catalyst, and selective C—H bond oxidation reactions utilizing such complexes are disclosed. These reaction products can be used as reagents in the synthesis of complex organic molecules, such as bioactive products, and C—H bond oxidation of complex molecules including various drugs and natural products.

### CROSS-REFERENCE TO RELATED APPLICATION

This application claims the benefit of U.S. Provisional Patent Application No. 63/315,723, filed Mar. 2, 2022, entitled CHIRAL-SUBSTITUTED POLY-N-VINYLPYRROLIDINONES AND COMPLEXES WITH BIMETALLIC NANOCLUSTERS AND USES THEREOF, which is incorporated by reference herein in its entirety.

### STATEMENT REGARDING FEDERALLY SPONSORED RESEARCH OR DEVELOPMENT

This invention was made with government support under Grant No. CHE-1662705 awarded by the National Science Foundation, Grant No. 1826982 awarded by the National Science Foundation, Grant No. CHE-2018414 awarded by the National Science Foundation, and Grant No. R01 GM128659 by the National Institutes of Health General Medical Science. The content is solely the responsibility of the inventors and does not necessarily represent the official views of the National Institutes of Health. The government has certain rights in the invention.

### BACKGROUND OF THE INVENTION

### Field of the Invention

The present invention is generally directed toward chiral substituted polyvinylpyrrolidinone (CSPVP) compounds that can be, among other things, complexed with catalytic materials, such as bimetallic nanoclusters, to provide catalysts for various asymmetric oxidation reactions producing reactions products having a high degree of optical purity and high chemical yields. In certain embodiments, the present invention is particularly concerned with the synthesis and characterization of CSPVP compounds, and reaction schemes and products utilizing catalysts comprising CSPVP compounds.

### Description of the Prior Art

The application of catalysts and environmentally friendly chemicals such as bimetallic nanoclusters Cu/Au or Pd/Au in C(sp³)-H oxidation of natural products and complex compounds, leading to bioactive molecules, may contribute to a part of the solutions for climate challenge. The rise of global population increases demands of energy, food, health care, transportation, etc. Catalysts enhance the rates of reactions by lowering their activation energies compared with those of uncatalyzed reactions, thereby a reduction of energy and lesser or cheaper reagents are needed. Late-stage C—H oxidation of complex bioactive molecules may provide pharmaceutical and fine chemical industries a greener and efficient process. Bimetallic nanoclusters require a stabilizer to maintain their nano-size structure. In addition to achiral stabilizers, chiral stabilizers have been explored for various possible applications. Chiral ligands, chiral surfactants, chiral DNA templates, and chiral polymers have been used to produce nanoclusters in which the metal atoms, such as gold or palladium, may organize into nano-sized asymmetrical structures. Chiral nanoclusters have been investigated in asymmetric catalysis, chiral recognition, and chiroptics. Chiral gold or palladium nanoclusters have been reported, and the studies of chiral polymers and polymeric chiral catalysts have progressed steadily in recent years. The synthesis of bimetallic nanoclusters encapsulated by chiral substituted poly-N-vinylpyrrolidinones (CSPVPs) has been reported, but the application is still in its infancy.

Catalytic oxidation of non-activated C—H groups remains one of the most challenging transformations in synthetic organic chemistry. Oxidation using enzymes such as P450 oxygenases and homogeneous catalysts were usually explored, since site selectivity and enantioselectivity are often achieved. In the former case, different classes of substrate molecules require the finding of proper oxygenases to affect the oxidation, and in the latter case, ligands in the organometallic or organo-catalysts are not readily available commercially in many cases and may require development of specific catalysts for particular C—H oxygenation reaction. Heterogeneous catalysts are readily prepared in general and can be separated from the products and recovered, hence, they are preferred by the industry. However, heterogeneous catalysts are less specific and often produce side or over oxidized products. Bimetallic nanoclusters are considered heterogeneous catalysts even though they are soluble in water and polar organic solvents such as CH₃CN and DMF. Due to numerous aliphatic C—H bonds in a molecule, a low dissociation-energy bond or a directing group is needed in controlling the regioselectivity of the oxidation. A review on gold and gold-based bimetal nanoclusters including characterizations and proposed mechanisms on oxidation reactions has been reported, but with limited applications.

### SUMMARY OF THE INVENTION

Embodiments of the present invention are generally directed toward chiral substituted polyvinylpyrrolidinone (CSPVP) compounds, methods of synthesizing the CSPVP compounds, and methods utilizing the CSPVP compounds in catalysts for C—H oxidation reactions and products resulting therefrom. Exemplary CSPVP nanocluster catalysts and their use in C—H oxidation reactions are depicted in Scheme 1.

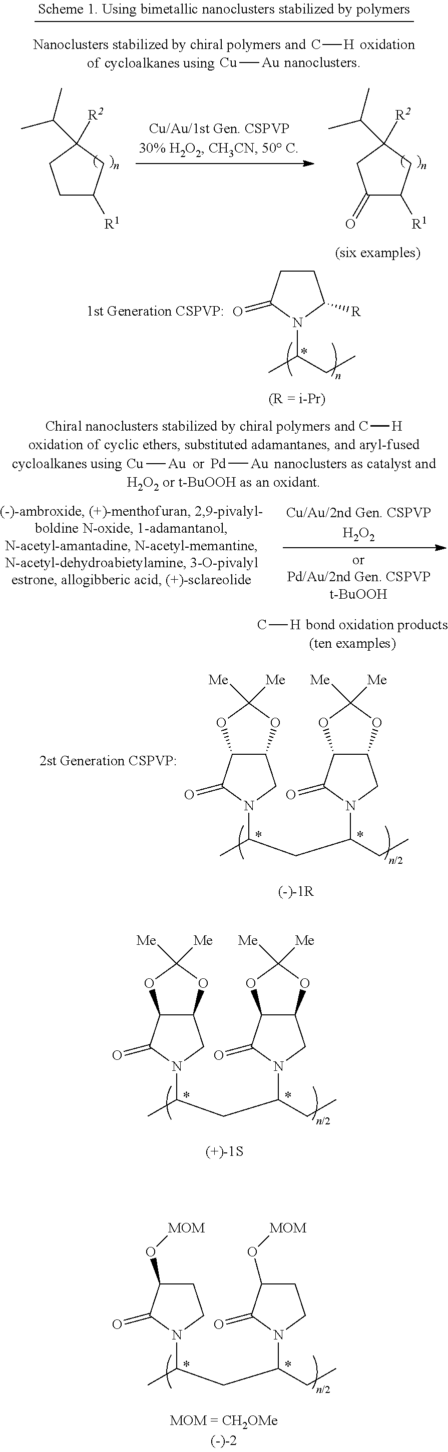

Earlier works reported C—H oxidation of six cycloalkanes using only Cu/Au stabilized by CSPVPs, derived from amino acids, and H₂O₂ as an oxidant (Scheme 1, top reaction). Described herein is the synthesis of second-generation CSPVPs, derived from inexpensive chemicals such as D-isoascorbic acid, D-ribose, and L-malic acid, according to certain embodiments of the present invention. They were utilized in the stabilization of Cu/Au or Pd/Au bimetallic nanoclusters and oxidation of ten cyclic molecules including cyclic ethers, rigid molecules, and bioactive natural products, using hydrogen peroxide or t-butyl hydroperoxide as an oxidant (Scheme 1, bottom reaction). The stereochemistry of the polymer chains were studied by ¹³C NMR spectroscopy, polymer chain lengths by high-resolution mass spectrometry (HRMS), and chiroptical responses of the bimetallic nanoclusters by circular dichroism (CD).

Also described herein are investigations into PVP-based polymers possessing solubilities in both water and organic solvents for encapsulation of bimetallic nanoclusters and catalytic oxidation reactions, according to certain embodiments of the present invention. The amide functions of PVP needed for binding to the nano-sized metal clusters, resulting in stabilization of the nanoclusters. Alkyl and oxygen atom(s) containing substituents, attached to the pyrrolidinone ring, enhance polymer's water solubility and interaction with hydrophobic substrate molecule. The substituent(s) may induce substrate facial recognition, leading to possible selective C—H group oxidation. Previously reported CSPVPs, derived from the polymerization of (R)—C5-substituted N-vinylpyrrolidinones, possess a substituent distanced from the C2 carbonyl group of the amide function, needed for complexation to the metal nanoclusters. Therefore, two new classes of CSPVPs were investigated possessing asymmetric centers at C3 and C4 or C3 alone of the pyrrolidinone ring and examined their effects on the polymer chain stereochemistry, stabilization, and induction of chirality in the bimetallic nanoclusters as well as the effectiveness in catalytic C—H group oxidation. In addition, the availability of both opposite chiral polymers, (−)-1R and (+)-1S (see Scheme 2), allows the examination of match and mismatch in stereochemistry with chiral substrates, which may shed light into the scope and applicability of the systems.

In one embodiment, there is provided a method of synthesizing a chiral substituted polyvinylpyrrolidinone compound. The method comprises reacting L-(S)-malic acid to produce a chiral vinyl lactam and polymerizing the chiral vinyl lactam to produce the chiral substituted polyvinylpyrrolidinone compound.

### BRIEF DESCRIPTION OF THE FIGURES

FIG. 1 depicts the molecular structure of (−)-6 obtained from a single-crystal X-ray analysis;

FIG. 2A is a graph showing the overlay of circular dichroism (CD) spectra of (−)-Cu:Au (3:1)/-1R and (+)-Cu:Au (3:1)/-1S;

FIG. 2B is a graph showing the overlay of circular dichroism (CD) spectra of (−)-Pd:Au (3:1)/-1R and (+)-Pd:Au (3:1)/-1S in 1.5 mM in deionized water;

FIG. 3 depicts the molecular structure of N-4-hydroxy-3,5-dimethyl-adamantan-1-yl acetamide (35), obtained from a single-crystal X-ray analysis;

FIG. 4 depicts the molecular structure of allogibberic acid (46), obtained from a single-crystal analysis;

FIG. 5 depicts the NOE correlations from 2D NOESY NMR spectrum of compound 47; and

FIG. 6 depicts the molecular structure of lactone 47, obtained from a single-crystal X-ray analysis.

### DETAILED DESCRIPTION

The present invention is generally directed toward chiral substituted polyvinylpyrrolidinone (CSPVP) compounds that can be, among other things, complexed with catalytic materials, such as bimetallic nanoclusters, to provide catalysts for various asymmetric oxidation reactions producing reaction products having a high degree of optical purity and high chemical yields.

In one embodiment, the present invention is directed toward a chiral-substituted poly-N-vinylpyrrolidinone having the general formula

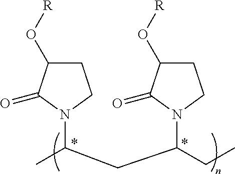

wherein each R is independently selected from OH, and aliphatic or aromatic functional groups, and n is greater than 50.

In certain embodiments, the CSPVPs are synthesized from L-(S)-malic acid. In certain such embodiments, the CSPVPs are synthesized from L-(S)-malic acid according to reaction Scheme 3, described below.

In certain embodiments, the chiral substituted polyvinylpyrrolidinone compound has the formula

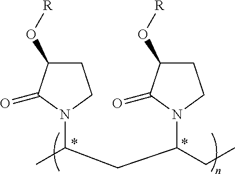

wherein each R is individually selected from the group consisting of OH and C1-C30 aliphatic and aromatic functional groups, and n is greater than 50. In a preferred embodiment, each R is CH₂OCH₃.

In certain embodiments, n is from 50 to 500. In certain same or different embodiments, the compound has a molecular weight of at least 50,000 g/mol.

Embodiments of the present invention also pertain to complexes comprising the chiral substituted polyvinylpyrrolidinone compounds described herein bound to a core species selected from the group consisting of nanoparticle materials, proteins, DNA, siRNA, and dsRNA. In certain embodiments, the complex comprises a nanoparticle cluster, and particularly a nanoparticle cluster that comprises one or more metals. In certain embodiments, the one or more metals are selected from the group consisting of Au, Pd, Cu, Rh, Ce, Mo, Ni, Ru, W, and Fe. In one or more embodiments, the nanoparticle cluster is bimetallic. Preferably, the bimetallic nanoparticle cluster is selected from the group consisting of Pd/Au, Cu/Au, Rh/Au, Ce/Au, Mo/Au, W/Au, Ru/Au, and Fe/Au. In one or more embodiments, the chiral substituted polyvinylpyrrolidinone compound encapsulates the core species.

The complexes according to the present invention can be used in asymmetric oxidation reactions involving organic molecules. In such reactions, the organic molecule is reacted with one or more reagents in the presence of a complex comprising a chiral substituted polyvinylpyrrolidinone compound as described herein bound to a metallic nanocluster to produce chiral molecules. In certain embodiments, the organic molecule is an alkene or cycloalkene, and the reaction results in the oxidation of a carbon-carbon double bond producing chiral diols. In certain other embodiments, the organic molecule is an alkane or cycloalkane, and the reaction oxidizes a carbon-hydrogen bond in the alkane or cycloalkane to form a chiral alcohol or ketone molecule possessing a hydroxyl or carbonyl functional group. In certain other embodiments, the organic molecule comprises an alkene, and the reaction comprises a ring-closing reaction resulting in the formation of a lactone or lactam. In one or more embodiments, the reaction generates a reaction product comprising two enantiomers, and wherein the enantiomeric excess of one of the enantiomers is greater than 50%. In certain embodiments, the reaction generates a reaction product that is enantiopure. In certain embodiments, the reaction generates a reaction product having a hydroxyl or ketone functional group, and wherein the reaction product is further reacted with an organic compound in which the organic compound is added to the reaction product at the site of the hydroxyl or ketone functional group.

In one or more embodiments of the present invention, a compound is produced by reacting a substrate with one or more reagents in the presence of a complex comprising a chiral substituted polyvinylpyrrolidinone compound as described herein bound to a metallic nanocluster. In certain embodiments, the compound comprises an enantiomeric excess of greater than 80% without having undergone a separate separation step to isolate a particular enantiomer.

Other exemplary CSPVP compounds, complexes, and catalysts, as well as methods of synthesizing and using the same are described in WO 2017/172763 and WO 2020/163295, which are each incorporated by reference herein in their entireties.

In certain embodiments, the catalytic materials comprising the CSPVPs are quite stable permitting them to be used in reactions conducted over extended periods of time and under elevated temperature conditions. For example, the catalytic materials resist degradation at reaction temperatures of 50° C., 70° C., 100° C. or higher, for periods of 2 days, 3 days, 5 days, 7 days or more. In addition, the catalytic materials are storage stable exhibiting a shelf-life at room temperature (approximately 25° C.) of at least 6 months, at least 1 year, or at least 1.5 years.

Nanoparticle clusters (also referred to as nanoclusters) are useful as catalysts in numerous chemical reactions. However, the catalytic activity of the nanocluster is largely dependent upon the material not aggregating into larger particles, which many nanoclusters will naturally tend to do in certain reaction environments. The CSPVP molecules described herein can also be used as stabilizers for various core species including nanoclusters, nanoparticles, and biomolecules such as DNA, RNA (e.g., siRNA and dsRNA), and proteins. Chiral recognition using chiral PVP can be achieved from the interaction with the biomolecule, thereby allowing either selective isolation or detection or delivery of specific biomolecules. Hence the present invention can be used in separation, detection, and nanodelivery of biomolecules.

Nanoclusters can be prepared by a number of methods including molecular beams, chemical reduction, thermal decomposition of transition metal complexes, ion implantation, electrochemical synthesis, radiolysis, sonochemical synthesis, and biosynthesis. In one embodiment, the nanoclusters comprise a metal. In preferred embodiments, the metal is present in its elemental, or zero valence, form, either alone as a monometal catalyst or alloyed with other metals. In particular embodiments, the nanoclusters comprise one or more transition metals, especially a transition metal selected from the group consisting of Au, Pd, Cu, Rh, Ce, Mo, Ni, Ru, W, and Fe. In certain embodiments, the nanoclusters are generally spherical and exhibit average particle diameters of from about 1 to about 10 nm, from about 2 to about 50 nm, or from about 3 to about 25 nm.

In certain embodiments, the nanoparticles comprise bimetallic materials. Exemplary bimetallic materials comprise those including Au as one of the metallic species due to its high electron-positivity, catalytic activity, and synergistic electronic effects, such as Pd/Au, Cu/Au, Ce/Au, Mo/Au, W/Au, Ni/Au, Rh/Au, Ru/Au, and Fe/Au. It was discovered that the bimetallic materials Pd/Au and Cu/Au when formed into CSPVP-stabilized nanoclusters are particularly preferred. In particular, Pd/Au-CSPVP nanoclusters are particularly suitable for the oxidation of alkenes. Cu/Au-CSPVP nanoclusters are particularly suitable for oxidation of cycloalkanes and for cleaving terminal C═C. The electronegativity values for Au, Pd, and Cu are 2.54, 2.20, and 1.90, respectively, suggesting that in the Pd/Au and Cu/Au bimetallic nanoclusters gold pulls electrons from (or deplolarizes) Pd or Cu and subsequently induces a greater positive Pd or Cu atom. This in turn affords a more electrophilic Pd or Cu resulting in a more reactive electron acceptor metal atom for the reactions with alcohols, alkenes, and alkanes.

In certain embodiments, the ratio between the first transition metal component, preferably Pd or Cu, and Au can be from about 0.5:1 to about 5:1, from about 1:1 to about 2:1 to about 3:1, or about 3:1. In certain preferred embodiments comprising Pd/Au-CSPVP nanoclusters, the ratio of Pd:Au:CSPVP is about 30:10:1.

The bimetallic-CSPVP nanoclusters can be used to catalyze a number of oxidation reactions to provide reaction products having a high level of optical purity. More specifically, the nanoclusters catalyze reactions that are highly enantioselective providing a relatively high enantiomeric excess of one enantiomer. Enantiomeric excess is defined as the percent of one enantiomer minus the percent of the other enantiomer. In certain embodiments, the reactions catalyzed with the nanoclusters described herein result in an enantiomeric excess of greater than 80%, greater than 85%, greater than 90%, greater than 95%, or greater than 98%.

Exemplary oxidation reactions that can be performed include enantioselective oxidation of cycloalkanediols, asymmetric oxidation of alkenes, asymmetric oxidation of unactivated C—H bonds, desymmetrized ring closing reactions, and regioselective C—H oxidation of complex molecules. A number of these reactions are described in further detail below. The reaction products formed via the asymmetric oxidation reactions can be quite useful as reagents in the synthesis of various bioactive compounds, such as synthesized bioactive natural products. Certain functional groups of the reaction products can be readily substituted with, for example, other organic groups so as to provide the desired bioactive compound. These reaction products and the bioactive compounds produced therefrom exhibit a high level of optical purity without having undergone a separate separation step to isolate a particular enantiomer.

In certain embodiments, the bimetallic-CSPVP nanoclusters can be used in a method of producing an oxidized product by contacting a bioactive natural material with a catalyst comprising the nanoclusters. In certain embodiments, the bioactive natural material is selected from the group consisting of ambroxide, menthofuran, boldine, adamantanol, N-acetyl-amantadine, N-acetyl-memantine, 3-O-pivaloyl estrone, N-acetyl-dehydroabietylamine, 9-allogivveric acid, and indane-1-carboxylic acid. In certain such embodiments, the method comprises a C—H oxidation reaction of the bioactive natural material.

In certain embodiments, CSPVP catalyst materials may be used to produce a product compound having the formula

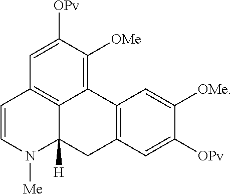

One method of forming the above compound is through the reaction scheme depicted below utilizing boldine as a starting reagent.

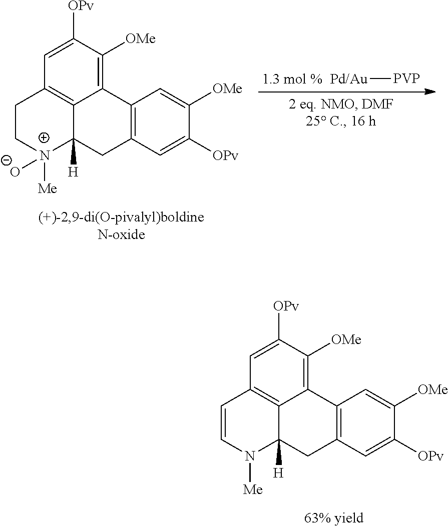

In certain embodiments, the method comprises a reaction scheme such as depicted in Scheme 4, below. In particular, the method may comprise reacting boldine with pivaloyl chloride to form an intermediate compound 22; (ii) oxidizing the intermediate compound 22 with m-chloroperbenzoic acid (MCPBA) to produce boldine N-oxide compound 23; and (iii) oxidizing the boldine N-oxide compound 23 in the presence of a catalyst comprising a CSPVP compound, such as those described herein, to produce the product compound.

In certain embodiments, CSPVP catalyst materials may be used to produce a product compound having the formula

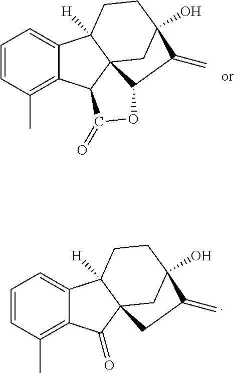 [SMILES: C=C1[C@@H]2OC(=O)[C@H]3c4c(C)cccc4[C@H]4CC[C@]1(O)C[C@]423 ; C=C1C[C@]23C[C@@]1(O)CC[C@@H]2c1cccc(C)c1C3=O]

One method of forming the above compounds is through the reaction scheme depicted below utilizing allogibberic acid as a starting reagent.

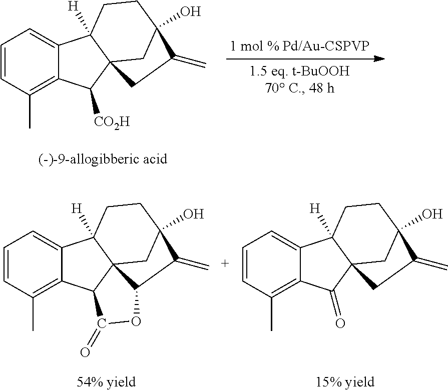

In certain embodiments, the method comprises a reaction scheme such as depicted in Scheme 5, below. In particular, the method may comprise oxidizing (−)-9-allogibberic acid in the presence of a catalyst comprising a chiral substituted polyvinylpyrrolidinone compound.

### Syntheses of Chiral N-vinylpyrrolidinones (−)-6, (+)-10, and (−)-13

The synthesis of the CSPVPs according to exemplary embodiments of the present invention is illustrated in Schemes 2 and 3, below.

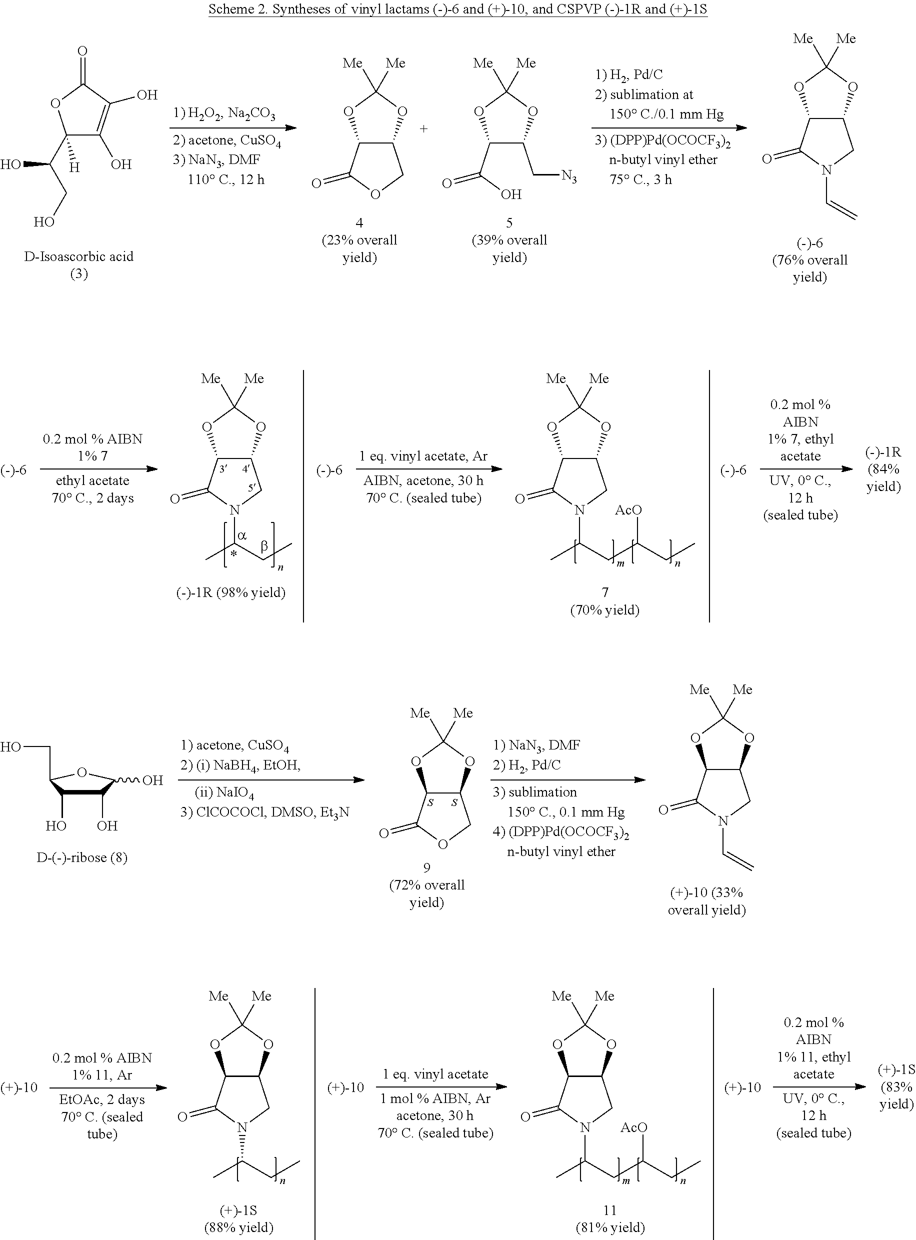

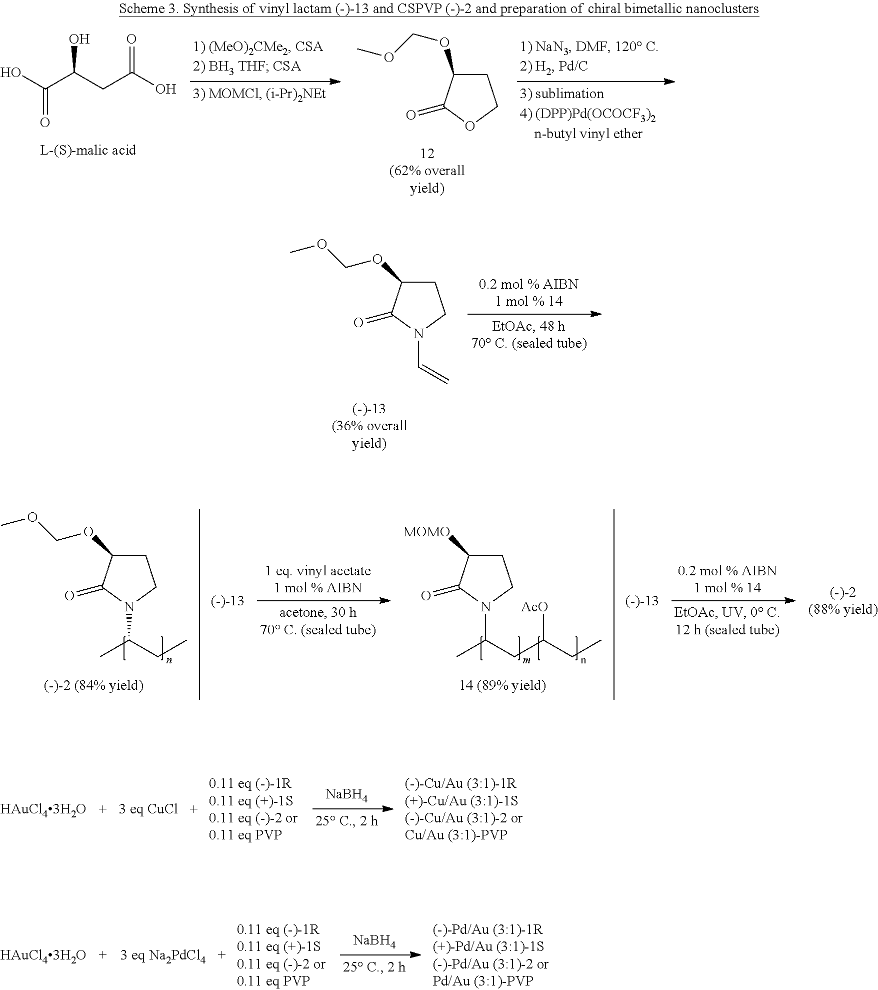

The availability of both enantiomers (R)- and (S)-CSPVP allows the study of chiroptical responses of the encapsulated bimetallic nanoclusters. Hence, enantiomers, N-vinylpyrrolidinone (−)-6 and (+)-10, possessing opposite asymmetric centers at C3 and C4 of the pyrrolidinone ring, and (S)-(−)-13, possessing asymmetric center at C3, were synthesized, and the corresponding chiral polymers were produced via free-radical polymerization processes (see Schemes 2 and 3). Without being bound by any theory, the stereogenic center(s) may provide an “enantiomorphic-site control” effect to generate stereo-regulated polymers in the polymer main chain, thereby producing a structurally defined polymer framework and improving the stereoselectivity of the oxidation reactions.

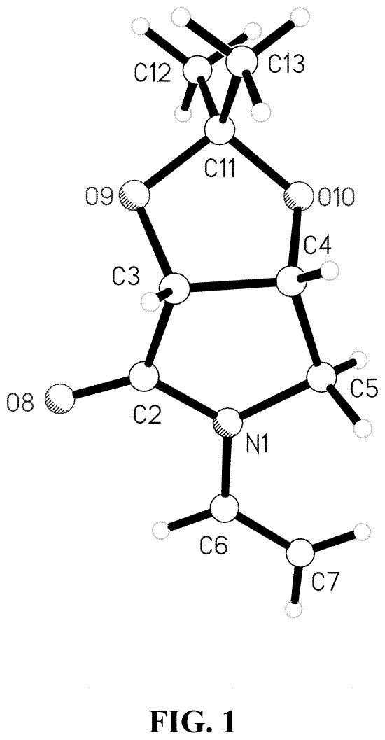

The required precursors, lactone 4 and azide 5, were synthesized by modification of a reported procedure, via a sequence of reactions (Scheme 2): (i) oxidative cleavage of D-isoascorbic acid (3) with 30% hydrogen peroxide and sodium carbonate (93% yield); (ii) acetonide formation of the resulting D-erythronolactone with acetone and copper sulfate (lactone 4; 78% yield); and (iii) ring opening of the lactone with sodium azide in DMF at 110° C. (azide 5, 54% yield). In the sodium azide reaction, lactone 4 was recovered in 32%, which likely derived from the nucleophilic addition of azide ion onto the carbonyl group of 4 followed by ring opening. The resulting acyl azide undergoes ring closure upon aqueous work-up to regenerate lactone 4. Reduction of the azido function of 5 with hydrogen and Pd/C in methanol (91% yield) followed by sublimation at 150° C./0.1 mm Hg (97% yield), and N-vinylation with 5 mol % of 4,7-diphenyl-1,10-phenanthroline palladium bis(trifluoroacetate) [(DPP)Pd(OCOCF₃)₂] and n-butyl vinyl ether at 75° C. gave vinyllactam (−)-6 in an 86% yield. The structure of (−)-6 was unequivocally characterized by a single-crystal X-ray analysis (FIG. 1).

The opposite stereoisomer of lactam (−)-6, N-vinyllactam (+)-10, was produced from lactone (+)-9, a known compound, which was conveniently prepared from D-(−)-ribose (8) by the formation of acetonide with acetone and copper sulfate (98% yield) followed by reduction and oxidative cleavage (91% yield) with sodium borohydride followed by sodium periodate, and Swern oxidation of the resulting lactol, a mixture of 3.8:1 of α and β anomers (81% yield) (Scheme 2). Azidation of lactone 9 followed by hydrogenolysis, sublimation, and N-vinylation with n-butyl vinyl ether in the presence of 4.6 mol % of (DPP)Pd(OCOCF₃)₂ at 75° C. furnished (+)-10 in a 33% overall yield.

The C3 substituted chiral vinyl lactam (−)-13, a precursor for the synthesis of chiral polymer (−)-2, was prepared from (S)-2-(methoxymethoxy)butanolide (12), a previously reported molecule, derived from L-(S)-malic acid (see Scheme 3). Hence, protection of L-malic acid with 2,2,-dimethoxypropane and a catalytic amount of D-10-camphorsulfonic acid (CSA) followed by borane reduction, ring closure under acidic medium, and alkylation with chloromethyl methyl ether (MOMCl) afforded lactone (−)-12 in a 62% overall yield.

Following the aforementioned azidation by sodium azide, reduction by hydrogen over palladium/carbon, annulation under sublimation conditions, and vinylation by n-butyl vinyl ether, lactone (−)-12 was converted into (−)-13 in a 36% overall yield.

### Syntheses and Characterization of Chiral Substituted Poly-N-vinylpyrrolidinones and Bimetallic Nanoclusters

Different catalysts and reaction conditions affect the polymer main chain stereochemistry in the polymerization of terminal alkenes. However, due to the presence of reactive amide and N-vinyl functions, a free-radical process was chosen for the polymerization of N-vinyllactams. The polymerizations of vinyllatams (−)-6, (+)-10, and (−)-13 were carried out under thermal condition and photochemical condition. Stereochemistry in the main chain of the resulting polymers was studied. A dispersion polymerization method was adapted by heating (−)-6, 1% of copolymer 7 and 0.2 mol % of azobisisobutyronitrile (AIBN) in ethyl acetate in a sealed tube at 70° C. to give polymer (−)-1R in a 98% yield (Scheme 2). Copolymer 7 was added to produce a uniformed polymer and was made from (−)-6 and 1 equiv. of vinyl acetate along with 1 mol % of AIBN in acetone at 70° C. under nitrogen in a sealed tube. Similarly, using this thermal process, chiral polymers (+)-1S and (−)-2 were synthesized as depicted in Scheme 2 and 3, respectively. Hence, vinyl lactams (+)-10 and (−)-13 were separately treated with 1% of the respective copolymer, 11 and 14, 0.2 mol % of AIBN in ethyl acetate under thermal condition (70° C.) to give (+)-1S and (−)-2, respectively. Photo-polymerization reactions were also carried out by treating vinyl lactams (−)-6, (+)-10, and (−)-13 separately with 1% (by weight) of the corresponding copolymer 7, 11, and 14, and 0.2 mol % of AIBN in ethyl acetate under UV light irradiation at 0° C. in a sealed tube. Polymers (−)-1R, (+)-1S, and (−)-2 were respectively obtained in 83-88% yields (Schemes 2 and 3). Molecular weights and specific rotations of the synthesized CSPVPs were determined and data summarized in Table 1.

TABLE 1
Number average molecular weight (Mₙ), weight average molecular
weights (M_{w}), polydispersity index (PI), numbers of monomer
units (n) in the polymer, and specific rotations of CSPVP
(−)-1R, (+)-1S, and (−)-2, using 0.2 mol % AIBN
in the polymerization reactions.

| | | | | n (number | |
|---|---|---|---|---|---|
| | CSPVP, | | Polydispersity | of | [α]_{D}²² |
| | reaction | MW from | index | monomer | (c = 0.5; |
| Entry | conditions | HRMS | (PI = M_{w}/Mₙ) | units) | CHCl₃) |
| 1 | (−)-1R, | Mₙ = | 1.04 | 486 | −42.7 |
| | 70° C. | 85,232.5236 | | | |
| | | M_{w} = | | | |
| | | 89,051.4707 | | | |
| 2 | (−)-1R, | Mₙ = | 1.03 | 292 | −38.0 |
| | UV, 0° C. | 51,795.4751 | | | |
| | | M_{w} = | | | |
| | | 53,547.9798 | | | |
| 3 | (+)-1S, | Mₙ = | 1.07 | 437 | +35.3 |
| | 70° C. | 74,449.8841 | | | |
| | | M_{w} = | | | |
| | | 80,021.809 | | | |
| 4 | (+)-1S, | Mₙ = | 1.04 | 283 | +32.4 |
| | UV, 0° C. | 46,417.5788 | | | |
| | | M_{w} = | | | |
| | | 48,459.1355 | | | |
| 5 | (−)-2, | Mₙ = | 1.04 | 350 | −168.0 |
| | 70° C. | 57,297.4884 | | | |
| | | M_{w} = | | | |
| | | 59,871.4884 | | | |
| 6 | (−)-2, | Mₙ = | 1.08 | 181 | −155.0 |
| | UV, 0° C. | 28,737.377 | | | |
| | | M_{w} = | | | |
| | | 30,969.1485 | | | |

The molecular weights of polymers can be determined by several methods including NMR, gel permeation chromatography (GPC), and mass spectrometry. The NMR method is based on comparison of integrals of the end group and the repeating unit. However, the end-group signal (2-cyano-2-propyl group) is overlapping with the up-field region of the polymer signal in polymers (−)-1R, (+)-1S, and (−)-2, excluding this application. Attempts to apply GPC/HPLC, equipped with an ELSD-LTII (evaporative light-scattering) detector along with UV and RI detectors, and using different size-exclusion chromatographic columns, including a combination of TSKgel α-400 and TSKgel α-M (from Tosoh Bioscience), to study the molecular weights of CSPVPs with PVPs as standards, failed. It was found that GPC retention times of different sizes of PVP are not in agreement with those of CSPVPs. Without being bound by any theory, it is believed the structural differences in PVP and CSPVP affect their solubility in various solvents, leading to different retention times in the GPC studies. The number average molecular weight (Mₙ) and weight average molecular weight (M_{w}) of chiral polymers were therefore determined by high-resolution mass spectrometry (HRMS) using a Quadrupole Time-of-Flight (QTOF) mass spectrometer, and results are depicted in Table 1. Polymers (−)-1R and (+)-1S, derived from thermal reactions, showed respective weight average molecular weight, M_{w}, of 89,051.471 (number of monomer units, n=˜486) and 80,021.8097 Da (n=˜437), and specific rotation of [α]_{D}²²=−42.7 (c 0.5, CHCl₃) and [α]_{D}²²=+35.3 (c 0.5, CHCl₃), suggesting the polymerization processes gave similar lengths of chiral polymers.

Polymers that derived from photochemical reactions, (−)-1R and (+)-1S, have lower molecular weights, M_{w} of 53,547.9798 (n=˜292) and 48,459.1355 (n=˜283), and smaller specific rotations, −38.0 and +32.4, comparing with those obtained from thermochemical reactions (Table 1). Similarly, the molecular weight and specific rotation of (−)-2 obtained from the thermochemical reaction are greater than those from photochemical reaction. The differences in magnitudes of specific rotations may derive from the differences in polymer lengths, hence the longer polymer has a larger specific rotation value. The polydispersity index, PI values (M_{w}/Mₙ) of (−)-1R, (+)-1S, and (−)-2 obtained from thermochemical reactions are 1.04-1.07, revealing the polymers are uniform in sizes. Similar PI values, 1.03-1.08, were found from polymers obtained from photochemical reactions. To evaluate whether different polymer lengths would affect the stability of the nanoclusters, different lengths of CSPVP and PVP were synthesized by varying the amounts of AIBN in the free-radical polymerization reactions. Table 2 summarizes Mₙ, M_{w} and intrinsic viscosity values of different lengths of (−)-1R, (+)-1S, and (−)-2 along with synthesized PVPs from polymerization reactions.

TABLE 2
Results of molecular weight measurements and intrinsic viscosity
of CSPVPs and PVPs prepared by thermal reaction in ethyl acetate
at 70° C. and different mol % of AIBN in sealed tubes.

| | | | | Intrinsic |
|---|---|---|---|---|
| | Polymers (amount | MW obtained | n (number of | viscosity, |
| Entry | of AIBN used) | from HRMS | monomer units) | [η] (mL/g) |
| 1 | (−)-1R | Mₙ = | 739 | 49.90 |
| | (0.1 mol %) | 130,512.278 | | |
| | | M_{w} = | | |
| | | 135,323.932 | | |
| 2 | (−)-1R | Mₙ = | 486 | 44.44 |
| | (0.2 mol %) | 85,232.5236 | | |
| | | M_{w} = | | |
| | | 89,051.4707 | | |
| 3 | (−)-1R | Mₙ = | 262 | 40.16 |
| | (0.4 mol %) | 45,580.4601 | | |
| | | M_{w} = | | |
| | | 48,038.7775 | | |
| 4 | (+)-1S | Mₙ = | 437 | 44.10 |
| | (0.2 mol %) | 74,449.8841 | | |
| | | M_{w} = | | |
| | | 80,021.809 | | |
| 5 | (−)-2 | Mₙ = | 350 | 27.75 |
| | (0.2 mol %) | 57,297.4884 | | |
| | | M_{w} = | | |
| | | 59,871.4884 | | |
| 6 | PVP | Mₙ = | 537 | 41.67 |
| | (0.1 mol %) | 59,359.159 | | |
| | | M_{w} = | | |
| | | 59,611.538 | | |
| 7 | PVP | Mₙ = | 386 | 34.04 |
| | (0.2 mol %) | 37,341.4092 | | |
| | | M_{w} = | | |
| | | 42,946.4619 | | |
| 8 | PVP | Mₙ = | 294 | 26.4 |
| | (0.4 mol %) | 30,936.9243 | | |
| | | M_{w} = | | |
| | | 32,678.9437 | | |

Results indicated that greater the amounts of AIBN, shorter the polymer lengths, which is in agreement with the free-radical polymerization mechanism. Various Cu/Au (3:1) and Pd/Au (3:1) bimetallic nanoclusters were prepared (Scheme 3) in aqueous solution using different sizes of CSPVP, and their stabilities were studied by prolong standing at elevated temperatures. Bimetallic nanoclusters obtained from chiral polymers, preparing from 0.2 mol % AIBN, showed the greatest stability. CSPVPs having shorter polymer length (M_{w}<30,000) gave less stable bimetallic nanoclusters, which decomposed at 25° C. in 24 hours, while CSPVPs possessing longer polymer length (M_{w}>100,000) have low solubility in water, resulting in a poor yield of nanoclusters. This was indicated by the metallic metal precipitation during the preparation process.

The relative sizes of a same class of polymers can be determined by measuring the intrinsic viscosity, [η], of the polymers. The viscosity of a molecule is generated from the intermolecular attractive force, hence the larger the polymer, the greater is its viscosity value. Using an Ubbelohde viscometer, intrinsic viscosity of chiral polymers (−)-1R, (+)-1S, and (−)-2, and three synthetic PVPs were measured in methanol and results are summarized in Table 2. Results of intrinsic viscosities shown in Table 2 correlate well with the molecular weights found from HRMS, in that a larger polymer shows a greater viscosity value. However, the intrinsic viscosity values of CSPVPs cannot be used to correlate with those of PVPs. Without being bound by any theory, the intermolecular interaction of CSPVP in methanol is likely different from that of PVP. Plots of intrinsic viscosities vs molecular weights (from HRMS) of different sizes of CSPVPs and PVPs separately showed linear correlations.

The synthesized polymers are soluble in water and organic solvents including dichloromethane, acetonitrile, and methanol, and are insoluble in non-polar solvents such as hexane. They are used in the catalytic oxidation reactions and can be recovered after the reactions.

In addition to the measurements of specific rotation, molecular weight and intrinsic viscosity of CSPVP, circular dichroism (CD) and ¹³C NMR spectroscopy were carried out for characterization of their macromolecular structure and backbone stereochemistry. CD spectra of (−)-1R, (+)-1S, and (−)-2 were recorded at 3 μM concentration in water. A strong absorption band was found for (−)-1R possessing a negative molar ellipticity [θ] value of −201 mdeg at λ=223 nm, and (+)-1S a positive molar ellipticity value of +180 mdeg at λ=219 nm. No other absorptions observed after 230 nm, and the two absorption graphs are symmetric, revealing two opposite conformational handiness. Chiral polymer (−)-2, like (−)-1R, showed a strong negative absorption band at 221 nm with [θ] value of −92 mdeg. There are no differences in the CD spectra of those obtained from thermal and photochemical reactions. Notably, these CD spectra are very different from those of bimetallic nanoclusters stabilized by chiral polymers (vide infra).

Carbon-13 NMR spectroscopy has been used to study the tacticity of poly(vinylpyrrolidinone) (PVP) polymer chain, hence, it was applied to gain information of the chiral polymer chain stereochemistry, in which the polymers were derived from both thermal and photochemical reactions. ¹³C NMR spectra were recorded at 100 MHz in CDCl₃ and representative spectra of (+)-1S and (−)-2, obtained from both thermal and photochemical reactions. The spectra of (+)-1S and (−)-1R are identical. The ¹³C spectra were also recorded at 150 MHz in CDCl₃ or D₂O, but no significant changes in signal appearances were found. The broad signals at δ 44.7-47.0 ppm and 43.0-44.5 ppm in the zoom-in spectrum of (+)-1S are assigned for α-CHN and CH₂N, respectively. Similarly, signals at δ 43.3-46.0 ppm and 37.7-40.0 ppm in the spectrum of (−)-2 are respective assigned for α-CHN and CH₂N. The α-CHN and CH₂N signals of (+)-1S are unresolved, hence it is not possible to assign the polymer main chain tacticity. However, the α-CHN signals at δ 43.3-46.0 ppm region of (−)-2, showing three signals at δ 45.3, 44.1, and 43.6 ppm. They are assigned to the triad stereo-sequences of mm+mr, rr, and mr (mm is isotactic, rr is syndiotactic, and mr is heterotactic triad). The assignments are assumed based on that reported α-CHN chemical shifts and tacticity assignment in PVP. The peak intensities cannot be used for quantitative determination of the triad tacticities, since the mm and mr contributions in the δ 45.3 ppm signal are unknown. Based on the spectra, isotactic, syndiotactic and heterotactic triads are likely present as block polymer, in polymer (−)-2 as well as (−)-1R.

Gold was used in bimetallic nanoclusters due to its synergistic electronic effects and enhancement of the reactivity of Cu or Pd (vide supra). Different ratios of Cu/Au and Pd/Au, such as 1:1, 2:1 and 3:1, were investigated, and a 3:1 ratio provided the highest reactivity. A co-reduction of mixed ions method was utilized for the preparation of Cu/Au (3:1) or Pd/Au (3:1) stabilized by CSPVP or PVP (40K MW). For example, a solution of (−)-Cu/Au (3:1)/1R was prepared by the treatment of HAuCl₄ (1 equiv.), CuCl (3 equiv.) and (−)-1R (0.11 equiv.; based on the moles of Au) in deionized and degassed water with NaBH₄ at 25° C. for 2 h to give a clear-dark-purple colloidal dispersion of bimetallic nanocluster solution (Scheme 3). Similarly, Na₂PdCl₄ (3 equiv.), HAuCl₄ (1 equiv.), CSPVP (−)-1R (0.11 equiv.) and NaBH₄ were used to prepared (−)-Pd/Au (3:1)/1R, resulting in a clear purple-brown solution. The bimetallic nanocluster solutions are stable at 25° C. and used in the catalytic C—H group oxidation reactions without further manipulation. Different concentrations of the bimetallic nanoclusters were obtained by using either less or more water. Bimetallic nanocluster concentrations ranging from 10 to 25 mM were prepared, and a higher the concentration, a greater the relative reaction rate. For characterization purpose, the aforementioned bimetallic nanocluster solution was filtered through a Vivaspin 20 centrifugal filter device (3,000 MWCO), and washed with deionized water twice to remove low molecular weight inorganic materials. The resulting nanoclusters were dissolved in water and subjected to various analyses including transition electron microscopy (TEM), atomic force microscopy (AFM), dynamic light scattering (DLS), CD, UV, inductively coupled plasma-mass spectroscopy (ICP-MS), NMR, and IR.

Cu/Au- (3:1) or Pd/Au- (3:1) CSPVP solution was dissolved in 1% HNO₃/2% HCl solution and subjected to the ICP mass spectrometer. Standard solutions for ¹⁹⁷Au, ¹⁰⁶Pd and ⁶⁵Cu (1000 ppm of metal in 30 mL of water) were used and results of Cu/Au (3:1)-1R and Pd/Au (3:1)-1R showed concentrations of Cu/Au and Pd/Au are 3:1, confirming the metal compositions in the bimetallic nanoclusters. The average sizes, size distribution, and shapes of polymers (−)-1R, (+)-1S and (−)-2 were measured by AFM and DLS. For instance, chiral polymer (−)-1R showed in DLS an average size of ˜14.6 nm with narrow distribution (11.4-18.2 nm) and in AFM sizes of ˜15-30 nm, showing structurally undefined shape. TEM revealed the average sizes of (−)-Pd/Au (3:1)-1R and (−)-Cu/Au (3:1)-1R nanoclusters being 3.32±1.08 and 3.41±1.13 nm, respectively. The amide C═O absorption band of the pyrrolidinone ring at 1648 cm⁻¹ of polymer (−)-1R in IR spectrum shifted to 1642 cm⁻¹ in (−)-Pd/Au (3:1)-1R and 1643 cm⁻¹ in (−)-Cu/Au-1R, suggesting a greater character of ^{δ-}O—C═N^{δ+} of the amide group in the nanoclusters than that of (−)-1R, due to chelation with the metals. Under similar reaction conditions, in the absence of CSPVP such as (−)-1R or PVP, reduction of Na₂PdCl₄, HAuCl₄ with NaBH₄ gave insoluble black solids, i.e., no nanoclusters were formed.

The chirality of nanoclusters may contribute by chirality of the ligand, e.g., glutathione in bimetallic nanoclusters, or chiral polymer, e.g., chiral poly(fluorine-alt-benzothiadiazole) in gold nanoparticles. Without being bound by any theory, this may be due to the formation of chirally ordered nanocomposite. It is intriguing whether the chirality of CSPVP can induce chiroptical responses in our bimetallic nanoclusters, which may shed light on optically active nanomaterials and their catalytic reactions.

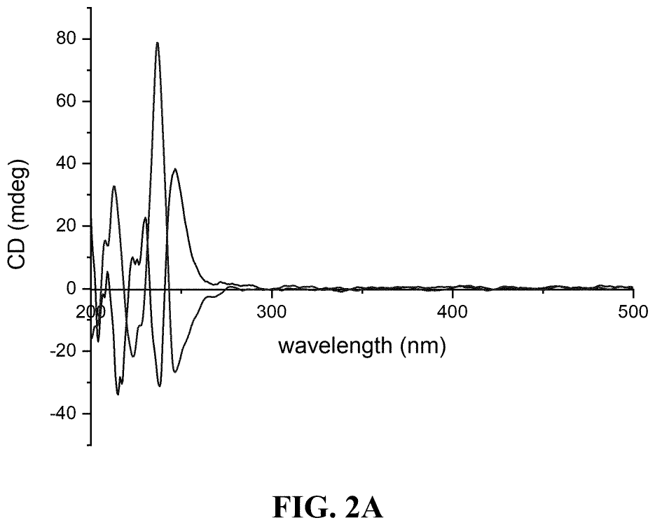

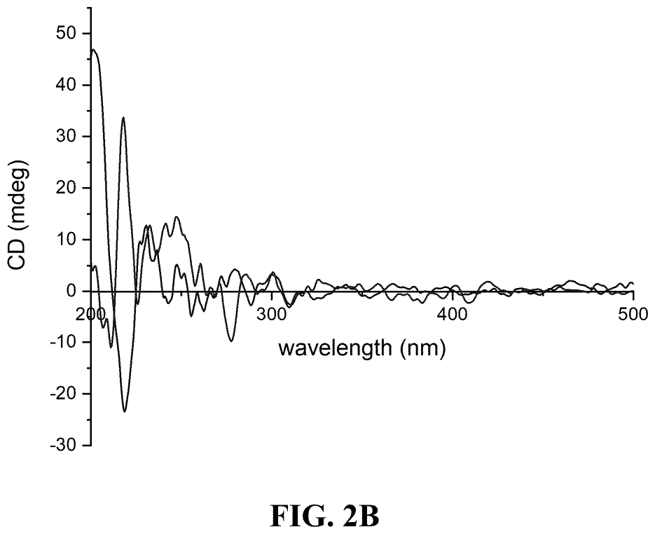

Indeed, CD spectra of bimetallic nanoclusters encapsulated by CSPVPs displayed characteristic absorptions in their CD spectra (FIG. 2A and FIG. 2B). Cu/Au (3:1)-1R spectrum at 1.5 mM concentration showed distinctive strong negative absorptions at 238 nm (−31 mdeg) and 215 nm (−33 mdeg), and positive absorptions at 253 nm (+38 mdeg) and 230 nm (+22 mdeg). On the other hand, Cu/Au (3:1)-1S spectrum showed positive absorptions at 237 nm (+79 mdeg) and 213 nm (+33 mdeg), and negative absorptions at 251 nm (−27 mdget) and 228 nm (−21 mdeg). An overlay of these two spectra is shown in FIG. 2A, revealing Cu/Au made from (−)-1R and (+)-1S displayed nearly mirror-imaged CD spectra, despite small differences in their wavelengths and magnitudes of the Cotton effects. Without being bound by any theory, these minor changes may be due to the different lengths of chiral polymers, 1R and 1S, and changes in Cotton effects are caused by conformer populations.

Similarly, an overlay of spectra of Pd/Au (3:1)-1R and Pd/Au (3:1)-1S presented in FIG. 2B, showing opposite CD spectra. The CD spectrum of Cu/Au (3:1)-2 at 1.5 mM in water showed a strong negative absorption appeared at 236 nm (−56 mdeg). Notably, the CD spectrum of (−)-1R or (+)-1S at 3 μM concentration exhibited a strong and single negative or positive absorption at ˜220 nm, respectively, suggesting the aforementioned bimetallic nanoclusters' chiroptical responses are contributed from chiral-polymer encapsulated nanomaterials and not from the chiral polymer alone. Without being bound by any theory, the nanoclusters likely possess defined and discrete chiral polymer structures and possibly chiral arrangement of the metal atoms. The CD spectra of Au, Pd, and Cu alone as controls, showed no absorption.

### Catalytic C—H Bond Oxidation of Complex Natural Products and Rigid Cyclic Molecules

Catalytic C—H bond oxidation reactions according to exemplary embodiments of the present invention are illustrated in Schemes 4, 5, and 6, below.

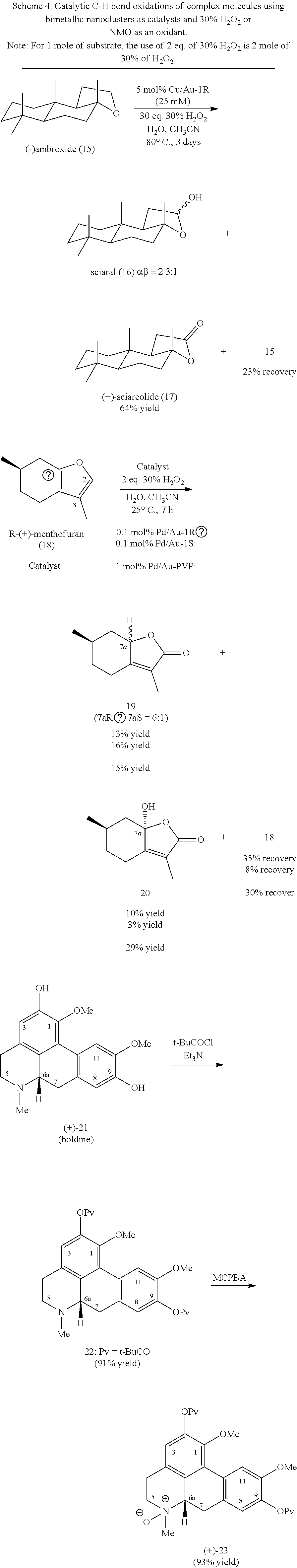

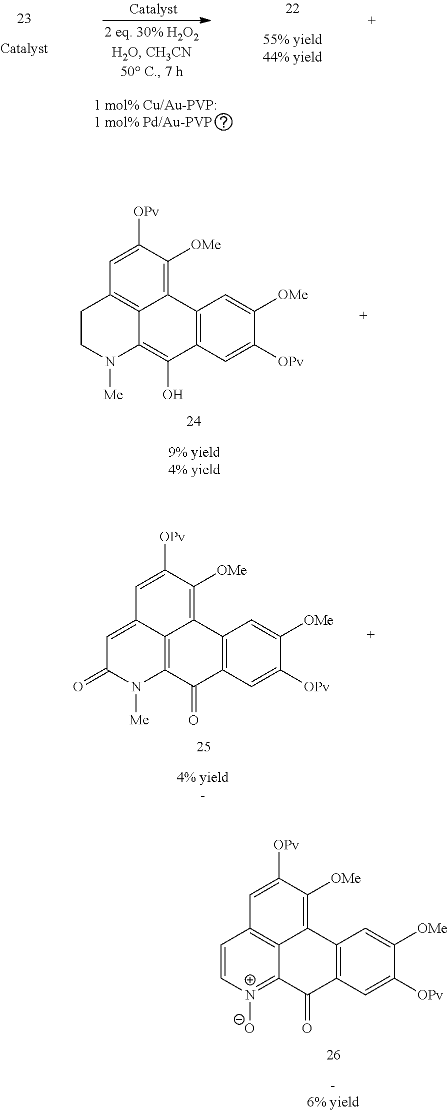

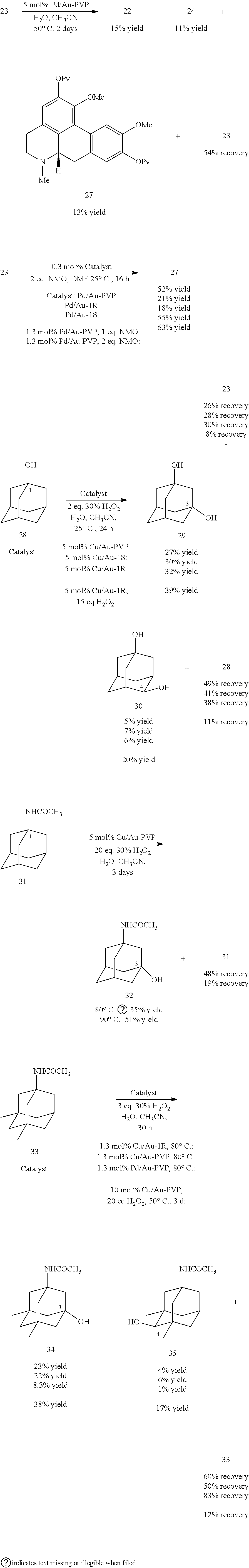

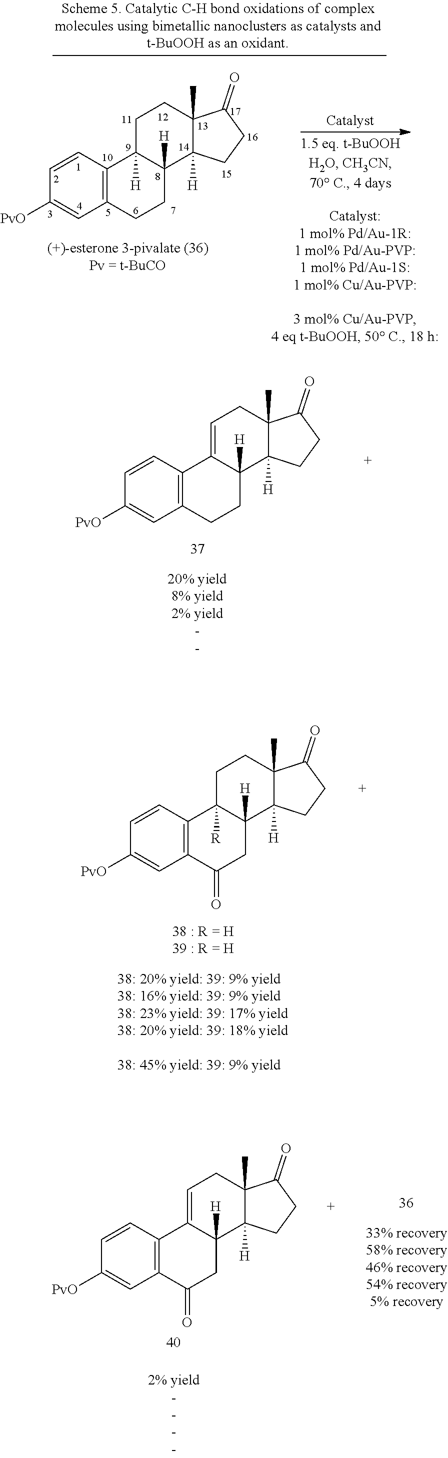

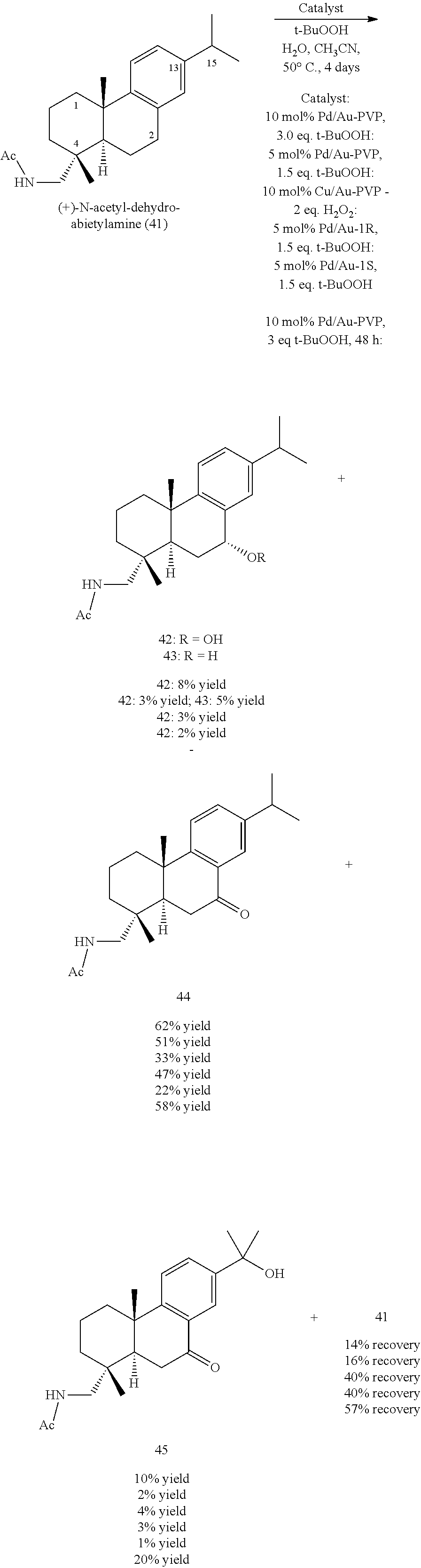

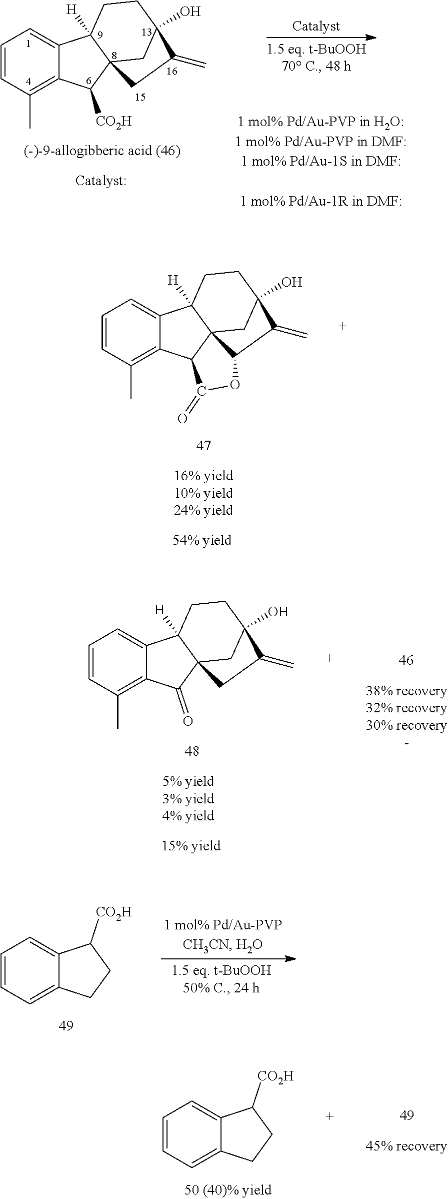 [SMILES: C=C1C[C@]23C[C@@]1(O)CC[C@@H]2c1cccc(C)c1[C@@H]3C(=O)O ; C=C1[C@@H]2OC(=O)[C@H]3c4c(C)cccc4[C@H]4CC[C@]1(O)C[C@]423 ; C=C1C[C@]23C[C@@]1(O)CC[C@@H]2c1cccc(C)c1C3=O ; O=C(O)C1CCc2ccccc21 ; O=C(O)C1CCc2ccccc21]

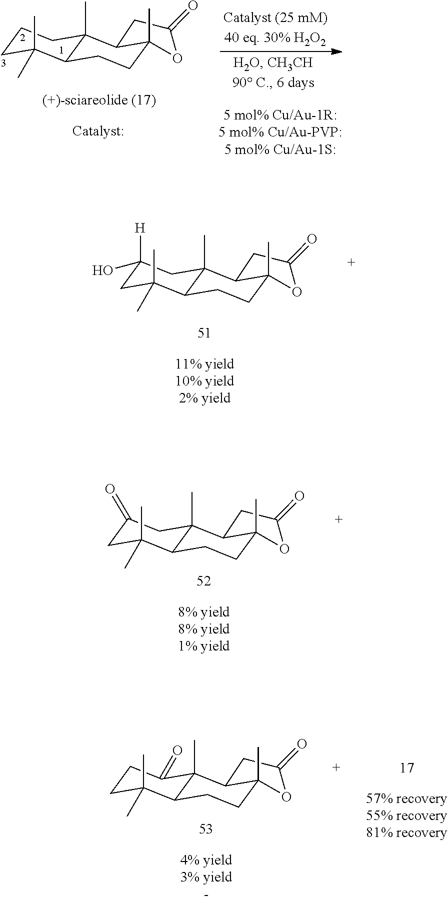 [SMILES: CC1(C)CCCC2(C)C1CCC1(C)OC(=O)CC12 ; CC1(C)CC(O)CC2(C)C1CCC1(C)OC(=O)CC12 ; CC1(C)CC(=O)CC2(C)C1CCC1(C)OC(=O)CC12 ; CC1(C)CCC(=O)C2(C)C1CCC1(C)OC(=O)CC12]

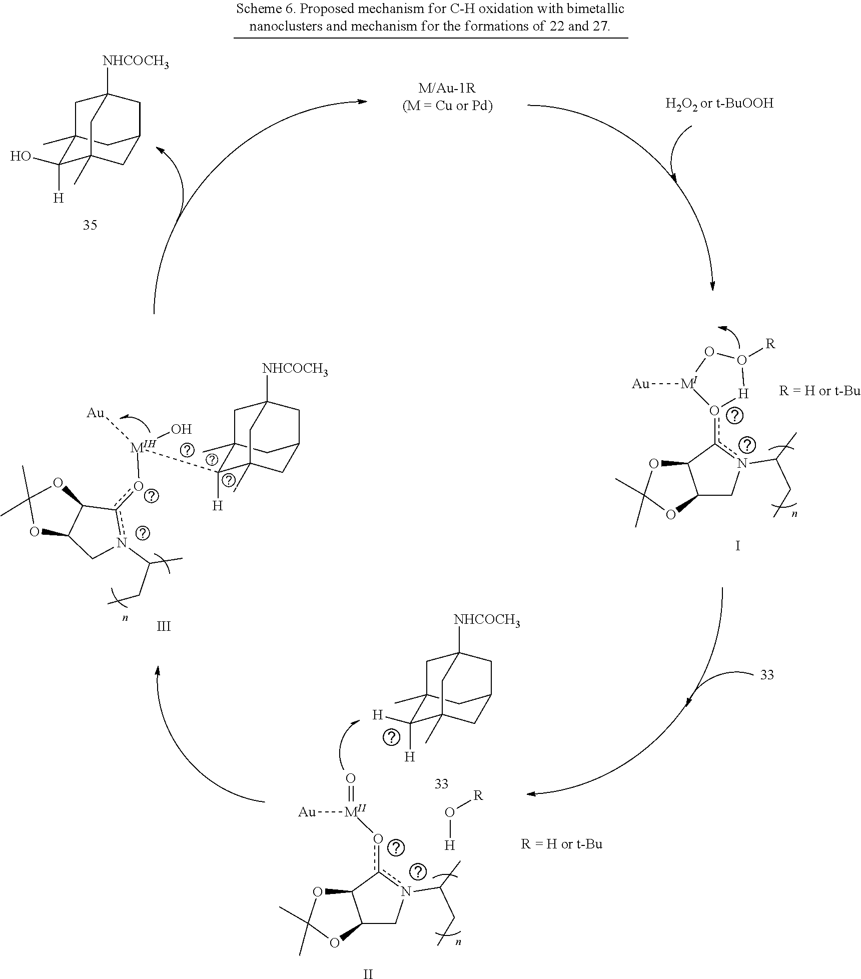

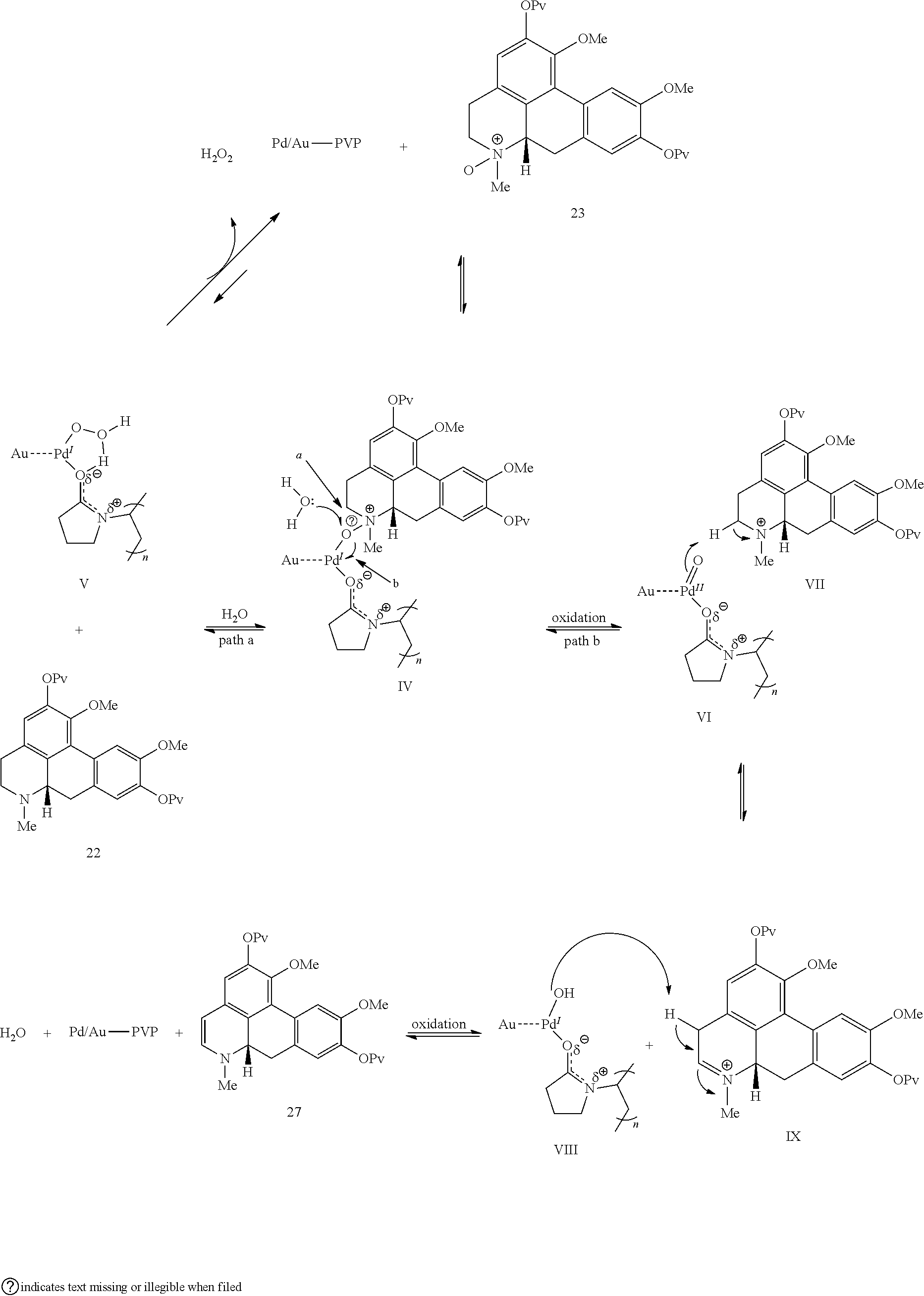

The diverse catalytic oxidations of copper-containing oxidases such as dicopper particulate monooxygenase, have in part motivated numerous studies in C—H functionalization due to copper's oxidative efficiency.

The use of bimetallic nanoclusters Cu/Au (3:1)-H₂O₂ or Pd/Au (3:1)-t-BuOOH in the C—H group oxidation of cyclic ethers, rigid molecules, heterocycles, and fused aromatic cycloalkanes has not been reported previously. Hence, (−)-ambroxide (15), R-(+)-menthofuran (18), (+)-2,9-di-(O-pivalyl)-boldine N-oxide (23), 1-adamantanol (28), N-acetylamantadine (31), and N-acetylmemantine (33) (Scheme 4) as well as (+)-3-pivaloyl estrone (36), (+)-N-acetyl-dehydroabietylamine (41), and (−)-9-allogibberic acid (46) (Scheme 5) were chosen for studies.

The oxidation of 15, a cyclic ether natural product, was carried out first to examine the catalytic activity and regioselectivity of monometallic and bimetallic nanocluster catalysts, Cu/Au (3:1) and Pd/Au (3:1) stabilized by PVP (40 K) or CSPVP (10 mM concentration each in water), using 2 equiv. 30% hydrogen peroxide as an oxidant. At room temperature, there was no reaction, however, the reaction proceeded gradually upon heating. Results of the oxidation reactions summarized in Table 3 and Scheme 4, revealing distinctive matched and mismatched chiral bimetallic-nanocluster catalysts with the chiral substrate, 15.

TABLE 3
Catalytic oxidations of (−)-ambroxide (15) with monometallic
or bimetallic nanoclusters and 2 equivalents of 30% H₂O₂ in
acetonitrile-water (1:1) (10 mM) at 80° C. for 3 days.

| | mol % of Catalysts (3:1 of | | |
|---|---|---|---|
| | bimetallic nano-clusters or | Product(s), | Recovered |
| Entry | monoclusters | (isolated yields) | 15 |
| 1 | None | — | 88% |
| 2 | 5% Au-PVP | — | 87% |
| 3 | 5% Cu-PVP | — | 87% |
| 4 | 5% Pd-PVP | 16 (1%) and 17 (2%) | 83% |
| 5 | 5% Pd/Au-PVP | 16 (1%) and 17 (14%) | 72% |
| 6 | 5% Cu/Au-PVP | 17 (20%) | 67% |
| 7 | 5% Cu/Au-1R | 17 (37%) | 51% |
| 8 | 5% Cu/Au-1S | 17 (1%) | 84% |
| 9 | 5% Cu/Au-2 | 17 (2%) | 83% |
| 10 | 5% Cu/Au-1R (25 mM)^{a} | 17 (64%) | 23% |

^{a}40 equivalents of 30% H₂O₂ were used.

In the absence of nanocluster catalysts, no oxidized product was found at 80° C. for 3 days and only starting material 15 was recovered (Table 3, Entry 1). Monometallic nanoclusters, 5 mol %, such as Au-PVP, Cu-PVP, and Pd-PVP, were also applied (Entries 2-4), and no oxidized product was detected, except in the case of Pd-PVP, where trace amounts of sclaral (16) and (+)-sclareolide (17) were isolated (Entry 4). The oxidation of 15 proceeded when 5 mol % of Pd/Au (3:1)-PVP or Cu/Au (3:1)-PVP were used (Entries 5 and 6), albeit only 28% and 33% conversion, respectively. However, when Cu/Au-1R was applied, 37% yield of 17 was isolated along with 51% recovery of 15 (Entry 7). Strikingly, Cu/Au-1S and Cu/Au-2 produced merely 1% and 2% of 17, respectively, along with 83-84% of recovered 15 (Entries 8 and 9). Results suggest that nanoclusters derived from 1R polymer matches the stereochemistry of 15, while those derived from chiral polymers 1S and 2 mismatches the stereochemistry of 15. The diastereoselective oxidation of 15 by Cu/Au/1R but not Cu/Au-1S or Cu/Au-2 suggests the bimetallic nanoclusters are chiral, and CD studies of nanoclusters (vide supra) are in agreement with the finding. The conversion of 15 to 17 can be improved by using 5 mol % of Cu/Au-1R (25 mM) in H₂O solution and 40 equiv. of 30% H₂O₂. The yield of 17 increased to 64% with a 23% recovery of 15 (Table 3, Entry 10 and Scheme 4). The regioselective oxidation of α-C—H bond of cyclic ether function may be due to its lower bond dissociation energy, ˜95 kcal/mol, than other C—H bonds in the molecule. Sclaral (16) comprised of an inseparable 2.3:1 ratio of a and B stereoisomers. Treatment of 16 with 1 mol % Cu/Au-PVP and 2 equiv. of 30% H₂O₂ at 80° C. for 2 h gave 17 in a 93% yield, suggesting 16 forms first, which undergoes alcohol oxidation to give 17 under the reaction conditions. Oxidations of 15 to 17 using benzil and oxygen under photoirradiation, tetrabutylammonium decatungstate photocatalyst, and chiral and achiral organometallic reagents have been reported previously. Since bimetallic nanoclusters derived from chiral polymers 1S and 2 provided similar results in the oxidation reactions, in the following studies, results from 1R and 1S were presented, but not 2.

The recognition of medium-size cyclic ether molecules by the bimetallic-nanocluster system led to study the oxidation of a smaller natural product, R-(+)-menthofuran (18). 18 underwent oxidation with 1 mol % Pd/Au-PVP (10 mM concentration in water) and 2 equiv. of 30% H₂O₂ at 25° C. for 7 h to give a 15% yield of (−)-mintlactone (19) and 29% yield of (−)-hydroxymintlactone (20) along with 30% recovery of 18 (Scheme 4). Prolonging the reaction time did not significantly improve the yield, but produced other unidentifiable over-oxidized by-products. Catalysts Pd/Au-1R and Pd/Au-1S were also used to examine their reactivity. To decrease the rate of reactions, 0.1 mol % of the catalysts were used, and results are summarized in Scheme 4. In the reaction using 1R, 13% yield of 19 and 10% yield of 20 along with 35% recovery of 18 were found. When 1S was used, the yields and recovery were lower than those from 1R; i.e., 16% and 3% yield of 19 and 20, respectively, along with 8% recovery of 18. Hence, a match-and-mismatch in stereochemical outcome is not as apparent comparing with result from 15, this may be due to the active site, at C2 of 18, is away from the C6-stereogenic center. Previously, oxidations of 18 were limited to chromic acid, singlet oxygen or cytochromes P450 enzymes and in most cases ring opening products were obtained.

The formation of both 19 and 20 from the oxidation of 18 have not been reported prior to this work. In the absence of the bimetallic-nanocluster catalyst, under similar reaction conditions, no product was found and only 18 recovered. The reaction pathways may involve addition of O=Pd^{II}/Au-1R onto C2,3-double bond, 1,3-allylic migration of (HO)Pd^{I}/Au-1R from C3 to C7a, followed by oxidation of C2-lactol to lactone. The C7a-Pd(OH)/Au species may either undergo protonation by H₂O to give 19 or oxidation to give 20. The facile oxidation of 18 may provide a new pathway for converting substituted furans and pyrroles to the corresponding lactones and lactams.

(S)-(+)-Boldine (21), an isoquinoline alkaloid, isolated from leaves, stem bark, and roots of Laurus nobilis or bay laurel evergreen tree. It possesses antioxidant, anti-inflammatory, and osteoporosis suppressive properties. Oxidation of boldine with various oxidants, such as H₂O₂, provided boldine N-oxide. C—H oxidation of boldine, its 0-protected analogs, or its N-oxide has not been reported previously. Treatment of 22, derived from (+)-boldine (21) and pivaloyl chloride, with 3 mol % Cu/Au-PVP at 50° C. or Pd/Au-PVP at 50 or 80° C. and 2 equiv. of 30% H₂O₂ for 30 h resulted in 98% and 93% recovery of 22, respectively. No oxidation products, including N-oxide 23, were found from these reactions. Generally, tertiary amine can be oxidized by H₂O₂ to give the corresponding N-oxide. However, under our oxidation reaction conditions, hydrogen peroxide likely deactivated by bimetallic nanoclusters, resulting in a significant decrease of the oxidation rate of tertiary amine. Hence, the oxidation of boldine N-oxide 23, generated from the oxidation of 22 with m-chloroperbenzoic acid (MCPBA), was investigated. Under similar reaction conditions, treatment of 23 with 1 mol % Cu/Au-PVP and 2 equiv. of 30% H₂O₂ at 50° C. gave a 9% yield 24, 4% yield of 25, 55% yield of 22, and unidentifiable materials. When 1 mol % of Pd/Au-PVP catalyst was used, 24 (4% yield), 26 (6% yield), and 22 (44% yield) were obtained. The structures were assigned based on their ¹H NMR, ¹³C NMR, 2D NOESY (Nuclear Overhauser Effect Spectroscopy), and mass spectra. In brief, ¹H NMR spectrum of compound 24 shows four singlets assigned for three aromatic hydrogens, C3-H, C8-H and C11-H along with an enol OH at δ 6.67 ppm. The C4 and C5 methylene hydrogens appear as two triplets at δ 3.37 (two protons) and 3.27 ppm (two protons), which couple with each other. The two methoxy's, N-methyl, and two t-butyl groups display five singlets at δ 3.97, 3.84, 3.06, 1.50, and 1.45 ppm, respectively. ¹³C NMR and mass spectra are in agreement with the assigned structure.

¹H NMR spectrum of 25 shows four aromatic hydrogens as singlets at δ 9.10, 8.43, 7.62, and 7.58 ppm, and five singlets at δ 4.05, 4.02, 3.88, 1.52, and 1.47 ppm assigned for two methoxys, N-methyl, and two t-butyl groups, respectively. Similarly, ¹³C NMR and mass spectra are in agreement with the assigned structure. The ¹³C NMR chemical shifts for the two C═O signals at C5 (S 157.4 ppm) and C7 (S 176.7 ppm) are in agreement with those reported for C═O of isoquinolones and dibenzo[de,g]quinolin-7-ones. ¹H NMR spectrum of compound 26 reveals five aromatic signals at δ 9.19 (singlet), 8.87 (doublet), 8.13 (singlet), 7.76 (doublet), and 7.57 ppm (singlet) for C8-H, C4-H, C11-H, C5-H, and C3-H, respectively. In addition, four singlets at 4.03, 3.92, 1.51, and 1.46 ppm are assigned for two methoxy and two t-butyl groups, and absence of the N-methyl signal. ¹³C NMR and mass spectra are in agreement with the assigned structure. Notably, oxidation of boldine and its derivatives has not been reported previously. Presumably, the oxy-anion of N-oxide binds to bimetallic nanoclusters Cu/Au or Pd/Au and subsequently undergoes intramolecular C—H oxidation at β carbon C7 and α carbon C5, utilizing the oxygen of N-oxide. The resulting C7 hydroxyl group oxidizes to give ketone, which enolizes to form aromatic phenanthrenol 24. On the other hand, the C5 hydroxyl group of 23 oxidizes to give amide, which proceeds oxidative dehydrogenation followed by C—H oxidation at C7 to furnish 25. Dibenzo[de,g]quinolin-7-one 26 may derive from demethylation of 23 followed by oxidative aromatization of the piperidine ring and C—H bond oxidation at C7. Demethylation of dialkylmethylamine N-oxides has been reported under reductive conditions by using sulfur dioxide or ferrous sulfate via a rearrangement mechanism, while demethylation under oxidative conditions has not been utilized previously. The N-oxide directed intramolecular oxidation and demethylation of N-methylamine N-oxide reactions are unprecedented. Molecule 23 is chiral, possessing C6a-S configuration, while oxidized products 24-26 are achiral, hence, oxidation of 23 with Cu—Au-1R or -1S under these conditions was not investigated.

In support of the assumption that the oxy-anion of N-oxide binds to bimetallic nanoclusters Pd/Au followed by C—H oxidations at 3-C7 or α-C5 carbons, N-oxide 23 was treated with 5 mol % of Pd/Au-PVP in acetonitrile and water without an oxidant such as H₂O₂. Deoxygenated amine 22 (15% yield), C7-oxidized product 24 (11% yield), and a new molecule, 27 (13% yield) along with recovered 23 (54%) were isolated and characterized. Results suggest that the N-oxide group is the oxygen source for C—H oxidation either intramolecularly and/or intermolecularly. The lesser amount of amine 22 than the total amounts of 24 and 27 implies that intramolecular delivery of the oxygen atom is likely. The structure of compound 27 was characterized based on its ¹H, ¹³C, and 2D NOESY NMR, and MS spectra. In the 2D NOESY spectrum, correlations were found between C5H at δ 7.83 ppm and C6a and C7 at δ 3.33 and 3.22 ppm, between C8H at δ 7.19 ppm and C7 and C6a, and between C3H at δ 7.54 ppm and C4H at δ 7.68. A proposed mechanism for the formation of 27 and 22 from 23 is depicted in Scheme 6 (vide infra). The presence of H₂O₂ in the oxidation of 23 appears to promote the deoxygenation of N-oxide function of 23, leading to amine 22. N-oxide molecules such as N-methylmorpholine N-oxide (NMO) may serve as a suitable oxidant in this case, and DMF can be used as a solvent for the preparation of bimetallic nanoclusters and oxidation reaction.

It is noteworthy that compound 23 and the aforementioned oxidized products have low solubility in water and acetonitrile. The use of DMF as a solvent would allow the reaction to be conducted at high concentrations, leading to an increase of reaction rate. Hence, 23 was treated with 0.3 mol % of Pd/Au-PVP (25 mM in DMF) and 2 equiv. of NMO in DMF, providing a final concentration of 0.89 M. Surprisingly, the reaction took place at 25° C. for 16 h to give a 52% yield of 27 and 26% recovery of 23. Compound 22 was not found. As mentioned above, 27 likely forms from 23, and in this case NMO binds to Pd/Au resulting in N-methylmorpholine-Pd(═O)/Au, which undergoes C5-H bond oxidation of Pd/Au-bound 22, derived from 23, or oxidation of the amine function of 22 to give 23. The use of 0.3 mol % of Pd/Au-1R or Pd/Au-1S gave similar results as those using 0.3 mol % Pd/Au-PVP, albeit in a decrease of relative reaction rates (Scheme 4). Compound 23 possesses a planar structure, which likely does not result in a facial selectivity by Pd/Au-1R or Pd/Au-1S. An increase of the amount of catalyst to 1.3 mol % Pd/Au-PVP, under similar reaction conditions, afforded a 63% yield of 27. A reduction of the oxidant to 1 equiv. of NMO provided a 55% yield of 27 and 8% of recovered 23. The reaction illustrates an unprecedented one-pot oxidation-elimination of boldine N-oxide derivative 23 to give a good yield of 27 as the sole product.

Rigid molecules such as 1-adamantanol (28), N-acetylated amantadine [or 1-(N-acetylamino)-adamantane] (31) and N-acetyl-memantine [or 1-(N-acetyl)-amino-3,5-dimethyladamantane] (33) were investigated next to probe the relative reactivity of their tertiary, secondary and primary C—H bonds. Treatment of 1-adamantanol (28) with 5 mol % of Cu/Au-PVP (10 mM aqueous solution) and 2 equiv. of 30% H₂O₂ in acetonitrile (the final concentration of the reaction solution is 0.03 M) at 25° C. for 24 h gave a 27% yield of 1,3-adamantanediol (29) and 5% yield of 1,4_{eq}-adamantanediol (30) along with a 49% recovery of 28. The use of 5 mol % Cu/Au-CSPVP 1S under similar reaction conditions gave similar results, 30% yield of 29 and 7% yield of 30 along with 41% recovery of 28. Both 29 and 30 are meso compounds, and oxidation of 28 using Cu/Au-CSPVP 1R provided similar results (Scheme 4). An increase of the oxidant H₂O₂ from 2 equiv. to 15 equiv. under similar reaction conditions afforded 39% and 20% yield of 29 and 30, respectively, along with a 11% of recovered 28. The spectral data of 29 and 30 are in agreement with those reported.

Amantadine is used for influenza A and Parkinsonian syndromes, while memantine for moderate-to-severe Alzheimer's disease. Both amantadine and memantine antagonize N-methyl-D-aspartate receptor (NMDAR), and they possess various side effects. Hence, analogs with lesser side effects and enhanced efficacy are preferable. C—H group oxidation of these molecules may lead to new analogs for biological studies. N-Acetyl-amantadine (31) underwent oxidation by the treatment with 5 mol % Cu/Au (3:1)-PVP and 20 equiv. of 30% H₂O₂ in acetonitrile-H₂O at 80° C. for 3 days to give 32, a meso molecule, in 35% yield along with 48% recovery of 31. An increase of the temperature to 90° C., under similar reaction conditions a 51% yield of 32 and 19% recovery of 31 were isolated. The spectral data of 32 is in agreement with those reported. The oxidation took place at the tertiary carbon of 31, which may due to a weaker tertiary C—H bond energy (96.5 kcal/mol) comparing with the secondary C—H bond energy (98.5 kcal/mol).

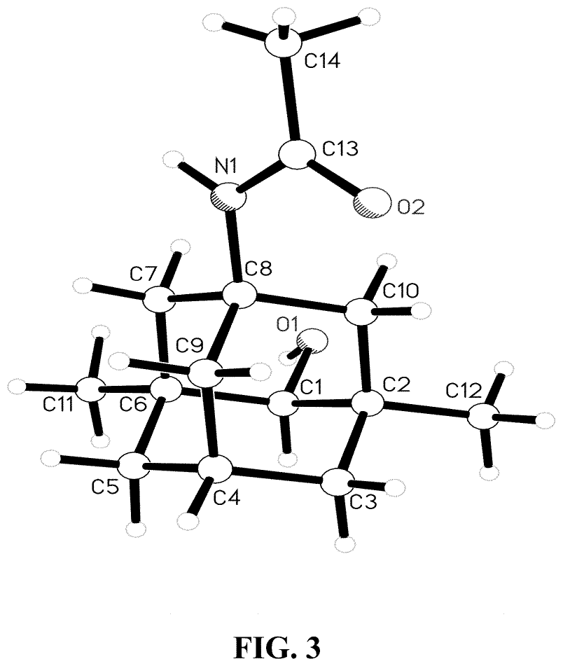

Interestingly, when N-acetylmemantine (33) was treated with 1.3 mol % Cu/Au (3:1)-1R and 3 equiv. of 30% H₂O₂ at 80° C. for 30 h, respective tertiary and secondary C—H oxidation products, 34 (23% yield) and equatorial hydroxyl 35 (4% yield), were isolated along with 60% recovery of 33. The use of 1.3 mol % Cu/Au-PVP provided similar results, 22% yield of 34, 6% yield of 35 and 50% recovery of 33. On the other hand, the oxidation reaction using 1.3 mol % of Pd/Au-PVP is sluggish and gave only 8.3% yield of 34 and 1% yield of 35 as well as 83% recovery of 33. The structure of 34 was characterized by its NMR spectra, which are identical to those reported, while that of 35 was identified through a single-crystal X-ray analysis (FIG. 3). Similar to the oxidation of 28, an increase of oxidant from 3 equiv. to 20 equiv. of 30% H₂O₂ at 50° C. for 3 days, 38% and 17% yield of 34 and 35, respectively, were isolated along with 12% of recovered 33. Hence, an increase of the amount of oxidant facilitated the rate of oxidation reactions and chemical yields. The methylene C—H oxidation of 33 leading to 35, a previously unreported molecule, is unusual. It can be converted into novel analogs for the discovery of Alzheimer drug.

The captivating results obtained from the oxidation of boldine derivative 23 led us to investigate oxidations of other bioactive natural products containing aromatic ring (Scheme 5). 3-O-Pivaloyl estrone (36) was prepared in an 89% yield by the esterification of estrone with pivaloyl chloride and pyridine. Attempted oxidation of 36 with 5 mol % Cu/Au (3:1)-1R or -PVP and an oxidant, 30% H₂O₂ (2 equiv.) in acetonitrile-water at 70° C. for 3 days failed to provide oxidized products. Similarly, 5 mol % Pd/Au-PVP and 2 equiv. of 30% H₂O₂ did not produce appreciable products. However, when t-BuOOH, a stronger oxidant than H₂O₂, was applied, satisfactory results were found. Hence, treatment of 36 with 1 mol % Pd/Au-1R and 1.5 equiv. of t-BuOOH in acetonitrile-H₂O at 70° C. gave 9,11-dehydro-3-pivaloyl-estrone (37) (20% yield), 6-oxo-3-pivaloyl-estrone (38) (20% yield), 9-hydroxy-6-oxo-3-pivaloyl-estrone (39) (9.5% yield) and 9,11-dehydro-6-oxo-3-pivaloyl-estrone (40) (2% yield) along with 33% of recovery of 36 (Scheme 5). Spectral data of 38 and 39 are identical with those reported. Hence, t-BuOOH appears to be more effective for benzylic oxidation reactions than hydrogen peroxide. The oxidation of 36 with 1 mol % Pd/Au-PVP and t-BuOOH produced 37-39, under similar reaction conditions, but in lower chemical yields (Scheme 5). The reaction of 36 with Pd/Au-CSPVP 1S and t-BuOOH showed a similar relative reaction rate as that of PVP, suggesting the match and mismatch in stereochemistry is not significant. This may be due to that estrone molecule is relatively flat and the small hydrogens at C8 and C9 do not offer a strong facial discrimination. Oxidation of (+)-36 with 1 mol % of Cu/Au-PVP (25 mM concentration) and 1.5 equiv. of t-BuOOH at 70° C. afforded 20% and 18% yield of 38 and 39, respectively. Increasing the amounts of catalyst and oxidant improved the chemical yield and lowered the reaction temperature and time. Thus, oxidation of 36 with 3 mol % of Cu/Au-PVP and 4 equiv. of t-BuOOH at 50° C. for 18 h, 38 and 39 were isolated in 45% and 24%, respectively, along with 5% of recovered 36. Cu/Au-1R gave similar results. Dehydroestrone 37 and starting estrone 36 are inseparable and they were deacylated with K₂CO₃ in methanol to give the corresponding phenols, which were separated by silica gel column chromatography. Spectral data of the resulting 9,11-dehydro-estrone is identical to that reported. Presumably, 36 undergoes benzylic oxidation to give 9-hydroxy- and 6-hydroxy-3-pivaloyl estrones. The former undergoes β-elimination to give 37 and the latter undergoes oxidation to give 38. Product 39 likely derived from the double oxidations at C6 and C9 followed by oxidation of the C6 hydroxyl group and dehydration of the C9-OH and C11-H. Compound 40 would derive from the dehydration of 39 via a β-elimination. The structure of 40 was assigned based on ¹H, ¹³C, 2D COSY and 2D NOESY NMR and mass spectra. In the 2D NOESY spectrum, correlations were found between C1-H signals at δ 7.25 ppm and C11-H at 6.50 ppm, establishing C9,11-double bond assignment. ¹³C NMR spectrum showed carbonyl groups of C6 at δ 196.2 ppm and C17 at δ 220.0 ppm. The selective benzylic C—H oxidation may be attributed to a weak bond-dissociation energy of the benzylic C—H bond, ˜90 kcal/mol. Results reveal a similar rate of oxidations at benzylic C6 and C9 C—H bonds accompanying by a rapid oxidation of the resulting secondary hydroxyl group.

The aromatic abietane diterpenoids have shown diverse bioactivities, and benzylic oxidation at C7 of N-acetyl-dehydroabietylamine (41) with chromic anhydride led to various analogs with anti-leishmanial activity. Catalysts such as bimetallic nanoclusters Pd/Au or Cu/Au would be good candidates for replacing chromic anhydride, a toxic chemical. Indeed, treatment of 41 with 10 mol % of Pd/Au-PVP and 3 equiv. of t-BuOOH in H₂O and CH₃CN at 50° C. for 4 days gave major product C7-ketone 44 in a 62% yield and minor products C7ₐₓ-hydroperoxide 42 (8% yield) and 7-keto-15-hydroxy 45 (10% yield) along with 14% recovery of 41. In a larger-scale reaction using 1.5 equiv. of t-BuOOH, a small amount (5% yield) of C7ₐₓ-hydroxy 43 was also isolated along with 42, 44 (51% yield), and 45 (2% yield), where ketone 44 is the major product (Scheme 5). In a side-by-side comparison of relative reaction rates and product distributions using 5 mol % each of catalysts stabilized by 1R, 1S and PVP, the relative rate of reaction from 1R was similar to that from PVP, and faster than that from 1S. There are some degrees of match and mismatch of stereochemistry between the substrate and the chiral bimetallic nanoclusters Pd/Au, where 1R matches with substrate 41 greater than 1S. By increasing the amount of t-BuOOH to 3 equiv., oxidation of 41 with 10 mol % of Pd/Au-PVP at 50° C. for 48 h, gave only 44 and 45 in 58% and 20% yield, respectively. The spectral data of 44 are identical to those reported.

Oxidation of alcohol 43 with 1 mol % of Pd/Au-PVP and 1.5 equiv. of t-BuOOH or IBX in DMSO gave ketone 44 (70% yield), whose spectra data are identical to those of 44 obtained from the catalytic oxidation reaction. Reduction of hydroperoxide 42 with Na₂S₂O₅ in 1,4-dioxane and water (9:1) gave alcohol 43 in an 85% yield. The assignment of C7-R configuration or a orientation of 43 is based on its ¹H NMR spectral data, which is different from that reported for C7-S stereoisomer of 43, obtained from sodium borohydride reduction of ketone 44. The structure of 45 was assigned based on its ¹H NMR, ¹³C NMR and mass spectra. Notably, ¹³C-NMR chemical shift of C-15 of 45 appears at δ 72.3 ppm, which is in agreement with the reported chemical shift of δ 72.3 ppm for hydroxyl analog, methyl 15-hydroxy-7-oxoabieta-8,11,13-trien-18-oate. Likely, hydroperoxide 42 and alcohol 43 form first, which subsequently oxidize to give ketone 44. The encouraging formation of 45 shows that acyclic alkanes can be oxidized albeit in a relative decreased reaction rate than that of cyclic alkanes under the reaction conditions.

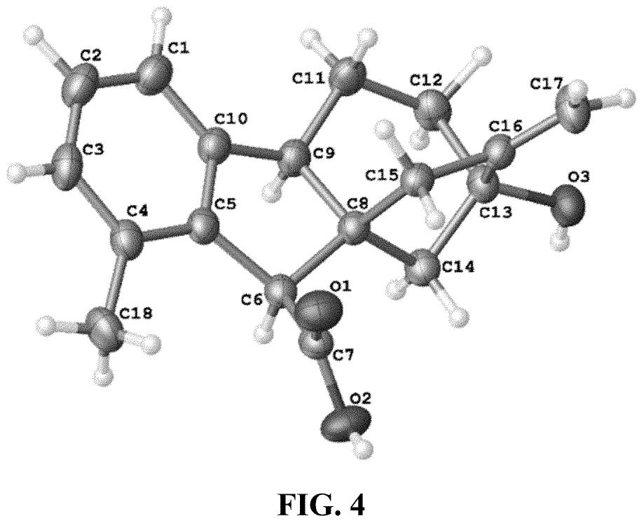

Fermentation of the fungus Gibberella fujikuroi has led to the production of large quantities of gibberellic acid. Subsequently, fragmentation of gibberellic acid in aqueous HCl gave 9-allogibberic acid (46) in a good yield. Various molecules derived from 46 have shown cytotoxicity against breast cancer and colon cancer cells. Because two opposite stereochemistry at C9 were reported in this reaction by the research groups, the structure and its relative stereochemistry were determined by X-ray analysis. Allogibberic acid (46) was obtained from an aqueous-HCl treatment of gibberellic acid. After recrystallization from diethyl ether and hexane, white crystals were obtained and the structure was solved by a single-crystal X-ray analysis and its molecular structure is revealed in FIG. 4, showing C9-α-H or R configuration and not the described S configuration.

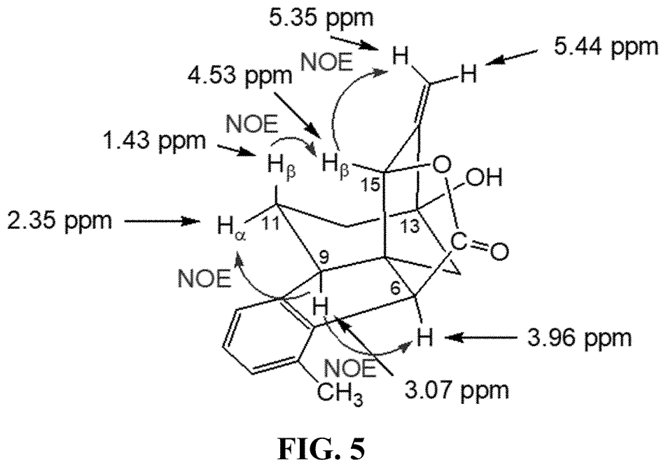

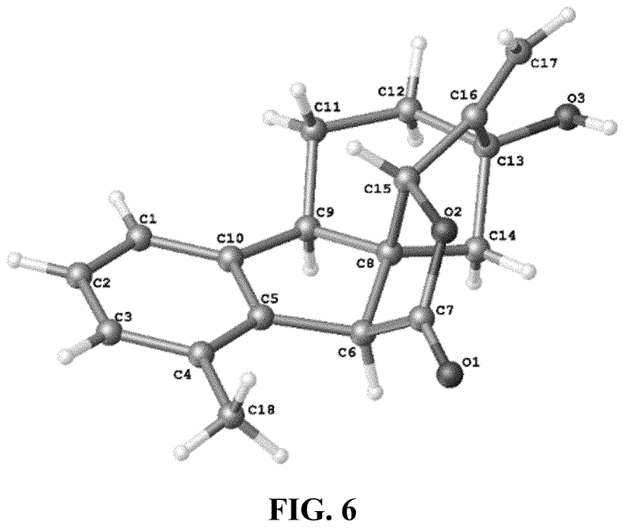

The relative reaction rate of oxidation of 46 was slow due to the bulkiness of the tetracyclic structure. However, upon heating of 46 and 1 mol % of Pd/Au-PVP (25 mM aqueous solution) and 1.5 equiv. of t-BuOOH in concentrated H₂O and CH₃CN at 70° C. for 2 days, low yields of lactone 47 (16% yield) and C6-ketone 48 (5% yield) were isolated along with 38% recovery of 46 (Scheme 5). When DMF was used as a solvent, the oxidation reaction gave a 10% yield of 47 and 3% yield of 48 as well as 32% recovered 46. Surprisingly, treatment of 46 with 1 mol % Pd/Au-1R in DMF (25 mM concentration) and 1.5 equiv. of t-BuOOH afforded 47 and 48 in a 54% and 15% yield, respectively. Under similar reaction conditions, oxidation with 1 mol % Pd/Au-1S in DMF gave respectively 24% and 4% yield of 47 and 48 along with a 30% recovery of 46. The C—H group oxidation at C9 of 46 was not found. Results indicate that oxidation reaction using 1R polymer provided greater yields of the two products than those using PVP or 1S. A match in stereochemistry of 1R derived Pd/Au nanoclusters and 46 may enhance the relative reaction rate. Oxidation of the methyl ester derivative of 46 using SeO₂ and t-BuOOH has been described previously, and the C15-hydroxy product was reported. Both lactone 47 and C6-ketone 48 have not been reported prior to this work. The structure of 47 was assigned base on its mass spectrum, ¹H, ¹³C and 2D NOESY NMR spectra. In the 2D NOESY spectrum, C15β-H at δ 4.53 ppm shows correlations with C11β-H at δ 1.43 ppm and one of the C17 olefinic Hs at δ 5.35 ppm (FIG. 5). Moreover, C15β-H has no correlation with C9α-H at δ 3.07 ppm, indicating C15β-H and C9α-H have opposite orientations. Hence, C15-oxygen orients at the α face. NOE (Nuclear Overhauser Effect) correlation was also found between C9α-H and C6a-H at δ 3.96 ppm. In addition, the structure of 47 was firmly established by a single-crystal X-ray analysis, shown in FIG. 6. It likely forms from the C—H oxidation at C15 followed by ring closing with C10-carboxylic acid group. Alternatively, a complex, RCO₂—Pd/Au—C15, forms followed by reductive elimination to give 47. Since the presumed C15-OH intermediate of 46 was not found, the latter proposed mechanism likely proceeds. The structure of 48 is assigned based on its spectral data, in which the C6-H signal at δ 4.01 ppm of 46 absents in the ¹H NMR spectrum of 48, and C9-H and C16,17-olefinic H's remain at δ 3.1, 5.06, and 4.80 ppm, respectively. The 2D NOESY showed no proton signal at C6 and low- and high-resolution mass spectra affirm the molecular formula for 48. The ¹³C NMR spectrum shows the C6-carbonyl group at δ 207.0 ppm and the IR spectrum at v 1695 cm⁻¹. Compound 48 likely forms from C—H group oxidation at C6 followed by decarboxylative fragmentation to give the ketone function. No oxidation of the alkene function was found, and the oxidation reaction took place at C6 of 46, adjacent to the electron-withdrawing group, carboxylic acid, is unusual. Moreover, the C—H group oxidation of cyclic aryl-α-carboxylic acid followed by decarboxylative fragmentation to form the corresponding ketone is a useful process such as ensuring the quality of active pharmaceutical ingredients. The availability of 47 and 48 may provide novel derivatives for biological study. To support this oxidative decarbonylation reaction, indane-1-carboxylic acid (49) was treated with 1 mol % Pd/Au-PVP and 1.5 equiv. of t-BuOOH in CH₃CN—H₂O at 50° C. 1-Indanone (50) was isolated in 40% yield along with a 45% of recovered 49.

In a comparative study, (+)-sclareolide (17), an oxidation product of (−)-ambroxide (15), has previously reported in the oxidation by bimetallic nanoclusters Cu/Au/1^{st} generation CSPVP. 17, obtained from the oxidation of 15 (see Scheme 4 & Table 3), reacted very slowly with the present catalysts. Indeed, only trace amounts of oxidation products were found when 17 was treated with 5 mol % Cu/Au/PVP (or 1R) and 2 equiv. of 30% H₂O₂ or Pd/Au/PVP and 2 equiv. of t-BuOOH at 80° C. However, treatment of 17, in a 1-gram-scale reaction, with 5 mol % of Cu/Au-1R (25 mM concentration) and 40 equiv. of 30% H₂O₂ in CH₃CN and H₂O at 90° C. for 6 days, C2-α-OH 51 (11% yield) and its ketone 52 (8% yield) along with C1-oxo 53 (4% yield) and 17 (57% recovery) were isolated (Scheme 5). Ketone 52 was derived from the oxidation of alcohol 51. Spectral data of 51, 52 and 53 are identical to those reported. Oxidation of 17 with 5 mol % Cu/Au-PVP (25 mM) and 40 equiv. 30% H₂O₂ under similar reaction conditions gave similar chemical yields as those obtained from Cu/Au-1R. Hence, the chemical yields (a total of 33% yield) from the oxidation of 17 were slightly lower than those reported using 1^{st} generation CSPVP.

Significantly, when 5 mol % Cu/Au-1S and 40 equiv. of 30% H₂O₂ were used under similar reaction conditions, only 2% and 1% yield of 51 and 52, respectively, were isolated along with 81% recovery of 17 (Scheme 5). Hence, the oxidation of 17, like 15, showed a match with Cu/Au-1R nanoclusters but a mismatch with Cu/Au-1S.

In addition, (−)-ambroxide (15) was oxidized using one of the previously reported 1^{st} generation chiral polymers, poly-(N-vinyl-5-isopropyl-pyrrolidinone; see Scheme 1, R=i-Pr) stabilized Cu/Au (5 mol %; 25 mM concentration) and 40 equiv. of 30% H₂O₂ in CH₃CN and H₂O at 80° C. for 3 days. Sclareolide (17) was isolated in 54% along with a 31% recovery of 15. Hence, the present catalysts provided a slightly better result than that of 1^{st} generation CSPVP in the oxidation of 15.

The detailed mechanism for the C—H oxidation reactions by bimetallic nanocluster/chiral and achiral polymer is unclear in part due to the unsolved bimetallic nanocluster structure. It remains undefined whether the reaction occurred at the corner or edge of the nanoclusters, on a detached metal complex by leaching from nanoclusters, or on small nanoclusters. Using a two-compartment membrane reactor along with transmission electron microscopy, Pd monomeric or dimeric moiety may have leached from the nanoclusters and probably responsible for the Pd-monometallic-nanocluster-catalyzed Sonogashira coupling reactions. Bimetallic nanoclusters derived from chiral polymers 1R and 1S showed different reactivities toward chiral ambroxide, implying that the chiral polymer involves in the oxidation reaction. A mechanism for the C—H oxidation reactions has been proposed, in that a η²-peroxido Cu^{II} (or peroxocopper) species, derived from bimetallic Cu/Au-CSPVP and H₂O₂, may include. A proposed mechanism for the C—H oxidation is depicted in Scheme 6, top panel. Bimetallic nanoclusters M/Au-1R or -PVP (where M=Cu or Pd) react with H₂O₂ or t-BuOOH to give peroxide complex I (R—O—O-M^{I}), which undergoes O—O bond cleavage to give metal-oxo-1R complex II (O=M^{II}). The oxo complex II abstracts a hydrogen atom from the substrate such as 33 (a representative cycloalkane) to form hydroxymetal complex III (HO-M^{I}) and an alkyl radical of 33. Without being bound by any theory, the radical likely complexes with the metal atom of III or in a cage, and is not a free carbon radical, since no axial-oriented hydroxyl product was found. Subsequently, the alkyl radical abstracts a hydroxyl group from III to give oxidized product 35 and regenerate M/Au-1R. The metal complex may approach the C—H bond via a “concerted oxenoid oxygen insertion” mechanism, leading to the insertion of an oxygen onto the C—H bond.

The weaker C—H bonds a to ether, aryl, and allyl functionalities as well as furan and tertiary C—H bond oxidized relatively faster than the secondary and primary C—H bonds. The bimetallic nanoclusters Cu/Au-polymer/H₂O₂ oxidative system may proceed via a different metals-polymer complexation than that of Pd/Au-polymer/t-BuOOH system, based on results of the oxidation reactions. The former may involve a tight coordinated cage system, while the latter a loose coordination or surface released or detached complex I.

The proposed pathways for the formation of 22 and 27 are described in Scheme 6, bottom panel. The oxygen of N-oxide 23 reacts with bimetallic nanoclusters Pd/Au-PVP to give complex IV, which can undergo either path a or b. In path a, an attack of H₂O to the oxygen of Pd—O—N resulting in a cleavage of O—N bond to give product amine 22 and hydroperoxide-Pd/Au complex V, which dissociates to give H₂O₂ and Pd/Au-PVP. Path b involves an oxidation reaction in which the O—N bond of IV breaks by shifting two electrons to the electron-negative oxygen, resulting O=Pd^{II} species VI and aminium cation VII. The O=Pd^{II} species VI abstracts an α-proton of the amine function of VII to give HO—Pd^{I} complex VIII and iminium ion IX. A lost of a β-proton of IX by VIII leads to vinylamine 27 and Pd/Au-PVP along with H₂O.

In summary, second-generation CSPVPs, (−)-1R, (+)-1S and (−)-2 were synthesized from D-isoascorbic acid, D-ribose, and L-(S)-malic acid, respectively. CD spectra of the bimetallic nanoclusters showed distinct chiroptical responses, derived from chiral-polymer encapsulated nanomaterials. Efficient catalytic C—H oxidation reactions were found using catalytic amounts of bimetallic nanoclusters Cu/Au or Pd/Au stabilized by PVP or CSPVP and H₂O₂ or t-BuOOH as an oxidant. The regioselective C—H oxidations at the α-carbon of ether function of medium-sized molecule (−)-ambroxide and (R)-(+)-menthofuran, tertiary carbon of N-acetylamantadine, tertiary and secondary carbons of 1-adamantanol and N-acetylmemantine, and benzylic oxidation of (+)-2,9-di(O-pivalyl)-boldine N-oxide, (+)-3-O-pivalyl-estrone, (+)-N-acetyl-dehydroabietylamine, (−)-9-allogibberic acid, and (+)-sclareolide may offer various methodologies for modification of complex molecules. New oxidative reactions were discovered including selective α-C—H oxidation of the N-oxide function of boldine-N-oxide using NMO, oxidative ring closing of allogibberic acid at C-15 with the adjacent C10-carboxylic acid group, and decarboxylative oxidation at C-6 of allogibberic acid. These reactions offer new synthetic pathways in organic functional group transformation. A library of molecules can be produced from the aforementioned oxidatively modified natural products via further functional group manipulation.

Oxidative and Catalytic C—C Bond Forming Reactions. Indication of Formation of C—Pd and C—Cu Intermediates in Bimetallic Nanoclusters Catalysts.

Oxidative and catalytic C—C bond forming reactions according to exemplary embodiments of the present invention are illustrated in Schemes 7, below.

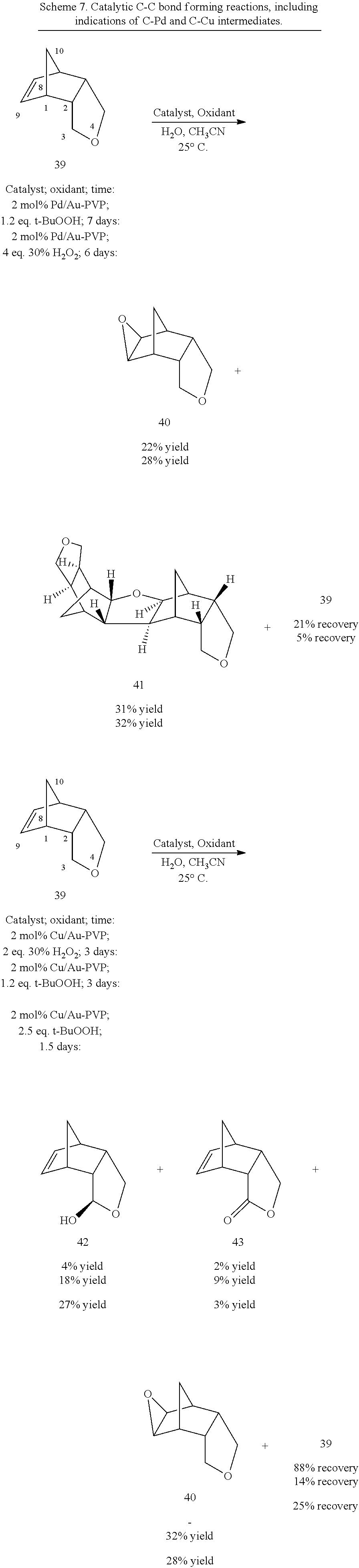

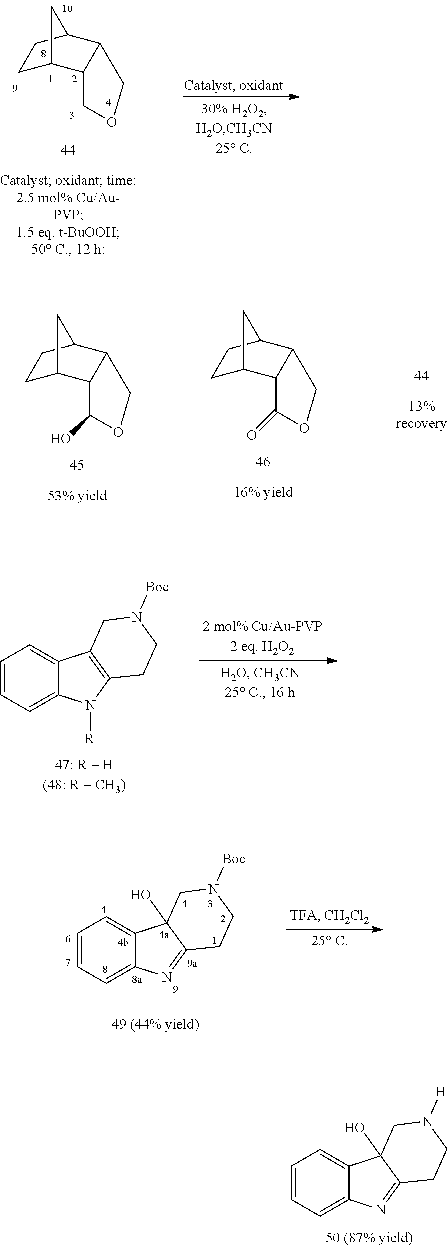

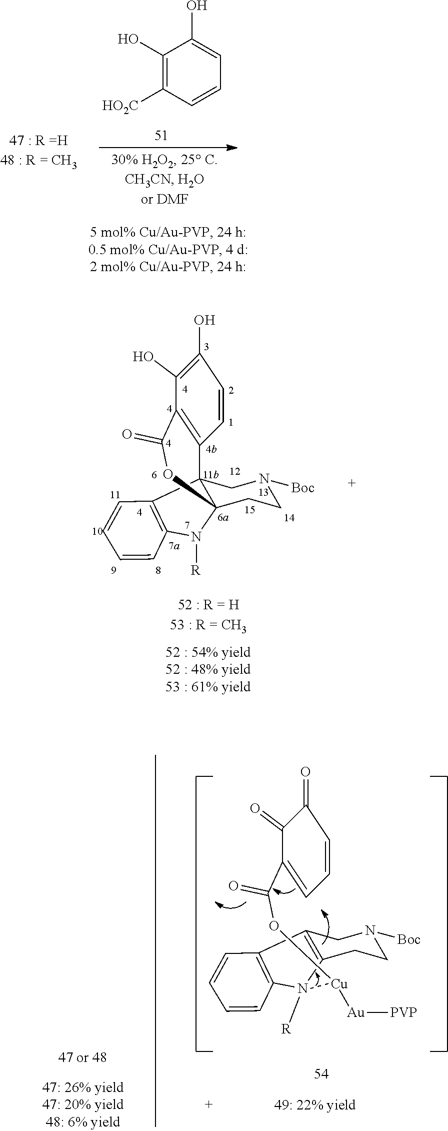

The development of catalytic C—H functionalization, enabling C—C and C-heteroatom bond formation, is a challenging and synthetically useful process. Notably, indication of the formation of C—Pd or C—Cu intermediate in the bimetallic nanoclusters catalyzed oxidation reactions may lead to various applications for the formation of C—C or C-heteroatom bond. Oxidation of tricyclic norborene-fused tetrahydrofuran 39 with 2 mol % of Pd/Au-PVP and 4 equiv. of H₂O₂ at 25° C. gave a 32% yield of dimeric-liked molecule 41 and 28% yield of epoxide 40. The structure of 41 was characterized by a single-crystal X-ray analysis, showing two units of norbornane join together to form a tetrahydrofuran ring by one C—C bond and two C—O bonds. Two methylene bridges of the two norbornane units of 41 are opposite to each other and the C—C bond and two C—O bonds orient at the exo face in each of the two norbornane units. It is proposed that (PVP)-(Au)—Pd^{I}-OH forms and coordinates to the alkene function of 39, which proceeds exo-syn-addition, resulting in 9-hydroxy-8-palladium intermediate, a C—Pd intermediate. It can then proceed by either by a fragmentation to give epoxide 40 or by a cis-exo addition onto the alkene function of an additional molecule 39 to give an oxopalladacyclohexane complex, a C—C bond forming reaction. Reductive elimination from the complex furnishes dimeric-liked species 41. Noteworthy, the aforementioned oxidation reactions took place at 25° C. implying the reactions require relatively low activation energies and may be applicable to other systems.

Oxidation of 39 with Cu/Au-PVP provided catalytic C—H oxidation at the α-carbon of the ether function. Hence, treatment of 39 with 2 mol % Cu/Au-PVP and 2.5 equiv. of t-BuOOH at 25° C. yielded lactol 42 and lactone 43 in 27% and 3% yield, respectively, along with 28% yield of epoxide 40 (Scheme 7). Without the alkene function, 44 underwent predictive C—H oxidation to give 45 and 46 in 53 and 16% yield, respectively. Lactol 45 is the precursor of 46 in the oxidation reaction. Results have been published in a manuscript.

Next, the oxidation of N2-Boc-1,2,3,4-tetrahydro-γ-carboline (47) was investigated in search of the possible existence of C—Pd or C—Cu intermediate. Carboline 47 possesses a reactive indolyl alkene function and potent histone deacetylase 6 inhibition. Oxidation of 47 with 2 mol % of Cu/Au-PVP and 2 equiv. of 30% H₂O₂ in acetonitrile and water at 25° C. for 16 h gave the 4a-hydroxyl product 49 (44% yield; Scheme 7), The formation of 49 likely derives from a β-elimination of an adduct intermediate, resulting from the addition of HO group onto C4a and Cu onto C9a, a C—Cu intermediate. The (3-elimination consists of the exclusion of C9a-Cu and N9-H.

Based on the proposed C—Cu bond formation, we investigated the bimolecular coupling reaction of 47 and 2,3-dihydroxybenzoic acid (51). Excitingly, treatment of 47 with an equimolar 51, 5 mol % of Cu/Au-PVP, and 1.2 equiv. of 30% hydrogen peroxide at 25° C. for 24 h, afforded a 54% yield of a [4+2] cycloadduct, 52, along with a 26% recovery of 47 (Scheme 7). The structure of 19 unequivocally confirmed by a single-crystal X-ray analysis. A lesser amount of catalyst and greater amount of oxidant appear to diminish the formation of bimolecular product and increase the oxidation of the indole ring. Similarly, when N9-methyl-N2-Boc-1,2,3,4-tetrahydro-γ-carboline (48) and 51 were subjected to 2 mol % of Cu/Au-PVP and 3 equiv. of 30% H₂O₂ in DMF at 25° C. for 24 h, the corresponding [4+2] cycloadduct 53 was isolated in a 61% yield along with 6% recovery of 48. Cycloaddition of N-alkyl γ-carbolines such as 48 has not been reported previously, which may provide synthetic routes leading to complex multi-ring alkaloids, such as voacalgines. Since Cu possesses a high affinity to the carboxylic acid group, our finding implies that Cu/Au-PVP nanoparticles complex with the pair of electrons on nitrogen-9 of 47 or 48 and the carboxylic acid moiety of 51 followed by oxidation of the two hydroxyl groups of the catechol ring to form ortho quinone group by Cu/Au-PVP-H₂O₂, and subsequent formation of C11b-C4b bond, through a nucleophilic addition reaction, as suggested in structure 54. An addition from the carboxylate oxygen onto C6a-N7 imino-double bond and aromatization via C4b-hydrogen shift and protonation leads to 52 or 53. The catalytic reactions are efficient and the one-to-one cycloadduct 52 or 53 was the predominant product. A possible formation of Cu-C11b bond, from a resonance structure of 54, in the joining of C11b and C4b bond. Noteworthy, catalytic oxidation of 47 and 51 with 4 mol % Pd/Au-PVP in DMF at 25° C. over 2 days gave only recovered starting material 47 and no [4+2] cycloadduct 52, suggesting the absence of or a weak complexation of Pd—Au and the carboxylic acid group of 51, diminishes the cycloadduct formation. The Cu/Au-PVP catalyzed coupling reactions appear to be general and analogs can be synthesized and bioevaluated.

### Examples

The following sets forth experimental information regarding the synthesis of various compounds in accordance with the present invention and exemplary reactions that are catalyzed with those compounds. It is to be understood, however, that these examples are provided by way of illustration and nothing therein should be taken as a limitation upon the overall scope of the invention.

Chiral substituted poly-N-vinylpyrrolidinones (CSPVPs) (−)-1R and (+)-1S were synthesized by a free-radical initiated polymerization of (3aR,6aR)- and (3aS,6aS)-5-ethenyl-tetrahydro-2,2-dimethyl-4H-1,3-dioxolo[4,5-c]pyrrol-4-one, respectively, under thermal and photochemical reactions. The aforementioned chiral N-vinyllactams were conveniently produced from respective D-isoascorbic acid and D-ribose. In addition, chiral polymer (−)-2 was also synthesized from the polymerization of (S)-3-(methoxymethoxy)-1-vinylpyrrolidin-2-one. Molecular weights of these chiral polymers were measured using high-resolution mass spectrometry and the polymer chain tacticity was studied using ¹³C NMR spectroscopy. Results suggest that isotactic, syndiotactic and heterotactic triads presented in the polymer chains. Chiral polymers (−)-1R, (+)-1S, and (−)-2 along with poly-N-vinylpyrrolidinone (PVP, MW 40K) were separately used in the stabilization of Cu/Au or Pd/Au nanoclusters. CD spectra of the bimetallic nanoclusters stabilized by (−)-1R and (+)-1S showed close to mirror-imaged CD absorption bands at wavelengths 200-300 nm, revealing bimetallic nanoclusters' chiroptical responses are derived from chiral-polymer encapsulated nanomaterials and not from the chiral polymer alone. Chemo-, regio- and stereo-selectivity were found in the catalytic C—H group oxidation reactions of complex polycyclic natural products, such as ambroxide, menthofuran, boldine, estrone, dehydroabietylamine, 9-allogibberic acid, and sclareolide, and bioactive substituted adamantane molecules, when catalyst Cu/Au (3:1) or Pd/Au (3:1) stabilized by CSPVPs or PVP and oxidant H₂O₂ or t-BuOOH were applied. Particularly, oxidation of (+)-boldine N-oxide 23 using NMO as an oxidant resulted 4,5-dehydroboldine 27 in a 63% yield and oxidation of (−)-9-allogibberic acid yielded the corresponding C6,15 lactone 47 (54% yield) and C6-ketone 48 (15% yield).

¹H NMR (400 MHz and 600 MHz) and ¹³C NMR (100 MHz and 150 MHz) spectra were obtained from a Bruker Avance Neo 400-MHz and a 600-Mz Bruker NMR spectrometers, and were measured from a solution in CDCl₃ unless otherwise mentioned. The chemical shift data reported in ¹H NMR are given in units of δ relative to TMS (δ=0) or CHCl₃ (δ=7.26 ppm). For ¹³C NMR spectra, the chemical shifts are recorded relative to CDCl₃ (δ=77.0 ppm). Low-resolution mass spectra were taken from a Waters Acquity TQD Ultra Performance LC/MS/MS system. High-resolution mass spectra were obtained using a LCT Premier time of flight mass spectrometer (Waters Inc.). IR spectra were measured directly in either solid or liquid form using a Cary 60 FTIR (Agilent Technologies Inc.). Optical rotations were measured from a Perkin-Elmer 241 polarimeter. Inductively coupled plasma-mass spectra (ICP-MS) were taken from a Perkin-Elmer NexION® 300D ICP-MS instrument. Transmission electron microscopy (TEM) images were taken from a FEI CM100 TEM instrument (Technical Sales Solutions Inc.). Polymer molecular weights were determined on a Water Xevo G2-XS QTOF Quadrupole Time-of-Flight Mass Spectrometry. Intrinsic viscosity of the polymers were measured using an Ubbelohde viscosimeter (dØ=0.7-0.8 mm). The uniformity of the polymers were studied using a Shimadzu UFLC-20AD-HPLC analytical system equipped with an ELSD-LTII (evaporative light-scattering) detector along with UV and RI detectors. Two connected size-exclusion columns, TSKgel α-400 (7.8 mm I.D.×30 cm; 10 μm) and TSKgel α-M (7.8 mm I.D.×30 cm; 13 □m) (from Tosoh Bioscience, Grove City, Ohio) were used with methanol as solvent and a flow rate of 1 mL/min. AFM images were taken from a Nanoscope IIIa SPM atomic force microscope (Digital Instrument). Dynamic light scattering spectra were taken from a ZetaPALS zeta potential analyzer (Brookhaven Instrument Co.). Vivaspin 20 centrifugal filter device with a 3,000 MWCO was purchased from Sartorius Inc. Inorganic chemical Na₂PdCl₄ and CuCl were purchased from Fisher Scientifics and tetrachloroauric (III) acid·trihydrate (HAuCl₄·3H₂O) purchased from VWR Int. All solvents distilled over appropriated drying agent such as CaH₂ for DMF, dichloromethane and acetonitrile, or Na/benzophenone for THE and diethyl ether. Flash column chromatography was carried out on silica gel (200-400 mesh) for purification of organic products. (−)-Ambroxide, R-(+)-menthofuran, (+)-boldine, 1-adamantanol, amantadine, memantine, estrone, dehydroabietylamine, and gibberellic acid were purchased from Fisher Scientific Inc. or VWR International, Inc.

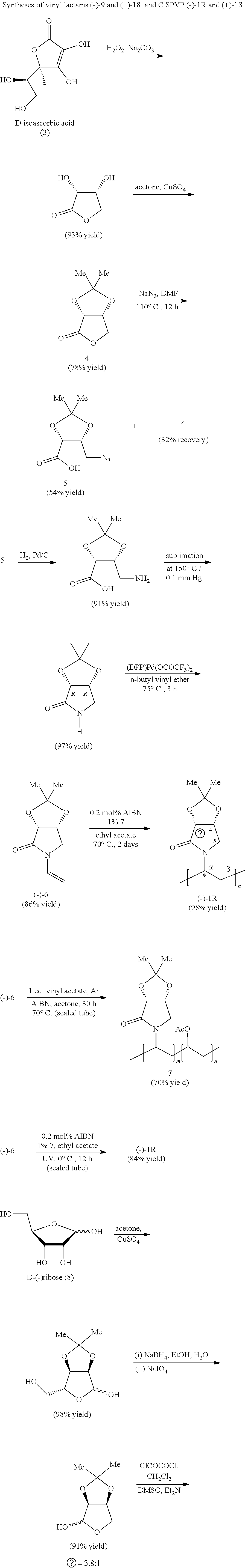

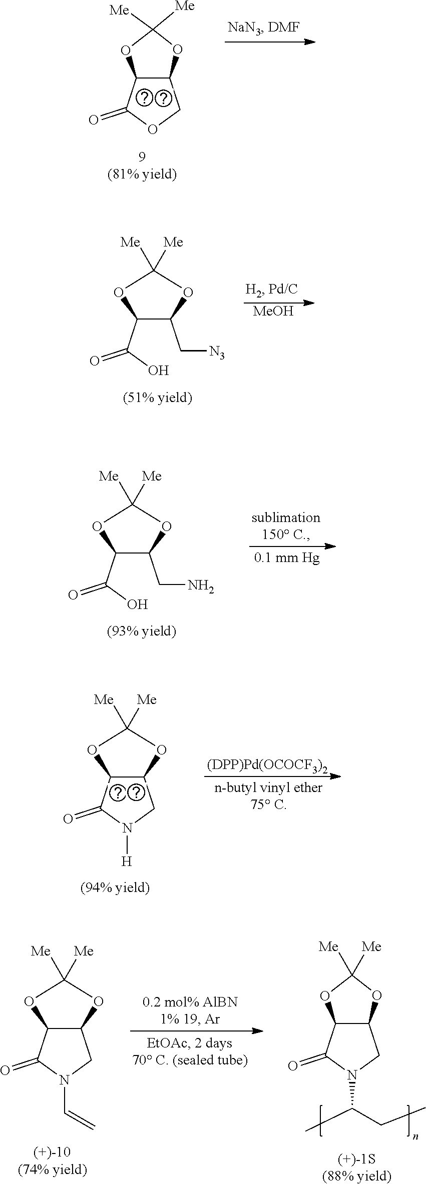

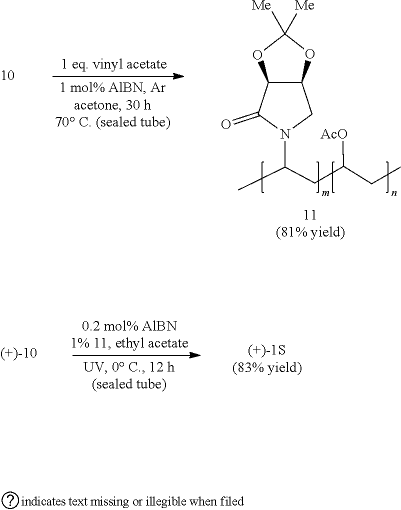

(3R,4R)-3,4-Dihydroxy-dihydrofuran-2(3H)-one. To a cold (0° C.) solution of 17.6 g (0.1 mol) of D-isoascorbic acid (3) and 21.2 g (0.2 mol) of Na₂CO₃ in 250 mL of H₂O was added 22.7 g (0.2 mol) of 30% H₂O₂ dropwise over 20 minutes. The resulting solution stirred at 0° C. for 10 minutes and 42° C. for 30 minutes. To it, 4.0 g of activated charcoal was added in portion over 10 minutes, and the mixture was stirred at 80° C. for 30 minutes, filtered through Celite while the mixture was still hot, and washed the filter cake with 50 mL of warm H₂O. The filtrate was carefully acidified with 6N HCl solution to pH ˜1, concentrated on a rotary evaporator and then under vacuum to give 36.9 g of solid. The crude product was diluted with 200 mL of ethyl acetate, heated to reflux for 10 minutes, and the resulting hot mixture was filtered. The filtrate containing the desired product was saved. The solid was extracted by dilution with 200 mL of ethyl acetate, heated to reflux, and filtered. This process was repeated one more time. The filtrates were combined, cooled over an ice-water bath, and the crystallized white solids were collected by filtration to give 11.0 g (93% yield) of the titled compound, m.p. 97-98° C. (Lit. 97.5-99° C.); [α]_{D}²²=−73.2 (c 0.5, H₂O) {Lit. [α]_{D}²⁰=−72.8 (c 0.498, H₂O)}; ¹H NMR (D₂O) δ 3.99 (d, J=4 Hz, 1H, C3H), 3.85 (q, J=4 Hz, 1H, C4H) 1H), 3.55-3.52 (m, 2H, C5H); ¹³C NMR (D₂O) δ 177.1, 72.5, 70.1, 69.0; MS (ESI, MeOH): m/z=141.4 ([M+Na]⁺).

(2R,3R)—O-Isopropylidene-D-erythronolactone (4). To a solution of 6.73 g (56.9 mmol) of (3R,4R)-3,4-dihydroxy-dihydrofuran-2(3H)-one in 84 mL of acetone (freshly distilled over CaSO₄) under argon at 25° C. was added 15.1 g (94.9 mmol) of anhydrous CuSO₄ (a trace amount of water was needed for the reaction to proceed) and the mixture was stirred for 36 h. The precipitated inorganic salt was removed by filtration over a pad of Celite and the filtrate concentrated to dryness under reduced pressure leaving yellow solids. This crude product was column chromatographed on silica gel using a gradient mixture of hexane and ethyl acetate as eluent to give 7.04 g (78% yield) of compound 4 as a pale yellow solid, m.p. 67-68° C. (Lit. 66° C.); [α]_{D}²²=−114.6 (c 1.5, acetone) {Lit. [α]_{D}²⁰−111.9 (c 2.2, acetone)}; ¹H NMR δ 4.85 (dd, J=6, 4 Hz, 1H), 4.75 (d, J=6 Hz, 1H), 4.48 (d, J=11 Hz, 1H), 4.41 (dd, J=11, 4 Hz, 1H), 1.50 (s, 3H), 1.41 (s, 3H); ¹³C NMR δ 174.8, 113.9, 75.8, 74.8, 70.5, 26.9, 25.6; MS (ESI, MeOH): m/z=181.3 ([M+Na]⁺), 95.6. Spectral data is in agreement with that reported.

(2R,3R)-4-Azido-4-deoxy-2,3-O-isopropylidene-D-erythronic acid (5). A solution of 6.0 g (38.0 mmol) of compound 4 and 8.22 g (0.127 mol) of NaN₃ in 38 mL of distilled DMF under argon was heated to 110° C. for 24 h. The solution was cooled to 25° C., diluted with 250 mL of a mixture of diethyl ether and H₂O (1:1), and the two layers were separated. The diethyl ether layer was washed with water, dried over anhydrous Na₂SO₄, and concentrated to dryness leaving 1.92 g of starting 4 (32% recovery). The aqueous layer was adjusted the pH to ˜2 with 20% aqueous HCl and extracted four times with ethyl acetate. The combined ethyl acetate extracts were washed with brine, dried (MgSO₄), concentrated to dryness, and column chromatographed on silica gel using a gradient mixture of hexane and ethyl acetate as an eluent to give 4.108 g (54% yield) of compound 5: [α]_{D}²²=+71.6 (c 0.5, acetone) {Lit. [α]_{D}²⁰=+72 (c 0.47, acetone)}; ¹H NMR δ 9.52-9.0 (bs, 1H, OH), 4.67 (d, J=7.2 Hz, 1H), 4.60-4.56 (m, 1H), 3.60 (dd, J=13.2, 3.2 Hz, 1H), 3.40 (dd, J=13.2, 6 Hz, 1H), 1.63 (s, 3H), 1.42 (s, 3H); ¹³C NMR δ 172.2, 112.2, 73.8, 70.8, 52.0, 27.1, 26.2; MS (ESI, MeOH): m/z=224.1 ([M+Na]⁺), 143.6, 85.6. The spectral data is in agreement with that reported.

(2R,3R)-4-Amino-4-deoxy-2,3-O-isopropylidene-D-erythronic acid. To a solution of 1.01 g (5.0 mmol) of compound 5 in 100 mL of methanol, was added 50 mg of 10% Pd/C, and the mixture was maintained under 2 atmospheric of hydrogen gas and shaken for 4 h on a hydrogenator. Hydrogen in the reaction mixture was released and maintained under normal condition. The mixture was filtered through a pad of Celite and washed three times with methanol. The filtrate was concentrated to dryness leaving 0.79 g (91% yield) of the titled compound as a pale yellow oil. This material was used in the subsequent step without purification. [α]_{D}²²=+91.6 (c 1.0, 60% aqueous acetone) {Lit. [α]_{D}²⁰=+92 (c 1.02, 60% aqueous acetone)}; ¹H NMR (DMSO-d6) δ 4.39 (d, J=7.2 Hz, 1H), 4.31-4.24 (m, 1H), 2.76 (t, J=8 Hz, 2H), 1.39 (s, 3H), 1.23 (s, 3H); ¹³C NMR (D₂O) δ 174.1, 111.1, 76.8, 72.5, 40.6, 26.5, 24.2; MS (ESI, MeOH): m/z=176.1 ([M+H]⁺), 198.1 ([M+Na]⁺). The spectral data is in agreement with that reported.

(−)-(3aR,6aR)-Tetrahydro-2,2-dimethyl-4H-1,3-dioxolo[4,5-c]pyrrol-4-one. To a sublimator, 2.80 g (16 mmol) of (2R,3R)-4-amino-4-deoxy-2,3-O-isopropylidene-D-erythronic acid was placed and the contend was heat at 150° C. under 0.1-0.5 mm Hg vacuum. After the sublimation process was completed, the sublimator was cooled to 25° C. and the product was collected to give 2.42 g (97% yield) of the titled compound as white solids. M.p. 148-149° C.; Lit. 147-148° C.; [α]_{D}²²=−60.3 (c 0.78, MeOH) {Lit. −59.0 (c 0.78, MeOH)}; ¹H NMR δ 6.10-5.80 (bs, 1H, NH), 4.79 (t, J=5.9 Hz, 1H), 4.58 (d, J=5.9 Hz, 1H), 3.59 (dd, J=11.5, 4.8 Hz, 1H), 3.49 (d, J=11.5 Hz, 1H), 1.49 (s, 3H), 1.39 (s, 3H); ¹³C NMR δ 174.4, 114.3, 75.7, 74.9, 45.9, 27.0, 25.9; MS (ESI, MeOH): m/z=158.4 ([M+H]⁺). The spectral data is in agreement with that reported.

(−)-(3aR,6aR)-5-Ethenyl-tetrahydro-2,2-dimethyl-4H-1,3-dioxolo[4,5-c]pyrrol-4-one (6). To a solution of 90 mg (0.57 mmol) of (−)-(3aR,6aR)-tetrahydro-2,2-dimethyl-4H-1,3-dioxolo[4,5-c]pyrrol-4-one in 10 mL of n-butyl vinyl ether, was added 18 mg (0.028 mmol) of (DPP)Pd(OCOCF₃)₂. The mixture was stirred at 75° C. for 3 h, cooled to 25° C., filtered through a pad of silica gel, washed with ethyl acetate, concentrated under vacuum, and column chromatographed on silica gel using a mixture of hexane and ethyl acetate (5:1) as an eluent to give 90 mg (86% yield) of 6 as white solids. Mp. 81-82° C.; [α]_{D}²²=−20.1 (c 1.0, CHCl₃); ¹H NMR δ 7.05 (dd, J=16.0, 9.2 Hz, 1H, CH═), 4.82-4.79 (m, 1H), 4.70 (d, J=6.4 Hz, 1H), 4.53 (d, J=9.2 Hz, 1H, ═CH₂), 4.48 (d, J=16 Hz, 1H, ═CH₂), 3.65 (dd, J=10, 1.5 Hz, 1H), 3.64 (dd, J=10, 4 Hz, 1H), 1.39 (s, 3H), 1.35 (s, 3H); ¹³C NMR δ 169.4, 129.2, 113.0, 96.7, 78.1, 72.1, 48.7, 27.2, 25.9. MS (ESI, MeOH): m/z=184.0 ([M+H]). HRMS-ESI: m/z [M+H]⁺ calcd for C₉H₁₄NO₃⁺: 184.0974 found: 184.0952. The solid was crystallized from diethyl ether to give colorless crystals, whose structure was verified by a single-crystal x-ray analysis (FIG. 1).

Poly(3R,4R-3,4-dimethyl-N-vinylpyrrolidinone-co-vinyl acetate) [P(DVP-co-VAc)] (7). Note: It is important to remove oxygen and water from the substrates, radical initiator and solvent for polymerization reactions. The substrates, radical initiator azobisisobutyronitrile (AIBN; recrystallized twice from methanol), and solvent (acetone was distilled over anhydrous K₂CO₃ under argon and then degassed using argon) have been carefully dried and transferred into a glove box, keeping under positive nitrogen atmosphere. A solution of 4 mg (0.024 mmol) of azobisisobutyronitrile (AIBN) in 1 mL of acetone was prepared inside the glove box. To a sealed tube in a glove box, 44 mg (0.24 mmol) of N-vinylpyrrolidinone 6 and 22 μL (0.24 mmol) of vinyl acetate (distilled and degassed) were added. To it, 100 μL (2.4 μmol; 1 mol %) of AIBN in acetone was added, and the tube was capped by a Teflon stopper. The sealed tube was transferred to a hood and heat at 70° C. for 24 h. The reaction solution was cooled to 25° C., diluted with hexane, and stirred for 10 min. The white precipitate was collected by filtration, washed with hexane, and dried under vacuum to give 46 mg (70% yield) of copolymer 7 as white solids. Notably, the relative rate of polymerization of vinyl lactam 6 is slightly greater than that of vinyl acetate. ¹H NMR δ 4.90-4.40 (m, 3H), 3.60-3.00 (m, 3H), 2.13 (s, 3H), 2.10-1.20 (m, 10H); ¹³C NMR δ 172.5-169.0 (m), 112.0 (s), 77.23, 72.3, 47.0-42.0 (m), 37.0-32.0 (m), 27.3, 25.4, 21.2.

The syntheses of polymers (−)-1R, (+)-1S, and (−)-2 were conducted by two different methods, thermal and photochemical polymerizations of vinyllactams, (−)-6, (+)-10, and (−)-13, respectively.

Poly[(3aR,6aR)-2,2-dimethyl-5-vinyl-dihydro-3aH-[1,3]dioxolo[4,5-c]pyrrol-4(5H)-one][(−)-(1R)] from thermal reaction. Note: the substrates, radical initiator AIBN, and solvent (ethyl acetate was distilled over CaH₂ under argon and then degassed using argon) have been carefully dried and transferred into a glove box, which maintained under positive nitrogen atmosphere. A solution of 4.0 mg (0.024 mmol) of AIBN in 2.0 mL of ethyl acetate was prepared inside the glove box. To a sealed tube in a glove box, 0.50 g (2.73 mmol) of (−)-6 and 5 mg of copolymer 7 were added followed by 0.45 mL (5.4 μmol; 0.2 mol %) of the AIBN-ethyl acetate solution (as described above) along with 1 mL of ethyl acetate. The tube was sealed with a Teflon cap, transferred outside of the glove box, stirred at 70° C. for 48 h, cooled to 25° C., and diluted with hexane to precipitate the polymer. The precipitate was collected by filtration, dried under vacuum to give 0.49 g (98% yield) of chiral polymer (−)-1R as a white solid; [α]_{D}²²=−42.7 (c 0.5, H₂O). The number average molecular weight (Mₙ) and weight average molecular weight (M_{w}) of 85,232.5236 and 89,051.4707 (n=486), respectively, were determined by high-resolution mass spectrometry. IR (solid) v 2939, 1648.0 (s), 1458.6, 1420.3, 1285.4 (s), 1169.4, 1024, 830 cm⁻¹. ¹H NMR δ 4.80-4.45 (bs, 2H, CHO), 3.8-3.0 (m, 3H, CHN, CH₂N), 1.80-1.2 (m, 8H, CH₂, 2 CH₃); ¹³C NMR δ 171.6 (m), 112.1 (bs, O—C—O), 78.0 (bs, C—O), 72.4 (bs, C—O), 47.0-43.0 (m, CHN and CH₂N), 36.5-31.0 (m, CH₂), 27.4 (bs), 25.4 (bs).

Poly[(3aR,6aR)-2,2-dimethyl-5-vinyl-dihydro-3aH-[1,3]dioxolo[4,5-c]pyrrol-4(5H)-one] [(−)-(1R)] by photochemical reaction. Following aforementioned procedure, a solution of 53 mg (0.29 mmol) of vinyl lactam (−)-6, 0.53 mg (1% by weight) of copolymer 7, and 0.095 mg (0.57 μmol) of AIBN in 0.5 mL of ethyl acetate was added to a sealed tube. The sealed tube was cooled over an ice-water bath and irradiated with a Hanovia UV lamp (model 679A36) ˜10 cm away from the tube. After irradiated for 12 h, the reaction tube was removed from irradiation and diluted with 2 mL of dichloromethane. The solution was added to 50 mL of a mixture of pentane and diethyl ether (1:1) and the precipitated white solid was collected by filtration to give 44 mg (84% yield) of chiral polymer 1R: [α]_{D}²²=−38.0 (c 0.5, H₂O). The number average molecular weight (Mₙ) and weight average molecular weight (M_{w}) of 51,795.4751 and 53,547.9789 (n=292), respectively, were determined by high-resolution mass spectrometry. ¹H and ¹³C NMR spectra were similar to those described above, obtained from the thermal reaction.

β-D-2,3-O-(1-Methylethylidene)-ribofuranose. To a solution of 15.0 g (0.10 mol) of D-ribose (8) in 200 mL of acetone under argon was added 30 g (0.19 mol) of CuSO₄, and the solution was stirred at 25° C. for 40 h. The mixture was filtered through Celite and washed with acetone three times. The filtrate was concentrated under reduced pressure to give 18.6 g (98% yield) of the titled compound as white solids, which were used in the subsequent reaction without purification. A small amount of the material was purified by silica gel column chromatography using a mixture of hexane and ethyl acetate (1:2) as an eluent to give the title compound as an oil. NMR spectra showed a mixture of β and α anomers in a ratio of 8:1: [α]_{D}²²=−34.2 (c 1.69, acetone); {Lit. [α]_{D}²⁰=−39.05 (c 1.68, acetone}; β-Isomer: ¹H NMR δ 5.52 (d, J=6.0 Hz, 1H), 5.41 (d, J=5.4 Hz, 1H), 4.81 (d, J=5.9 Hz, 1H), 4.58 (d, J=5.9 Hz, 1H), 4.39 (s, 1H), 4.25-4.15 (br s, 1H), 3.73-3.71 (br s, 2H), 1.49 (s, 3H), 1.33 (s, 3H); ¹³C NMR δ 112.2, 102.7, 87.6, 86.7, 81.6, 63.5, 26.3, 24.7. The spectral data is in agreement with that reported.

(3aS,4S,6aS)-2,2-Dimethyl-tetrahydrofuro[3,4-d][1,3]dioxol-4-ol. To a cold (0° C.) solution of 10.0 g (52.6 mmol) of β-D-2,3-O-(1-methylethylidene)-ribofuranose in 60 mL of ethanol and 250 mL of water, was added dropwise of a cold (0° C.) solution of 2.98 g (79 mmol) of sodium borohydride in 60 mL of water, warmed to 25° C. and stirred for 14 h. To it, 12 mL of 10% aqueous acetic acid solution was added to adjust the pH to ˜5. The solution was diluted with 80 mL of water, cooled over ice-water bath, and added 13.5 g (63 mmol) of NaIO₄ in portions over 5 minutes. The reaction solution was stirred at 25° C. for 3 h, concentrated on a rotary evaporator to −50 mL, and extracted with ethyl acetate four times (50 mL each). The combined extracts were washed with water and brine, dried (anhydrous Na₂SO₄), concentrated to dryness to give 7.66 g (91% yield) of the titled compound, whose NMR spectrum showed a mixture of α and β anomers in a ratio of 3.8:1. This compound was used in the following step without further purification. [α]_{D}²²=+71.0 (c 1.0, CHCl₃), {Lit. [α]²⁰_{D}=+74.8 (c 2.51, MeOH)}; α-anomer: ¹H NMR δ 5.43 (s, 1H, C1-H), 4.87 (dd, J=6, 3.6 Hz, 1H, C3-H), 4.61 (d, J=6 Hz, 1H, C2-H), 4.11 (dd, J=10.4, 3.6 Hz, 1H, C4-H), 4.06 (d, J=10.4 Hz, 1H, C4-H), 2.80-2.70 (bs, 1H, OH), 1.48 (s, 3H), 1.33 (s, 3H); ¹³C NMR δ 112.3, 101.8, 85.1, 80.0, 72.0, 26.2, 24.7; α-anomer: ¹H NMR δ 5.00-4.90 (m, 1H, C1-H), 4.76 (dd, J=6, 3.6 Hz, 1H, C3-H), 4.49 (d, J=6 Hz, 1H, C2-H), 3.95 (d, J=10.4 Hz, 1H, C4-H), 3.55 (dd, J=10.4, 3 Hz, 1H, C4-H), 1.80-1.60 (bs, 1H, OH), 1.55 (s, 3H), 1.38 (s, 3H); ¹³C NMR δ 113.4, 97.4, 79.6, 78.3, 67.6, 26.0, 24.9. The spectral data is in agreement with that reported.

(3aS,6aS)-2,2-Dimethyl-dihydrofuro[3,4-d][1,3]dioxol-4(3aH)-one (9). To a dried flask containing 1.0 g of 3 Å molecular sieves and 100 mL of dichloromethane under argon at −78° C., were added 5.3 mL (63 mmol) of freshly distilled oxalyl chloride followed by a solution of 8.9 mL (0.125 mol) of dry DMSO in 25 mL of dichloromethane. The reaction mixture was stirred at −78° C. for 15 min. To it, was added a solution of 4.887 g (30.5 mmol) of (3aS,4S,6aS)-2,2-dimethyl-tetrahydrofuro[3,4-d][1,3]dioxol-4-ol in 25 mL of dichloromethane. The resulting solution was stirred at −78° C. for 0.5 h, added 27 mL (0.19 mol) of distilled triethylamine, and stirred at −78° C. for 0.5 h and 25° C. for 14 h. The mixture was diluted with water (100 mL), acidified with 1N HCl to pH 2, and extracted four times with dichloromethane (100 mL each). The combined extract was washed with aqueous NH₄Cl, water and brine, dried (anhydrous Na₂SO₄), and concentrated to give 4.01 g (81% yield) of lactone 9. Compound 9: [α]_{D}²⁰=+116.0 (c 1.5, acetone), {Lit. +116.3 (c 1.49, acetone)}; ¹H NMR δ 4.89 (dd, J=6, 4 Hz, 1H), 4.76 (d, J=6 Hz, 1H), 4.47 (d, J=11 Hz, 1H), 4.42 (dd, J=11, 4 Hz, 1H), 1.50 (s, 3H), 1.41 (s, 3H); ¹³C NMR δ 174.1, 114.1, 75.5, 74.6, 70.2, 26.8, 25.7. The spectral data is in agreement with that reported.

(4S,5S)-5-(Azidomethyl)-2,2-dimethyl-1,3-dioxolane-4-carboxylic acid. To a flame dried flask, were added 1.22 g (7.7 mmol) of lactone 9 and 1.5 g (23.1 mmol) of NaN₃ under argon at room temperature. The mixture was dried under vacuum for 30 min, then freshly distilled DMF (15 mL) was added and heated at 120° C. with stirring for 22 h. The reaction mixture was cooled to room temperature and diluted with H₂O (40 mL), extracted with diethyl ether three times (50 mL each). The combined organic layer was washed with brine, dried (anhydrous Na₂SO₄), and concentrated to recover 62 mg (5% recovery) of lactone 9. The aqueous layer was acidified with 1 N HCl to pH 2.0 and extracted five times with dichloromethane (50 mL each). The combined organic layer was washed with brine, dried (anhydrous Na₂SO₄), concentrated, and column chromatographed on silica gel using a gradient mixture of CH₂Cl₂ and MeOH as eluent to give 0.126 g (10% recovery) of lactone 9 and 0.794 g (51% yield) of the titled compound as a colorless oil. [α]_{D}²²=−70.7 (c 0.5, acetone). ¹H NMR δ 4.68 (d, J=8.0 Hz, 1H), 4.58 (td, J=8.0, 4 Hz, 1H), 3.58 (dd, J=13, 4 Hz, 1H), 3.40 (dd, J=13, 6 Hz, 1H), 1.64 (s, 3H), 1.42 (s, 3H); ¹³C NMR δ 172.2, 112.2, 73.8, 70.8, 52.0, 27.1, 26.2. MS (ESI, MeOH): m/z=224.2 ([M+Na]⁺), 143.7, 85.5. The spectral data is in agreement with that reported.

(4S,5S)-5-(Aminomethyl)-2,2-dimethyl-1,3-dioxolane-4-carboxylic acid. To a hydrogenation flask, were added 0.38 g (1.9 mmol) of (4S,5S)-5-(azidomethyl)-2,2-dimethyl-1,3-dioxolane-4-carboxylic acid, 15 mL of MeOH and 40 mg of 5% Pd/C. The mixture was shaken under 30 psi H₂ at room temperature for 20 h. The reaction mixture was maintained under normal pressure, filtered through Celite, washed with methanol, and concentrated to give 0.31 g (93% yield) of the titled amino acid: m.p. 160-161° C.; [α]_{D}²²−82.5 (c 0.68, methanol). ¹H NMR (D₂O) δ 4.52-4.51 (m, 1H; overlap with HOD), 4.50 (hex, J=2.4 Hz, 1H), 3.01 (dd, J=8.8, 2.4 Hz, 1H), 2.83 (dd, J=8.8, 6.4 Hz, 1H), 2.80 (d, J=5.6 Hz, 2H), 1.42 (s, 3H), 1.26 (s, 3H); ¹³C NMR (D₂O) δ 174.1, 110.8, 76.8, 72.5, 40.6, 26.6, 24.5. The spectral data is in agreement with that reported. It was used in the following reaction without purification.

(+)-(3aS,6aS)-2,2-Dimethyl-dihydro-3aH-[1,3]dioxolo[4,5-c]pyrrol-4(5H)-one. To a sublimation flask, 280 mg (1.6 mmol) of amino acid (4S,5S)-5-(aminomethyl)-2,2-dimethyl-1,3-dioxolane-4-carboxylic acid was added. The chemical was stirred and heated to 150° C. under high vacuum (0.1 mm Hg). The titled compound (238 mg, 94% yield) was collected from the cooling tube (cooled with dry ice-acetone) as white needle-like solid: m.p. 146-148° C.; [α]_{D}²²=+59.7 (c 0.8, MeOH); ¹H NMR δ 6.70-6.52 (bs, 1H, NH), 4.81 (t, J=6 Hz, 1H), 4.59 (d, J=6 Hz, 1H), 3.60 (dd, J=11.5, 6 Hz, 1H), 3.48 (d, J=11.5 Hz, 1H), 1.49 (s, 3H), 1.40 (s, 3H); ¹³C NMR δ 174.3, 112.7, 76.5, 74.6, 45.9, 27.0, 25.7; MS (ESI, MeOH): m/z=158.4 ([M+H]⁺). The spectral data is in agreement with that reported.

(+)-(3aS,6aS)-5-Ethenyl-tetrahydro-2,2-dimethyl-4H-1,3-dioxolo[4,5-c]pyrrol-4-one (10). To 0.505 g (3.2 mmol) of (+)-(3aS,6aS)-2,2-dimethyl-dihydro-3aH-[1,3]dioxolo[4,5-c]pyrrol-4(5H)-one was added 30 mL of freshly distilled n-butyl vinyl ether. The mixture sonicated for few minutes to provide a clear solution. To it, was added 100 mg (0.15 mmol) of 4,7-diphenyl-1,10-phenanthroline palladium bis(trifluoroacetate) [(DPP)Pd(OCOCF₃)₂] and the solution was stirred at 75° C. for 19 h. The mixture was cooled to 25° C., filtered through a small layer of silica gel, washed with ethyl acetate, concentrated, and purified by silica gel column chromatography with a mixture of hexane/acetone (10:1) as eluent to give 0.322 g (74% yield) of 10 as a white solid: m.p. 80 82° C.; [α]_{D}²²=+20.1 (c 1.0, CHCl₃); ¹H NMR δ 7.10 (dd, J=16.0, 9.1 Hz, 1H, CH═), 4.84 (ddd, J=6, 4, 1.4 Hz, 1H), 4.73 (d, J=6 Hz, 1H), 4.57 (dd, J=9.1, 1.1 Hz, 1H, ═CH₂), 4.51 (dd, J=16, 1.1 Hz, 1H, ═CH₂), 3.66 (dd, J=10, 1.4 Hz, 1H), 3.65 (dd, J=10, 4 Hz, 1H), 1.44 (s, 3H), 1.41 (s, 3H); ¹³C NMR δ 169.1, 129.0, 112.9, 96.4, 77.9, 71.9, 48.5, 27.0, 25.7; MS (ESI, MeOH): m/z=184.0 ([M+H]⁺). HRMS-ESI: m/z [M+H]⁺ calcd for C₉H₁₄NO₃⁺: 184.0974 found: 184.0966.

Poly((3aS,6aS)-2,2-dimethyl-5-vinyl-dihydro-3aH-[1,3]dioxolo[4,5-c]pyrrol-4(5H)-one-co-vinyl acetate) [P(DVP-co-VAc)] (11). Note: It is important to remove oxygen and water from the substrates, radical initiator and solvent for polymerization reactions. The substrates, radical initiator azobisisobutyronitrile (AIBN; recrystallized from twice from methanol), and solvent (acetone was distilled over anhydrous K₂CO₃ under argon and then degassed using argon) have been carefully dried and transferred into a glove box, which kept under positive nitrogen atmosphere. A solution of 7 mg (0.042 mmol) of AIBN in 10 mL of acetone was prepared inside the glove box. To a sealed tube in a glove box, 15 mg (0.082 mmol) of N-vinylpyrrolidinone 10 and 15 μL (0.16 mmol) of vinyl acetate (distilled under argon and degassed) were added. To it, a solution of 100 μL (2.4 μmol; 0.5 mol %) of AIBN in acetone was added, and the tube was capped by a Teflon stopper. The sealed tube was transferred to a hood and heat at 65° C. for 2 days. The reaction solution was cooled to 25° C., diluted with 8 mL of hexane, and centrifuged for 10 min at 2,000 rpm. The supernatant was removed and the white precipitate was washed twice with 5 mL each of hexane, dried under vacuum to give 17.8 mg (81% yield) of copolymer 11 as white solids. Notably, the relative rate of polymerization of vinyl lactam is greater than that of vinyl acetate. ¹H NMR (CDCl₃): δ 5.0-4.5 (bm, 3H), 4.2-3.2 (bm, 3H), 2.25-2.20 (bm, 4H), 1.84 (s, 3H), 1.43 (s, 3H), 1.35 (s, 3H); ¹³C NMR δ 172.5-169.0 (m), 112.0 (s), 77.23, 72.3, 47.0-42.0 (m), 37.0-32.0 (m), 27.3, 25.4, 21.2. The number average molecular weight (Mₙ) and weight average molecular weight (M_{w}) of 36,347.98 and 40,113.86, respectively, were determined by high-resolution mass spectrometry.

Poly[(3aS,6aS)-2,2-dimethyl-5-vinyl-dihydro-3aH-[1,3]dioxolo[4,5-c]pyrrol-4(5H)-one] [(+)-(1S)] from thermal reaction. Note: The substrates, radical initiator AIBN, and solvent (ethyl acetate was distilled over CaH₂ under argon and then degassed using argon) have been carefully dried and transferred into a glove box, which maintained under positive nitrogen atmosphere. A solution of 4.0 mg (0.024 mmol) of azobisisobutyronitrile (AIBN) in 2.0 mL of ethyl acetate was prepared inside the glove box. To a pre-sealed tube in a glove box, 480 mg (2.62 mmol) of N-vinylpyrrolidinone 10 and 4.8 mg of copolymer 11 were added followed by 0.43 mL (5.24 μmol; 0.2 mol %) of AIBN in ethyl acetate (as described above) along with 2 mL of ethyl acetate. The tube was sealed with a Teflon cap and transferred outside of the glove box. It was stirred for at 75° C. for 2 days, cooled to 25° C., and diluted with 5 mL of dichloromethane. The resulting solution was added dropwise into 30 mL of pentane and diethyl ether (1:1), and filtered to collect the white solid polymer. The white solid was dried under vacuum to give 420 mg (88% yield) of chiral polymer (+)-1S. The number average molecular weight (Mₙ) and weight average molecular weight (M_{w}) of 74,449.8841 and 80,021.8097 (n=437), respectively, were determined by high-resolution mass spectrometry. [α]_{D}²²=+35.3 (c 0.5, CHCl₃); IR (solid) v 2949.0, 2884.4, 1648.2 (s), 1459.5, 1420.6, 1270.0 (s), 1227.4, 1167.6, 842.5, 732.6 cm⁻¹; ¹H NMR (CDCl₃) δ 4.70-4.50 (m, 2H, CHO), 3.80-3.00 (m, 3H, CHN, CH₂N), 2.00-1.25 (m, 2H), 1.42 (s, 3H), 1.34 (s, 3H); ¹³C NMR (CDCl₃) δ 171.8, 112.0, 77.9, 72.3, 47.0-43.5 (m), 37.5-32.5 (m), 27.3, 25.3.

Poly[(3aS,6aS)-2,2-dimethyl-5-vinyl-dihydro-3aH-[1,3]dioxolo[4,5-c]pyrrol-4(5H)-one][(+)-(1S)] from photoreaction. Following the procedure described above, 220 mg (1.2 mmol) of 10, 2 mg of copolymer 11, 0.4 mg of AIBN, and 2 mL of ethyl acetate were added to a sealed tube in a glove box under nitrogen atmosphere. The sealed tube was transferred outside of the glove box, cooled over an ice-water bath and irradiated with a Hanovia UV lamp (679A36) ˜10 cm away from the sealed tube. After irradiated for 12 h, the reaction tube was removed from irradiation and diluted with 2 mL of dichloromethane. The solution was added to 60 mL of a mixture of pentane and diethyl ether (1:1) and the precipitated white solid was collected by filtration to give 183 mg (83% yield) of chiral polymer 1S: [α]_{D}²²=+32.4 (c 0.5, CHCl₃); The number average molecular weight (Mₙ) and weight average molecular weight (M_{w}) are 46,417.5788 and 48,459.1355 (n=283), respectively, were determined by high-resolution mass spectrometry. ¹H and ¹³C NMR spectra were similar to those described above, obtained from the thermal reaction.

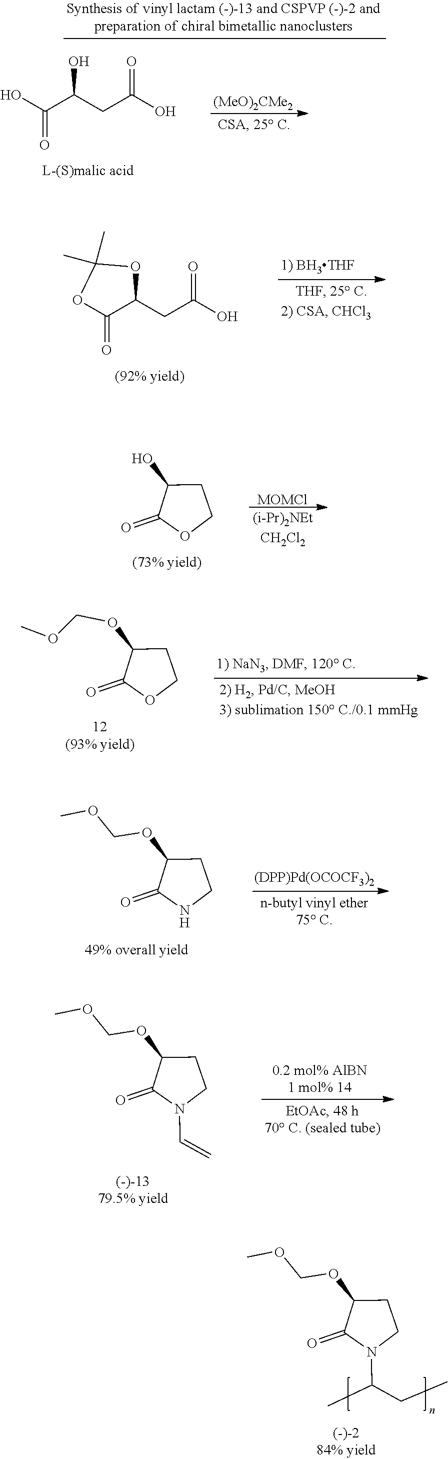

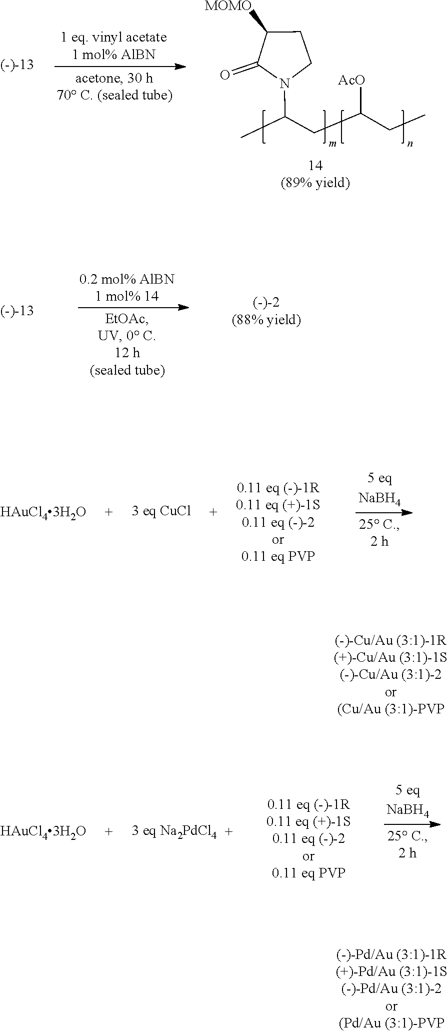

(S)-2-(2,2-Dimethyl-5-oxo-1,3-dioxolan-4-yl)acetic acid. To a solution of 15.0 g (0.112 mol) of L-(S)-malic acid in 300 mL of 2,2-dimethoxypropane under argon was added 0.50 g (2.15 mmol) of D-10-camphorsulfonic acid. The solution was stirred at 25° C. for 12 h, added 0.20 g (2.38 mmol) of sodium acetate, and stirred for 1 h. The white solid, sodium camphorsulfonate, was removed by filtration, and the filtrate was concentrated under reduced pressure. The resulting residue was crystallized from a mixture of 50 mL of chloroform and 100 mL of hexane to give 17.98 g (92% yield) of the titled compound as a white solid: ¹H NMR δ 11.2-10.7 (bs, 1H, OH), 4.72 (dd, J=6.8, 4.0 Hz, 1H), 3.00 (dd, J=17.2, 4 Hz, 1H), 2.86 (dd, J=17.2, 6.8 Hz, 1H), 1.62 (s, 3H), 1.57 (s, 3H); ¹³C NMR δ 174.8, 171.9, 111.4, 70.4, 36.0, 26.8, 25.8. HRMS-ESI (positive mode): m/z [M+H]⁺ calcd for C₇H₁₀O₅⁺: 175.0606, found: 175.0615. The spectral data is in agreement with that reported.

(S)-3-Hydroxy-dihydrofuran-2(3H)-one. To a solution of 17.54 g (0.101 mol) of (S)-2-(2,2-dimethyl-5-oxo-1,3-dioxolan-4-yl)acetic acid in 130 mL of freshly distilled THE under argon at 0° C., 130 mL (0.13 mol) of BH₃·THF (1 M solution in THF) was added through a dropping funnel slowly over 30 min. The solution was stirred at 25° C. for 12 h, an additional 44 mL (0.044 mol) of BH₃·THF was added and stirred at 25° C. for 8 h. Proton NMR spectrum of an aliquot of the reaction mixture showed the absence of starting material. To the reaction mixture, 240 mL of methanol was added and the resulting solution was concentrated on a rotary evaporator to dryness. The process of addition of methanol (30 mL) and evaporation for removal of trimethylborate byproduct was repeated until the weight of the residue reduced to 16.67 g. The residue, (S)-5-(2-hydroxyethyl)-2,2-dimethyl-1,3-dioxolan-4-one, was dissolved in 200 mL of chloroform and added 0.80 g (3.45 mmol) of 10-camphorsulfonic acid. The solution was stirred for at 25° C. for 12 h, added 0.29 g (3.45 mmol) of sodium bicarbonate, concentrated to dryness, and column chromatographed on silica gel using a gradient mixture of hexane and ethyl acetate as eluent to give 7.54 g (73% yield) of the titled compound: [α]_{D}²²=−61.0 (c 1, CHCl₃); {Lit. −69.3 (c 1, CHCl₃)}; ¹H NMR δ 4.53 (dd, J=10, 8.4 Hz, 1H), 4.44 (dt, J=10, 7 Hz, 1H), 4.25 (ddd, J=8.4, 6.8, 1.6 Hz, 1H), 3.8-3.6 (bs, 1H, OH), 2.62 (dddd, J=10, 8, 6, 2 Hz, 1H), 2.30 (dddd, J=10, 8.8, 8.4, 4 Hz, 1H); ¹³C NMR δ 178.2, 67.4, 65.3, 30.9. MS (ESI, MeOH): m/z=103.112 ([M+H]⁺). The spectral data is in agreement with that reported.

(−)-(S)-3-(Methoxymethoxy)-dihydrofuran-2(3H)-one (12). To a cold (0° C.) solution of 2.8 g (27.5 mmol) of (S)-3-hydroxy-dihydrofuran-2(3H)-one in 20 mL of dichloromethane under argon was added 11 mL (68.8 mmol) of methoxymethyl chloride (from a solution containing 1:1 ratio of methoxymethyl chloride and methyl acetate). To it, 7.2 mL (41.3 mmol) of diisopropylethylamine was added dropwise over 5 minutes from a dropping funnel. The resulting solution was stirred at 25° C. for 18 h, diluted with 20 mL of aqueous NH₄Cl solution, and extracted three times (20 mL each) with dichloromethane. The combined extracts washed with aqueous sodium bicarbonate solution and brine, dried (MgSO₄), concentrated under reduced pressure to give 3.73 g (93% yield) of compound 12, which was used in the following step without purification. Compound 12: [α]_{D}²²=−137.2 (c 1, CHCl₃); {Lit. −122.4 (c 2.59, CHCl₃)}; ¹H NMR δ 4.96 (d, J=6.8 Hz, 1H), 4.73 (d, J=6.8 Hz, 1H), 4.45 (dt, J=8.4, 4 Hz, 1H), 4.41 (d, J=9 Hz, 1H), 4.24 (td, J=9, 6.4 Hz, 1H), 3.43 (s, 3H), 2.59 (dddd, J=12.8, 8.8, 6.8, 3.2 Hz, 1H), 2.29 (dq, J=12.8, 8.8 Hz, 1H); ¹³C NMR δ 174.9, 95.9, 70.3, 65.2, 56.0, 29.9. MS (ESI, MeOH): m/z=168.91 (M+Na)⁺, 146.90 ([M+H]⁺). The spectral data is in agreement with that reported.

(S)-4-Azido-2-(methoxymethoxy)butanoic acid. To a two-necked round-bottom flask equipped with a condenser was added 0.98 g (15 mmol) of sodium azide and the material was dried under vacuum and then maintained under argon. To it, was added a solution of 1.0 g (6.85 mmol) of lactone 12 in 5 mL of DMF (distilled over CaH₂), and stirred at 120° C. for 24 h. The solution was cooled to 25° C., diluted with 60 mL of water, and extracted three times with diethyl ether. The combined diethyl ether extracts were washed with brine, dried (anhydrous Na₂SO₄), and concentrated to give 80 mg (8% recovery) of lactone 12. The aqueous layer was acidified to pH 2, extracted three times with dichloromethane (40 mL each), and the combined extracts were washed with brine, dried (anhydrous Na₂SO₄), and concentrated to give 1.165 g (89% yield) of (S)-4-azido-2-(methoxymethoxy)butanoic acid, which was used in the subsequent step without purification. A small amount of material was purified by silica gel column chromatography using a gradient mixture of dichloromethane and methanol as eluents to give pure material: [α]_{D}²²=−72.8 (c 1, CHCl₃); ¹H NMR δ 4.78 (d, J=6.8 Hz, 1H), 4.71 (d, J=6.8 Hz, 1H), 4.30 (dd, J=8, 4.4 Hz, 1H), 3.53-3.47 (m, 2H), 3.42 (s, 3H), 2.12-2.05 (m, 2H); ¹³C NMR δ 176.3 (C═O), 96.5 (OCO), 72.5 (CHO), 56.3 (OMe), 47.3 (CH₂N), 32.0 (CH₂). MS (ESI, MeOH; negative mode): m/z=187.982 ([M−H]⁻). HRMS-ESI (negative mode): m/z [M−H]⁻ calcd for C₆H₁₀N₃O₄⁻: 188.0677, found: 188.0663.

(S)-3-(Methoxymethoxy)pyrrolidin-2-one. To a solution of 1.56 g (8.25 mmol) of (S)-4-azido-2-(methoxymethoxy)butanoic acid in 30 mL of methanol in a hydrogenation bottle, was added 0.18 g (82.5 μmol) of 5% Pd/C. The reaction mixture was shaken under 30 psi. of hydrogen at 25° C. for 16 h, removed from the hydrogenation apparatus, filtered through Celite, washed with methanol thoroughly, and the filtrate was concentrated to dryness. The crude product was triturated with diethyl ether to remove unreacted starting azido carboxylic acid and the residue was dried under vacuum to give 0.798 g (53% yield of crude product) of (S)-4-amino-2-(methoxymethoxy)butanoic acid, which was used in the subsequent reaction without purification. ¹H NMR (D₂O) δ 4.62 (d, J=7.0 Hz, 1H, OCH₂O), 4.56 (d, J=7.0 Hz, 1H, OCH₂O), 4.01 (dd, J=6.8, 4.4 Hz, 1H, CHO), 3.30 (s, 3H, OMe), 3.02 (t, J=7.4 Hz, 2H, CH₂N), 2.12-1.80 (m, 2H, CH₂); ¹³C NMR (D₂O) δ 178.4, 95.5, 75.9, 55.6, 36.7, 30.0. HRMS-ESI (negative mode): m/z [M−H]⁻ calcd for C₆H₁₂N₃O₄⁻: 162.0766, found: 162.0790.

The above diethyl ether wash was concentrated to give 0.10 g of recovered 4-azido-2-(methoxymethoxy)butanoic acid. To a sublimation apparatus, 0.492 g (3.0 mmol) of (S)-4-amino-2-(methoxymethoxy)butanoic acid was added and it was connected to a vacuum at ˜0.1 mmHg pressure and then heated at 140-150° C. for ˜1 h. The sublimation apparatus was cooled to 25° C. and detached from the vacuum. White solids, 0.330 g, were obtained from the cold finger, which were subjected to silica gel column chromatography using a gradient mixture of hexane, dichloromethane, and methanol as eluent to give 0.212 g (49% overall yield from lactone 12) of (S)-3-(methoxymethoxy)pyrrolidin-2-one: m.p. 76-78° C.; [α]_{D}²²=−131.4 (c 1, CHCl₃); ¹H NMR δ 6.60-6.40 (bs, 1H), 4.95 (d, J=6.8 Hz, 1H), 4.75 (d, J=6.8 Hz, 1H), 4.269 (t, J=8 Hz, 1H), 3.43 (s, 3H), 3.46-3.39 (m, 1H), 3.30-3.25 (m, 1H), 2.51-2.42 (m, 1H), 2.15-2.11 (m, 1H); ¹³C NMR δ 175.7 (C═O), 96.2 (OCO), 72.8 (CHO), 55.8 (OCH₃), 38.7 (CN), 29.1 (CH₂). MS (ESI, MeOH): m/z=167.65 (M+Na)⁺, 146.23 ([M+H]⁺); HRMS-ESI: m/z [M+H]⁺ calcd for C₆H₁₂NO₃⁺: 146.0812, found: 146.0817.

(−)-(S)-3-(Methoxymethoxy)-1-vinylpyrrolidin-2-one [(−)-13]. To a solution of 0.20 g (1.37 mmol) of (S)-3-(methoxymethoxy)pyrrolidin-2-one in 23 mL of freshly distilled n-butyl vinyl ether was added 17 mg (0.0274 mmol, 0.02 equivalent) of (DPP)Pd(OCOCF₃)₂. The solution was stirred at 75° C. for 3 h, cooled to 25° C., filtered through a pad of Celite, and washed with 100 mL of ethyl acetate. The filtrate was concentrated, column chromatographed on silica gel using a gradient mixture of hexane and ethyl acetate as eluent to give 0.186 g (79.5% yield) of vinyl lactam 13: [α]_{D}²²=−122.9 (c 1, CHCl₃); ¹H NMR δ 7.09 (dd, J=16, 9 Hz, 1H), 4.98 (d, J=6.8 Hz, 1H), 4.75 (d, J=6.8 Hz, 1H), 4.51 (dd, J=16, 8 Hz, 1H), 4.39 (dd, J=9, 8 Hz, 1H), 3.60 (td, J=10, 3.2 Hz, 1H), 3.43 (s, 3H), 3.36 (dt, J=10, 7.6 Hz, 1H), 2.51 (dtd, J=11, 8, 2.8 Hz, 1H), 2.08 (tt, J=11, 8 Hz, 1H); ¹³C NMR δ 170.6, 129.2 (HC═), 96.2, 95.5, 73.8 (HCO), 55.8 (OMe), 41.2 (CH₂N), 26.3 (CH₂). MS (ESI, MeOH): m/z=193.98 (M+Na)+, 172.27 ([M+H]⁺); HRMS-ESI: m/z [M+H]⁺ calcd for C₆H₁₂NO₃⁺: 172.0974, found: 172.0988.

Poly((S)-3-(methoxymethoxy)-1-vinylpyrrolidin-2-one-co-vinyl acetate) [P(MVP-co-VAc)] (14). Note: It is important to remove oxygen and water from the substrates, radical initiator and solvent for polymerization reactions. The substrates, radical initiator azobisisobutyronitrile (AIBN; recrystallized twice from methanol), and solvent (acetone was distilled over anhydrous K₂CO₃ under argon and then degassed using argon) have been carefully dried and transferred into a glove box, which kept under positive nitrogen atmosphere. A solution of 6.5 mg (0.040 mmol) of AIBN in 1 mL of acetone was prepared inside the glove box. To a sealed tube inside a glove box, 36 mg (0.21 mmol) of N-vinylpyrrolidinone 13 and 20 μL (0.22 mmol) of vinyl acetate (distilled under argon and degassed) were added. To it, a solution of 53 μL (2.1 μmol; 1 mol %) of AIBN in acetone was added, and the tube was capped by a Teflon stopper. The sealed tube transferred to a hood and heat at 70° C. for 2 days. The reaction solution cooled to 25° C., diluted with 8 mL of hexane, and centrifuged for 10 min at 2,000 rpm. The supernatant was removed and the white precipitate was washed twice with 5 mL each of hexane, dried under vacuum to give 48 mg (89% yield) of copolymer 14. ¹H NMR δ 5.0-4.75 (m, 2H), 4.74-4.50 (bs, 1H), 4.40-4.10 (bs, 1H), 3.38 (s, 3H, OMe), 3.45-3.10 (bs, 2H), 2.50-2.25 (bs, 1H), 2.02 (s, 3H, CH₃CO), 2.0-1.50 (bs, 6H); ¹³C NMR δ 172.5 (m, OC═O), 170.4 (NC═O), 95.9 (m, OCO), 74.2 (m, CHO), 67.0 (m, CHO), 55.6 (s, OCH₃), 45.0 (m, CN), 38.0 (m, CN), 35.0 (m, CH₂), 27.1 (s, CH₂), 21.1 (s, CH₂).

Poly[3-(methoxymethoxy)-1-vinylpyrrolidin-2-one] [(−)-(2)] from thermal reaction. Note: The substrates, radical initiator AIBN, and solvent (ethyl acetate was distilled over CaH₂ under argon and then degassed using argon) have been carefully dried and transferred into a glove box, which maintained under positive nitrogen atmosphere. A solution of 12.8 mg (0.078 mmol) of AIBN in 0.5 mL of ethyl acetate was prepared inside the glove box. To a sealed tube in a glove box, 0.171 g (1.0 mmol) of N-vinylpyrrolidinone (−)-13 and 78 μL (1.71 mg, 1% weight) of 14 (22 mg in 1 mL ethyl acetate) were added followed by 26 μL (4 μmol; 0.4 mol %) of AIBN in ethyl acetate (as described above) along with 0.40 mL of ethyl acetate. The tube was sealed with a Teflon cap and transferred outside of the glove box. It was stirred for at 75° C. for 2 days, cooled to 25° C., diluted with 15 mL of pentane, and centrifuged for 10 min at 2,000 rpm. The supernatant was removed and the white precipitate was washed twice with 5 mL each of a 1:1 mixture of pentane and diethyl ether. The white solid was dried under vacuum to give 0.125 g (84% yield) of polymer (−)-2. The combined filtrates were concentrated to give 13 mg (8% recovery) of starting lactam 13. Compound (−)-2: [α]_{D}²²=−168.0 (c 0.5, CHCl₃); ¹H NMR δ 5.0-4.75 (bm, 1H), 4.74-4.60 (bs, 1H), 4.33-4.20 (bs, 1H), 3.95-3.0 (bm, 2H), 3.38 (s, 3H), 2.50-2.25 (bs, 1H), 2.15-1.30 (bm, 4H); ¹³C NMR δ 172.9 (s), 96.4 (rr, OCO), 96.1 (mm, OCO) and 95.9 (mr, OCO), 74.7 and 74.1 (2 peaks, C—O), 55.6 (s, OMe), 45.2 (mm, α-CHN), 44.1 (rm, α-CHN), 43.7 (rr, α-CHN), 39.5, 39.2 and 38.6 (3 peaks, CH₂N), 36.0-31.0 (m, α-CH₂), 27.1 (s, C4-CH₂). The number average molecular weight (Mₙ) and weight average molecular weight (M_{w}) of 57,297.4884 and 59,871.4884 (n=350), respectively, were determined by high-resolution mass spectrometry.

Poly[3-(methoxymethoxy)-1-vinylpyrrolidin-2-one] [(−)-(2)] from photochemical reaction. Following the procedure described above, 250 mg (1.46 mmol) of (−)-13, 2.5 mg of copolymer 14, 0.48 mg (2.9 μmol) of AIBN, and 2 mL of ethyl acetate were added to a sealed tube in a glove box under nitrogen atmosphere. The reaction solution was transferred outside of the glove box, cooled over an ice-water bath and irradiated with a Hanovia UV lamp (679A36) ˜10 cm away from the sealed tube. After irradiated for 12 h, the reaction tube was removed from irradiation and diluted with 2 mL of dichloromethane. The solution was added to 60 mL of a mixture of pentane and diethyl ether (1:1) and the precipitated white solid was collected by filtration to give 220 mg (88% yield) of chiral polymer (−)-2: [α]_{D}²²=−155.0 (c 0.5, CHCl₃). ¹H and ¹³C NMR spectra were similar to those described above, obtained from thermal reaction. The number average molecular weight (Mₙ) and weight average molecular weight (M_{w}) of 28,737.377 and 30,969.1485 (n=181), respectively, were determined by high-resolution mass spectrometry.

General Procedure for the preparation of Cu Au stabilized by chiral polymer (−)-1R. To a solution of 94 mg (0.0011 mmol) of (−)-1R (MW ˜85,000) and 1.0 mL (0.010 mmol) of a 10 mM aqueous solution of HAuCl₄·3H₂O under argon, were added 3.0 mg (0.03 mmol) of CuCl and 3.0 mL of deionized water. The mixture was stirred for 5 min. and added 1.9 mg (0.05 mmol) of sodium borohydride. The resulting solution was stirred at 25° C. for 2 h to give 4 mL of 10 mM of (−)-Cu/Au (3:1)-1R bimetallic nanoclusters in aqueous solution. The solution was concentrated on a rotary evaporator under vacuum and heat (<30° C.) to a desired concentration (such as 16 mM), which was used in subsequent catalytic oxidation without further manipulation. For analyses, the above (−)-Cu/Au (3:1)-1R solution was filtered through a Vivaspin 20 (Sartorius Inc.) centrifugal filter device (with a 3,000 MWCO) using a centrifugation instrument (Eppendorf Centrifuge model 5430) at 3,000 rpm for 2 h, and washed with deionized water twice to remove low molecular weight inorganic materials. The resulting nanoclusters were dissolved in 2 mL of deionized water and lyophilized to give (−)-Cu/Au (3:1)-1R as dark red solids, which were subjected to analyses including CD, atomic force microscopy (AFM), dynamic light scattering (DLS), TEM, and ICP-MS. IR (neat) v 3394.0 (bs), 2954.8, 2920.0, 1643.5 (vs), 1491.4, 1460.5, 1421.0 (s), 1365.2, 1289.2 (s), 1214.7, 1074.1, 932.8 (broad), 731.0.

The solution can be stored in a refrigerator (at 0° C.) for several weeks without noticeable change in appearance and reactivity.

Similarly, (+)-1S, (−)-2, and PVP (MW ˜40K) were used to prepare (+)-Cu/Au (3:1)-1S, (−)-Cu/Au (3:1)-2, and Cu/Au (3:1)-PVP bimetallic nanoclusters, respectively.

General Procedure for the preparation of 25 mM concentration of Cu Au stabilized by PVP (40 K) polymer in DMF. To a solution of 0.110 g (2.75 μmol) of PVP (40 K) in 3.25 mL of DMF were added 7.4 mg CuCl (75 μmol) and 0.25 mL (25 μmol) of HAuCl₄·3H₂O (100 mM in DMF solution). After stirring for 5 min, to it, a solution of 4.8 mg (0.125 mmol) of NaBH₄ in 0.5 ml DMF was added, and the solution was stirred at 25° C. for 2 h to give a 25 mM-solution of Cu/Au-PVP in DMF.

Similarly, 25 mM-solution of Cu/Au-1R, -1S, and -2 in DMF were prepared.

General Procedure for the preparation of 25 mM concentration of Cu Au stabilized by PVP (40 K) polymer in H₂O. To a solution of 0.110 g (2.75 μmol) of PVP (40 K) in 2.88 mL of H₂O were added 7.4 mg (75 μmol) of CuCl and 0.625 mL (25 μmol) aqueous solution of HAuCl₄·3H₂O (40 mM). After stirring for 5 min, to it, a solution of 4.8 mg (0.125 mmol) of NaBH₄ in 0.5 ml H₂O was added, and the solution was stirred at 25° C. for 2 h to give a 25 mM-solution of Cu/Au-PVP in H₂O.

Similarly, 25 mM-solution of Cu/Au-1R, -1S, and -2 in H₂O were prepared.

Representative C—H Oxidation of Complex Molecules Using (−)-Cu/Au (3:1)-1R and 30% H₂O₂.

Oxidation of (−)-ambroxide (15) and formation of (+)-sclareolide (17). To an aqueous solution of 6.5 mL of (−)-Cu/Au (3:1)-(−)-1R (7.93 μmol of Cu, 2.64 μmol of Au, and 0.29 μmol of (−)-1R), were added 0.05 mL (0.42 mmol; 2 equiv.) of 30% H₂O₂, 0.8 mL of CH₃CN, and 50 mg (0.21 mmol) of (−)-ambroxide (15). The resulting solution was stirred at 80° C. for 3 days, cooled to 25° C., and extracted three times with 20 mL each of ethyl acetate. The combined extracts were washed with water and brine, dried (MgSO₄), concentrated, and column chromatographed on silica gel using a gradient mixture of hexane and ethyl acetate as eluents to give 19 mg (37% yield) of 17 and 25.5 mg (51% recovery) of 15. Sclareolide (17): ¹H NMR δ 2.42 (dd, J=16.4, 14.8 Hz, 1H), 2.25 (dd, J=16.4, 6.8 Hz, 1H), 2.12-2.08 (m, 1H), 1.98 (dd, J=14.8, 6.4 Hz, 1H), 1.93-1.85 (m, 1H), 1.75-1.62 (m, 2H), 1.51-1.36 (m, 4H), 1.35 (s, 3H), 1.20 (td, J=13.6, 4.4 Hz, 1H), 1.11-1.03 (m, 2H), 0.93 (s, 3H), 0.90 (s, 3H), 0.85 (s, 3H); ¹³C NMR δ 177.3, 86.6, 59.3, 56.8, 42.4, 39.7, 38.9, 36.3, 33.4, 33.3, 28.9, 21.8, 21.1, 20.8, 18.3, 15.3; MS (ESI, MeOH): m/z=251.2 (M+H⁺). The spectral data are in agreement with those obtained from commercial source (Sigma-Aldrich Inc.).

Similarly, treatment of 15 (50 mg; 0.21 mmol) with 5 mol % Cu/Au-1R (25 mM concentration in H₂O) and 40 equiv. of 30% H₂O₂ (1.68 mmol) in acetonitrile at 80° C. for 3 days gave a 64% of 17 and 23% recovery of 15.

Procedure for Recovery of CSPVP from Cu/Au bimetallic nanocluster catalyst after oxidation reaction. To an aqueous solution of bimetallic nanocluster/CSPVP, recovered from an oxidation reaction, was added aqueous NH₄OH (3 mL) and the solution was stirred at 25° C. for 3 h. It was transferred to a dialysis membrane tube (3,000 MWCO). The tube was closed and immersed into deionized water in a 1-litter beaker and stirred at 25° C. for 8 h. The deionized water was discarded and new deionized water was added. The dialysis process was repeated two more times. The solution in the bag was transferred to a plastic tube and lyophilized to give recovered CSPVP as a white solid, which ¹H and ¹³C NMR along with high-resolution mass spectra were taken and they were similar to those of the original CSPVP. The recovered chiral polymer was used in oxidation reactions and similar results were obtained from those using freshly prepared CSPVPs.

General Procedure for the preparation of Pd/Au stabilized by polymer (−)-1R in H₂O. To a solution of 70 mg (0.825 μmol) of (−)-1R (MW ˜85,000), 0.75 mL (7.5 μmol) of a 10 mM aqueous solution of HAuCl₄·3H₂O and 2.3 mL (22.5 μmol) of Na₂PdCl₄ (10 mM in H₂O), was added 1.4 mg (37.5 μmol) of sodium borohydride. The solution was stirred at 25° C. for 2 h to give 3 mL of 10 mM of (−)-Pd/Au (3:1)-1R bimetallic nanoclusters in aqueous solution. The solution was used in subsequent catalytic oxidation without further manipulation. For analyses, the above Pd/Au (3:1)-1R solution was filtered through a Vivaspin 20 (Sartorius Inc.) centrifugal filter device (with a 3,000 MWCO) using a centrifugation instrument (Eppendorf Centrifuge model 5430) at 3,000 rpm for 1 h, and washed with deionized water twice to remove low molecular weight inorganic materials. The resulting nanoclusters were dissolved in 2 mL of deionized water and lyophilized to give (−)-Pd/Au (3:1)-1R as dark brown solids, which were subjected to analyses including CD, atomic force microscopy (AFM), dynamic light scattering (DLS), TEM, and ICP-MS. IR (neat) v 3387.5 (bs), 2921.3, 1641.9 (vs), 1491.8, 1420.8 (s), 1286.1 (s), 1217.0, 1005-846.1 (broad), 731.0 cm⁻¹.

Similarly, (+)-1S, (−)-2, and PVP (MW ˜40K) were used to prepare (+)-Pd/Au (3:1)-1S, (−)-Pd/Au (3:1)-2, and Pd/Au (3:1)-PVP bimetallic nanoclusters, respectively.

General procedure for recovery of CSPVP 2 from Pd/Au bimetallic nanocluster catalyst after oxidation reaction. To an aqueous solution of Pd/Au-CSPVP 2 bimetallic nanoclusters, recovered from an oxidation reaction, was added 30% aqueous ammonium hydroxide solution (3 mL), and the solution was stirred at 25° C. for 2 days. It was transferred to a dialysis membrane tube (3,000 MWCO). The tube was closed and immersed into deionized water in a 1-litter beaker and stirred at 25° C. for 8 h. The deionized water was discarded and new deionized water was added. The dialysis process was repeated two more times. The solution in the bag was transferred to a plastic tube and lyophilized to give recovered CSPVP as a grey solid. The solid was dissolved in deionized water (1 mL), filtered through charcoal, and washed with deionized water (15 mL). The filtrate was lyophilized to give CSPVP 2 as a white solid, which ¹H and ¹³C NMR along with high-resolution mass spectra were taken and they were similar to those of the original CSPVP. The recovered chiral polymer was used in oxidation reactions and similar results were obtained from those using freshly prepared CSPVPs.

General Procedure for the preparation of 25 mM concentration of Pd/Au stabilized by PVP (40 K) polymer in H₂O. To a solution of 0.138 g (3.45 μmol) of PVP (40 K) in 1.88 mL of H₂O were added 2.4 mL (94 μmol) aqueous solution of Na₂PdCl₄ (31 mM) and 0.78 mL (32 μmol) aqueous solution of HAuCl₄·3H₂O (40 mM). After stirring for 5 min, to it, 6 mg (0.16 mmol) of NaBH₄ was added and the solution was stirred at 25° C. for 2 h to give a 25 mM-solution of Pd/Au-PVP in H₂O.

Similarly, 25 mM-solution of Cu/Au-1R, -1S, and -2 in H₂O were prepared.

General Procedure for the preparation of 25 mM concentration of Pd/Au stabilized by PVP (40 K) polymer in DMF. To a solution of 0.11 g (2.75 μmol) of PVP (40 K) in 0.5 mL of DMF were added 0.75 mL (75 μmol) solution of Na₂PdCl₄ (100 mM in DMF) and 0.25 mL (25 μmol) solution of HAuCl₄·3H₂O (100 mM in DMF). After stirring for 5 min, to it, a solution of 4.8 mg (0.13 mmol) of NaBH₄ in 0.5 mL of DMF and additional 2 mL of DMF were added, and the solution was stirred at 25° C. for 2 h to give a 25 mM-solution of Pd/Au-PVP in DMF.

Similarly, 25 mM-solution of Cu/Au-1R, -1S, and -2 in DMF were prepared.

Representative C—H oxidation of ambroxide (15) using (−)-Pd/Au (3:1)-PVP and H₂O₂. Formation of 3a,6,6a,9a-tetramethyl-dodecahydronaphtho[2,1-b]furan-2-ol (16) (or sclaral) and (+)-sclareolide (17). To an aqueous solution of 4.25 mL (5 mol %) of (−)-Pd/Au (3:1)-PVP (1.88 μmol of Pd, 0.62 μmol of Au, and 0.069 μmol of PVP), were added 2 mL of H₂O, 0.19 mL (1.7 mmol) of 30% H₂O₂, 2.5 mL of CH₃CN, and 200 mg (0.85 mmol) of 15. The resulting solution was stirred at 80° C. for 3 days, cooled to 25° C., diluted with 20 mL of water, and extracted with dichloromethane three times (20 mL each). The combined extract was washed with brine, dried (anhydrous Na₂SO₄), concentrated and column chromatographed on silica gel using a gradient mixture of hexane and ethyl acetate as eluent to give 28 mg (14% yield) of (+)-sclareolide (17), 2 mg (1% yield) of lactol 16 (a ratio of 2.3:1 of α and β diastereomers), and 144 mg (72% recovery) of 15. Compound 16: ¹H NMR (a mixture of 2.3:1 of α and β diastereomers) 9.17 (s, 1H, OH of major), 9.06 (s, 1H, OH of minor), 5.62-5.56 (m, 1H, CHO), 2.05-1.90 (m, 2H), 1.83-1.53 (m, 4H), 1.50-1.37 (m, 3H), 1.35-1.28 (m, 1H), 1.27 (s, 3H), 1.24-1.12 (m, 2H), 1.10-0.92 (m, 2H), 0.87 (s, 3H), 0.85 (s, 3H), 0.82 (s, 3H); ¹³C NMR 108.4 (OCO of major), 106.2 (OCO of minor), 84.3 (CO of minor), 82.4 (CO of major), 59.9 (major), 57.6 (minor), 57.1 (minor), 56.9 (major), 42.4 (major), 39.9 (minor), 39.8 (minor), 39.7 (major), 39.6 (major), 36.2 (major), 36.0 (minor), 33.5 (major), 33.4 (minor), 33.1 (2C), 28.1 (minor), 27.4 (major) 23.4 (major), 23.0 (minor), 21.0 (2C), 20.8 (minor), 20.4 (major), 18.3 (major), 18.2 (minor), 15.1 (2C); MS (ESI, MeOH): m/z=251.087 (M-2H+H⁺). The spectral data is in agreement with those reported.

Oxidation of R-(+)-menthofuran (18). Formation of (6R,7aR)- and (6R,7aS)-3,6-dimethyl-5,6,7,7a-tetrahydrobenzofuran-2(4H)-one (19) and (6R,7aR)-7a-hydroxy-3,6-dimethyl-5,6,7,7a-tetrahydrobenzofuran-2(4H)-one (20). To a solution of 1.4 mL (14 μmol; 1 mol % catalyst) of a 10-mM solution of Pd/Au-PVP nanocluster was added a solution of 0.204 g (1.36 mmol) of 18 in 0.7 mL of CH₃CN, followed by 0.28 mL (2.7 mmol) of 30% H₂O₂. After stirring at 25° C. for 7 h, the mixture was diluted with 10 mL of water and extracted three times with ethyl acetate (10 mL each). The combined organic extracts were washed with aqueous Na₂S₂O₅ solution and brine, dried (anh. Na₂SO₄), concentrated and column chromatographed on silica gel using a gradient mixture of hexane and ethyl acetate as eluent to give 45 mg (15% yield) of 19 and 76 mg (29% yield) of 20 along with 60 mg (30% recovery) of 18. Compound 19 was isolated as an inseparable mixture of 7aR and 7aS isomers in a ratio of 6:1:¹⁵ [α]²²_{D}=−23.5 (c 1, CHCl₃); Lit. −59.2 (c 2.4, CHCl₃) for pure 7aR isomer; ¹H NMR δ 4.83 (dd, J=11, 6 Hz, 1H, 7aS), 4.64 (dd, J=11, 6 Hz, 1H, 7aR), 2.81 (ddd, J=14, 5, 2 Hz, 1H, 7aR), 2.71 (ddd, J=14, 5, 2 Hz, 1H, 7aS), 2.39 (ddd, J=8, 3, 2 Hz, 1H, 7aR), 2.37 (ddd, J=8, 3, 2 Hz, 1H, 7aS), 2.33-2.2.26 (m, 1H, 7aS), 2.21 (td, J=14, 6 Hz, 1H, 7aR), 2.00-1.92 (m, 1H, 7aS), 1.84 (s, 3H, CH₃, 7aR), 1.78-1.67 (m, 1H, 7aS), 1.16 (d, J=7 Hz, 3H, Me, 7aS), 1.07 (td, J=12, 4.4 Hz, 1H, 7aR), 1.03 (d, J=7 Hz, 3H, Me, 7aR); ¹³C NMR 174.9 (C═O, 7aR & 7aS), 163.0 (7aS), 162.4 (7aR), 119.6 (7aR), 119.4 (7aS), 80.0 (7aR), 77.5 (7aS), 42.0 (7aR), 39.6 (7aS), 34.6 (7aR), 31.7 (7aS), 29.8 (7aR), 27.4 (7aS), 25.5 (7aR), 21.8 (7aS), 21.3 (7aR), 17.3 (7aS), 8.2 (7aR & 7aS); MS (ESI, MeOH): m/z=167.188 ([M+H]⁺, 64%). The spectral data is in agreement with those reported. Compound 20: [α]²²_{D}=−51.0 (c 1, CHCl₃), Lit. −59.8 (c 10, EtOH); ¹H NMR δ 2.75-2.68 (m, 2H, CH & OH), 2.42-2.33 (m, 2H), 2.25-1.96 (m, 2H), 1.84 (d, J=1.6 Hz, 3H, Me), 1.34-1.26 (m, 1H), 1.11-1.10 (m, 1H), 1.02 (d, J=7 Hz, 3H, Me); ¹³C NMR δ 172.2 (C═O), 160.3 (C═), 121.4 (C═), 103.4 (C-0), 45.9, 35.0, 29.2, 24.4, 21.1, 8.2; MS (ESI, MeOH): m/z=182.911 ([M+H]⁺, 100%), 164.882 [M−H₂O+H]⁺ (99%). The spectral data is in agreement with those reported.

Similar treatment of 18 (1.36 mmol) with 0.1 mol % of Pd/Au-1R and 2 equiv. (2.7 mmol) of 30% H₂O₂ gave 13% yield of 19, 10% yield of 20, and 35% recovery of 18.

Oxidation of 18 (1.36 mmol) with 0.1 mol % of Pd/Au-1S and 2 equiv. (2.7 mmol) of 30% H₂O₂ produced a 16% yield of compound 19, 3% yield of 20 and 8% recovery of 18. (S)-2,9-Di-(O-pivalyl)-boldine (22). To a solution of 1.82 g (5.56 mol) of (+)-boldine (21) and 6.2 mL (44 mmol) of triethylamine in 30 mL of dichloromethane under argon at 25° C. was added 2.7 mL (22 mmol) of pivaloyl chloride. After stirring for 16 h, the solution was diluted with water and extracted three times with dichloromethane. The combined organic layers were washed with water and brine, dried (MgSO₄), concentrated and column chromatographed on silica gel using a gradient mixture and hexane and ethyl acetate as eluent gave 2.5 g (91% yield) of compound 22 as a yellow solid: mp. 172-173° C.; [α]²²_{D}=+92.0 (c 1, CHCl₃); ¹H NMR δ 8.10 (s, 1H, C11H), 6.97 (s, 1H, C8H), 6.79 (s, 1H, C3H), 3.86 (s, 3H, OMe), 3.56 (s, 3H, OMe), 3.30-2.95 (m, 3H), 2.75-2.48 (m, 4H), 2.54 (s, 3H, NMe), 1.43 (s, 9H), 1.41 (s, 9H); ¹³C NMR δ 177.0 (2C), 150.0, 147.3, 143.5, 139.3, 133.7, 129.8, 129.7, 129.2, 127.3, 122.0, 121.9, 112.7, 62.5, 60.6, 56.4, 52.9, 44.0, 39.1, 39.0, 33.6, 28.9, 27.3 (6C). MS (ESI, MeOH): m/z=496.057 ([M+H]⁺, 100%). HRMS-ESI: m/z [M+H]⁺ calcd for C₂₉H₃₈NO₆⁺: 496.2694, found: 496.2780.

(S)-2,9-Di-(O-pivalyl)-boldine N-oxide (23). To a solution of 0.528 g (1 mmol) of compound 22 in 20 mL of dichloromethane was added 0.296 g (1.2 mmol) of m-chloroperbenzoic acid. The reaction mixture was stirred at 25° C. for 2.5 h, concentrated under reduced pressure, and purified by silica gel column chromatography using a mixture of dichloromethane and methanol (10:1) as an eluent to give 0.475 g (93% yield) of compound 23: m.p. 102-103° C.; [α]²²_{D}=+51.0 (c 1, CHCl₃); ¹H NMR δ 8.10 (s, 1H, C11H), 7.01 (s, 1H, C8H), 6.89 (s, 1H, C3H), 4.29 (dd, J=14, 4 Hz, 1H), 3.91-3.83 (m, 1H), 3.85 (s, 3H, OMe), 3.73 (dd, J=12, 5 Hz, 1H), 3.61-3.55 (m, 2H), 3.54 (s, 3H, OMe), 3.45 (s, 3H, NMe), 3.08 (dd, J=14, 4 Hz, 1H), 2.79 (dd, J=17, 3.2 Hz, 1H), 1.43 (s, 9H), 1.41 (s, 9H); ¹³C NMR δ 177.1, 176.9, 150.5, 148.3, 144.8, 139.8, 128.9, 128.2, 127.3, 127.2, 126.6, 122.5, 122.2, 112.6, 71.4, 64.3, 60.8, 58.0, 56.4, 39.2, 39.1, 28.6, 27.2 (3C), 27.1 (3C), 24.2. MS (ESI, MeOH): m/z=512.057 ([M+H]⁺). HRMS-ESI: m/z [M+H]⁺ calcd for C₂₉H₃₈NO₇⁺: 512.2648, found: 512.2656.

Oxidation of 23 with Cu Au-PVP. Formation of (S)-2,9-di-(O-pivalyl)-boldine (22), 24, and 25. To a solution of 0.2 mL (2 μmol) of Cu/Au (3:1)-PVP (40 K) (10 mM in aqueous solution) was added a solution of 0.10 g (0.2 mmol) of 23 in 0.25 mL of acetonitrile and 0.045 mL (0.4 mmol) of 30% H₂O₂. The reaction solution was stirred at 50° C. for 7 h, cooled to 25° C., diluted with aqueous Na₂S₂O₅, and extracted with ethyl acetate three times. The combined organic layer was washed with brine, dried (anhydrous Na₂SO₄), concentrated, and column chromatographed on silica gel using a mixture of ethyl acetate, dichloromethane and methanol as eluent to give 54.5 mg (55% yield) of 22, 9.4 mg (9% yield) of 24, and 4.2 mg (4% yield) of 25. The spectral data of compound 22 are identical to those reported above. Compound 24, a dark green solid: mp. 159-160° C.; ¹H NMR δ 9.05 (s, 1H, C11H), 7.35 (s, 1H, C8H), 7.05 (s, 1H, C3H), 6.67 (s, 1H, C7-OH), 3.97 (s, 3H, OMe), 3.84 (s, 3H, OMe), 3.37 (t, J=6 Hz, 2H, C4-H), 3.27 (t, J=6 Hz, 2H, C5-H), 3.06 (s, 3H, NMe), 1.50 (s, 9H), 1.45 (s, 9H); ¹³C NMR δ 177.0, 176.9, 148.1, 147.7, 142.4, 142.3, 140.7, 129.9, 129.7, 125.2, 123.2, 122.6, 120.0, 119.0, 109.9, 103.0, 60.6, 56.1, 50.2, 40.5, 39.2, 30.8 (2C), 27.3 (6C). MS (ESI, MeOH): m/z=510.263 (M+1⁺, 28%). HRMS-ESI: m/z [M+H]⁺ calcd for C₂₉H₃₅NO₇Na⁺: 532.2306, found: 532.2108. The chemical shift assignments are based on 2D NOESY spectrum. Compound 25, a yellow solid: mp. 264-265° C.; ¹H NMR δ 9.10 (s, 1H, C11H), 8.42 (s, 1H, C8H), 7.62 (s, 1H, C3H), 7.58 (s, 1H, C4H), 4.05 (s, 3H, C1-OMe), 4.02 (s, 3H, C10-OMe), 3.88 (s, 3H, NMe), 1.52 (s, 9H), 1.47 (s, 9H); ¹³C NMR δ 176.7, 176.3, 175.4, 157.4, 156.1, 151.5, 144.5, 141.6, 130.8, 127.2, 125.5, 125.0, 124.7, 124.3, 122.7, 121.9, 114.9, 109.2, 61.3, 56.1, 39.3, 30.7 (2C), 27.3 (6C). MS (ESI, MeOH): m/z=522.204 (M+1⁺, 100%); HRMS-ESI: m/z [M+H]⁺ calcd for C₂₉H₃₂NO₈⁺: 522.2128, found: 522.2150. The ¹H chemical shift assignments of 25 were based on 2D NOESY NMR.

Oxidation of 23 with Pd/Au-PVP. Formation of 22, 24, and dibenzo[de,g]quinolin-7-one 26. To a solution of 0.2 mL (2 μmol) of Pd/Au (3:1)-PVP (40 K) (10 mM in aqueous solution) was added a solution of 0.10 g (0.2 mmol) of 23 in 0.25 mL of acetonitrile and 0.045 mL (0.4 mmol) of 30% H₂O₂. The reaction solution was stirred at 50° C. for 23 h, cooled to 25° C., diluted with aqueous Na₂S₂O₅, and extracted with ethyl acetate three times. The combined organic layer was washed with brine, dried (anhydrous Na₂SO₄), concentrated, and column chromatographed on silica gel using a gradient mixture of dichloromethane and methanol as eluents to give 44 mg (44% yield) of 22, 4 mg (4% yield) of 24, and 6.2 mg (6% yield) of 26. Compound 26: ¹H NMR δ 9.19 (s, 1H, C11H), 8.86 (d, J=9 Hz, 1H, C5H), 8.12 (s, 1H, C8H), 7.75 (d, J=9 Hz, 1H, C4H), 7.57 (s, 1H, C3H), 4.03 (s, 3H, OMe), 3.91 (s, 3H, OMe), 1.51 (s, 9H), 1.49 (s, 9H); ¹³C NMR δ 184.0, 179.0, 176.8, 176.7, 164.9, 157.8, 154.2, 150.9, 147.4, 141.5, 140.8, 128.7, 128.2, 127.5, 125.1, 122.0, 121.0, 109.6, 60.9, 56.1, 39.2 (2C), 27.3 (6C); MS (ESI, MeOH): m/z=508.258 ([M+H]). HRMS-ESI: m/z [M]⁺ calcd for C₂₈H₂₈NO₈⁺: 507.1893, found: 507.1817.

Reaction of 23 with Pd/Au-PVP without H₂O₂. Formation of 22, 24, and 27. To a solution of 0.29 mL (2.9 μmol) of Pd/Au-40K PVP (10 mM in H₂O; 3 mol %) was added a solution of 50 mg (0.10 mmol) of 23 in 0.3 mL of acetonitrile. The mixture was stirred at 50° C. for 20 h and additional 0.3 mL of acetonitrile was added to dissolve the precipitated organic materials and 0.15 mL (1.5 μmol) of Pd/Au-40K PVP (10 mM in H₂O; 2 mol %). After stirred at 50° C. for additional 35 h, the mixture was cooled to 25° C., diluted with aqueous Na₂S₂O₅ solution, and extracted with ethyl acetate three time. The combined extracts were washed with water and brine, dried (anh. Na₂SO₄), concentrated, and column chromatographed on silica gel using a gradient mixture of hexane and ethyl acetate and then dichloromethane and methanol as eluents to give 7.6 mg (15% yield) of 22, 5.5 mg (11% yield) of 24, and 7 mg (13% yield) of 27 along with 27 mg (54% recovery) of 23. Spectral data of 22, 24 and 23 are identical to those described above. Compound 27: [α]²²_{D}=+0.48 (c 1.46, CHCl₃); ¹H NMR δ 9.22 (s, 1H, C11H), 7.89 (d, J=8.8 Hz, 1H, C5H), 7.68 (d, J=8.8 Hz, 1H, C4H), 7.54 (s, 1H, C3H), 7.22 (s, 1H, C8-H), 4.02 (s, 3H, C1-OMe), 3.86 (s, 3H, C10-OMe), 3.39-3.30 (m, 2H), 3.10-3.00 (m, 1H), 2.73 (s, 3H, NMe), 1.50 (s, 9H), 1.46 (s, 9H); ¹³C NMR δ 177.0, 176.9, 150.5, 148.4, 142.1, 140.4, 133.2, 130.4, 128.9, 127.5, 126.7, 124.6, 123.2, 120.9, 120.8, 109.6, 62.6, 60.7, 56.0, 48.8, 39.2, 31.6, 29.7, 27.3 (6C, t-Bu); MS (ESI, MeOH): m/z=494.259 ([M+H]⁺). HRMS-ESI: m/z [M]⁺ calcd for C₂₉H₃₆NO₆⁺: 494.2537, found: 494.2391. The ¹H chemical shift assignment was based on 2D NOESY spectrum.

Oxidation of 23 with Pd/Au-PVP and NMO in DMF. Formation of 27. To a solution of 0.10 g (0.2 mmol) of 23 in 0.2 mL of DMF were added 24 mL (0.6 μmol; 0.3 mol %) of Pd/Au-PVP (25 mM in DMF) and 46 mg (0.39 mmol) of N-methylmorpholine N-oxide (NMO). The solution was stirred at 25° C. for 16 h, diluted with water (10 mL), and extracted two times each with ethyl acetate and dichloromethane. The combined organic layers were dried (anh. Na₂SO₄), concentrated, and column chromatographed on silica gel using a gradient mixture of hexane, ethyl acetate and methanol as eluent to give 51 mg (52% yield) of compound 27 and 26 mg (26% recovery) of 23. The spectral data are identical to those described above.

Similar treatment of 23 with 0.3 mol % of Pd/Au-1R (25 mM in DMF) and 2 equiv. of NMO at 25° C. for 16 h gave 27 (21% yield) and recovered 23 (28%). Oxidation of 23 with 0.3 mol % of Pd/Au-1S (25 mM in DMF) and 2 equiv. of NMO at 25° C. for 16 h gave 27 (18% yield) and recovered 23 (30%). Treatment of 0.10 g (0.2 mmol) of 23 with 1.3 mol % of Pd/Au-PVP and 46 mg (0.39 mmol) of NMO under similar reaction conditions afforded a 63% yield of 27. Reaction of 23 (0.2 mmol) with 1.3 mol % of Pd/Au-PVP and 23 mg (0.2 mmol) of NMO under similar reaction conditions gave a 55% yield of 27 and 8% recovery of 23.

Oxidation of 1-adamantanol (28). Formation of 1,3-adamantanediol (29) and 1,4_{eq}-adamantanediol (30). To a solution of 0.10 g (0.65 mmol) of 28 in 5 mL of acetonitrile, were added 7.3 mL (0.033 mmol; 5 mol %) of Cu/Au (3:1)-PVP (40K molecular weight; 4.6 mM aqueous solution) and 0.13 mL (1.32 mmol; 2 equiv.) of 30% H₂O₂. The reaction solution was stirred at 50° C. for 24 h, cooled to 25° C., diluted with water and aqueous Na₂S₂O₅, and extracted with dichloromethane three times. The combined extracts were washed with water and brine, dried (anhydrous Na₂SO₄), concentrated and column chromatographed on silica gel using a mixture of dichloromethane and methane (30:1) as eluent to give 25 mg (27% yield) of 1,3-adamantanediol (29) and 5 mg (5% yield) of 1,4-adamantanediol (30) along with 49 mg (49% recovery) of 1-adamantanol (28). Compound 29: ¹H NMR (DMSO-d6) δ 4.42 (s, 2H, OHs), 2.14-2.09 (bs, 2H), 1.52-1.44 (m, 10H), 1.37 (s, 2H); ¹³C NMR (DMSO-d6) δ 68.9, 53.8, 44.6, 35.2, 31.1; MS (ESI, MeOH): m/z=169.12 (M+H⁺). The spectral data are in agreement with those reported. Compound 30: ¹H NMR (DMSO-d6) δ 4.53 (d, J=3.2 Hz, 1H, OH), 4.31 (s, 1H, OH), 3.63 (q, J=3.2 Hz, 1H, CHO), 1.97-1.90 (m, 3H), 1.85-1.78 (bs, 2H), 1.62-1.50 (m, 6H), 1.24-1.17 (m, 2H); ¹³C NMR (DMSO-d6) δ 72.2, 66.2, 46.0, 44.0, 36.3, 30.1, 29.9; MS (ESI, MeOH): m/z=169.11 (M+H⁺). The spectral data are in agreement with those reported.

Similarly, treatment of 28 (0.65 mmol) with 5 mol % of Cu/Au-1S and 2 equiv. (1.32 mmol) of 30% H₂O₂ in H₂O and CH₃CN at 25° C. for 24 h gave a 30% yield of 29 and 7% yield of 30 as well as 41% recovery of 28. Oxidation of 28 (0.65 mmol) with 5 mol % of Cu/Au-1R and 2 equiv. (1.32 mmol) of 30% H₂O₂ in H₂O and acetonitrile gave a 32% yield of 29 and 6% yield of 30 along with 38% recovery of 28. Oxidation of 28 (0.65 mmol) with 5 mol % of Cu/Au-1R and 15 equiv. (9.75 mmol) of 30% H₂O₂ in H₂O and acetonitrile gave a 39% yield of 29 and 20% yield of 30 along with 11% recovery of 28.

N-(Adamantan-1-yl)acetamide (31). To a solution of 0.50 g (3.30 mmol) admantan-1-amine and 0.92 mL (6.60 mmol) triethylamine in 5 mL distilled THE under argon, was added 0.38 mL (4.00 mmol) acetic anhydride dropwise and stirred for 16 h. The reaction solution was diluted with 15 mL of H₂O, extracted twice with 20 mL of dichloromethane, and the combined extracts were washed with 10 mL of brine, dried (MgSO₄), and concentrated to give 0.525 g (82.4% yield) of compound 31 as a white solid: m.p. 146-149° C.; ¹H NMR δ 5.20-5.10 (bs, 1H, NH), 2.03 (s, 3H), 1.98 (s, 6H), 1.91 (s, 3H), 1.66 (s, 6H); ¹³C NMR δ 169.3, 51.9, 41.6 (3C), 36.3 (3C), 29.4 (3C), 24.7.

N-3-Hydroxyadamantan-1-yl acetamide (32). To an aqueous solution of 4 mL of Cu/Au (3:1)-(−)-1R (9.7 μmol of Cu, 3.2 μmol of Au, and 0.18 μmol of (−)-1R), were added 0.56 mL (5.2 mmol) of 30% H₂O₂, 2 mL of CH₃CN, and 50 mg (0.259 mmol) of compound 31. The resulting solution was stirred at 80° C. for 3 days, cooled to 25° C., diluted with aqueous Na₂S₂O₅, and extracted three times with 20 mL each of ethyl acetate. The combined extracts were washed with water and brine, dried (MgSO₄), concentrated, and column chromatographed on silica gel using a gradient mixture of hexane and ethyl acetate as eluents to give 20 mg (35% yield) of 32 and 24 mg (48% recovery) of 31. ¹H NMR δ 5.25-5.17 (bs, 1H), 2.29-2.22 (m, 2H), 1.85 (s, 3H), 2.08-1.50 (m, 13H); ¹³C NMR (CDCl₃) δ 169.8, 69.6, 54.8, 49.5, 44.5, 40.8, 35.3, 31.0, 25.0. MS (ESI, MeOH): m/z=210.6 ([M+H]⁺). The spectral data is in agreement with that reported.

Similarly, treatment of 31 (0.26 mmol) with 5 mol % of Cu/Au-PVP and 20 equiv. (5.2 mmol) of 30% H₂O₂ in H₂O and CH₃CN at 90° C. for 3 days gave a 51% yield of 32 along with 19% recovery of 31.

N-Acetyl-memantine (33). To a solution of 0.50 g (2.79 mmol) memantine and 0.7 g (6.9 mmol) of triethylamine in 10 mL of CH₂Cl₂ under argon, was added 0.27 g (3.4 mmol) of acetyl chloride dropwise and stirred for 5 h. The reaction mixture was diluted with 30 mL of H₂O, extracted twice with 50 mL each of dichloromethane, and the combined extracts were washed with 10 mL each of water and brine, dried (MgSO₄), and concentrated to give 0.603 g (97% yield) of compound 33: m.p. 110-111° C.; ¹H NMR δ 5.25-5.15 (bs, 1H, NH), 2.15-2.11 (m, 1H), 1.90 (s, 3H, CH₃CO), 1.82-1.81 (m, 2H), 1.64-1.63 (m, 4H), 1.36 (d, J=16 Hz, 2H), 1.30 (d, J=10.4 Hz, 2H), 1.16 (d, J=10.4 Hz, 2H), 0.84 (s, 6H); ¹³C NMR δ 169.3, 53.5, 50.6, 47.7 (2C), 42.8 (2C), 42.4, 40.2, 32.3, 30.1 (2C), 24.7. MS (ESI, MeOH): m/z=222.018 ([M+H]⁺). The spectral data is in agreement with that reported.

Oxidation of 33. Formation of N-3-hydroxy-5,7-dimethyl-adamantan-1-yl acetamide (34) and N-4-hydroxy-3,5-dimethyl-adamantan-1-yl acetamide (35). To an aqueous solution of 10 mL of Cu/Au (3:1)-(−)-1R (5.0 μmol of Cu, 1.7 μmol of Au, and 0.18 μmol of (−)-1R), were added 0.17 mL (1.5 mmol) of 30% H₂O₂, 4 mL of CH₃CN, and 111 mg (0.5 mmol) of 33. The resulting solution was stirred at 80° C. for 30 h, cooled to 25° C., diluted with aqueous Na₂S₂O₅, and extracted three times with 20 mL each of ethyl acetate. The combined extract was washed with brine, dried (MgSO₄), concentrated and column chromatographed on silica gel using a gradient mixture of hexane and ethyl acetate as eluent to give 27 mg (23% yield) of 34 and 5 mg (4% yield) of 35 along with 70 mg (60% recovery) of 33. Compound 34: ¹H NMR (CDCl₃): δ 5.20-5.15 (bs, 1H, NH), 2.03 (s, 1H, OH), 1.91 (s, 3H, CH₃CO), 1.87-1.85 (s, 2H), 1.66 (d, J=16 Hz, 2H), 1.59 (d, J=16 Hz, 2H), 1.42 (d, J=10.4 Hz, 2H), 1.33 (d, J=10.4 Hz, 2H), 1.14 (dt, J=12.4, 2 Hz, 1H), 1.09 (dt, J=12.4, 2 Hz, 1H), 0.93 (s, 6H); ¹³C NMR (CDCl₃): δ 169.4, 70.3 (C-0), 55.1 (C—N), 50.4 (2C), 49.4, 47.7, 46.5 (2C), 34.2 (2C), 29.1 (2C), 24.6. MS (ESI, MeOH): m/z=238.038 ([M+H]⁺). HRMS-ESI: m/z [M+H]⁺ calcd for C₁₄H₂₄NO₂⁺: 238.1802, found: 238.1809. The spectral data are similar to those of N-Boc-3-hydroxy-memantine or tert-butyl (3-hydroxy-5,7-dimethyladamantan-1-yl)carbamate. Compound 35: ¹H NMR δ 5.16-5.13 (bs, 1H, NH), 3.36 (s, 1H, CHO), 2.10-2.02 (m, 2H), 1.91 (s, 3H, CH₃), 1.75-1.65 (m, 4H), 1.50-1.35 (m, 3H), 1.22-1.18 (m, 2H), 0.90 (s, 3H), 0.86 (s, 3H); ¹³C NMR δ 169.4, 76.9, 52.8, 49.9, 47.2, 42.2, 41.0, 36.5, 36.4, 33.9, 32.2, 29.2, 25.6, 24.7. MS (ESI, MeOH): m/z=238.047 ([M+H]⁺, 100%). HRMS-ESI: m/z [M+H]⁺ calcd for C₁₄H₂₄NO₂⁺: 238.1807, found: 238.1844. Compound 35 crystallized from ethyl acetate to give single crystals, whose structure was determined by X-ray analysis (FIG. 3).

Similarly, treatment of 33 (0.5 mmol) with 1.3 mol % of Cu/Au-PVP (40K) and 3 equiv. (1.5 mmol) of 30% H₂O₂ in H₂O and CH₃CN at 80° C. for 30 h gave 22% yield of 34 and 6% yield of 35 as well as 50% recovery of 33. Oxidation of 33 (0.5 mmol) with 1.3 mol % of Pd/Au-PVP and 3 equiv. (1.5 mmol) of 30% H₂O₂ under similar reaction conditions produced an 8.3% yield of 34 and 1% yield of 35 along with 83% recovery of 33. Oxidation of 33 (0.5 mmol) with 10 mol % of Cu/Au-PVP and 20 equiv. (10 mmol) of 30% H₂O₂ at 50° C. for 3 days gave 38% yield of 34, 17% yield of 35 and 12% recovery of 33.

Estrone 3-pivalate (36). To a solution of 1.00 g (3.7 mmol) of estrone in 30 mL of CH₂Cl₂ under argon were added 0.66 g (5.5 mmol) of pivaloyl chloride and 0.60 g (7.4 mmol) of pyridine. The solution was stirred for 10 h, acidified with 1N HCl to pH 5, and extracted three times with 20 mL each of CH₂Cl₂. The combined extracts were washed with brine, dried (MgSO₄), concentrated, and column chromatographed on silica gel using a gradient mixture of hexane and diethyl ether as eluent to give 1.17 g (89% yield) of compound 36: m.p. 159-160° C.; Lit.¹⁴ 164-165° C.; [α]²²_{D}=+122.2 (c 1, CHCl₃); ¹H NMR Q 7.28 (d, J=8.4 Hz, 1H), 6.84 (d, J=8.4 Hz, 1H), 6.79 (s, 1H), 2.94-2.88 (m, 2H), 2.50 (dd, J=18, 9 Hz, 1H), 2.53-2.30 (m, 2H), 2.16-1.89 (m, 4H), 1.67-1.38 (m, 6H), 1.35 (s, 9H), 0.91 (s, 3H); ¹³C NMR δ 220.8, 177.3, 149.0, 137.9, 137.1, 126.3, 121.5, 118.7, 50.4, 48.0, 44.2, 39.0, 38.0, 35.9, 31.6, 29.4, 27.2 (3C), 26.4, 25.8, 21.6, 13.9. MS (ESI, MeOH): m/z=355.142 (M+H⁺; 100%).

Oxidation of estrone 3-pivalate (36). Formation of (8S,13S,14S)-13-methyl-17-oxo-7,8,12,13,14,15,16,17-octahydro-6H-cyclopenta[a]phenanthren-3-yl pivalate (37), (8R,9S,13S,14S)-13-methyl-6,17-dioxo-7,8,9,11,12,13,14,15,16,17-decahydro-6H-cyclopenta[a]phenanthren-3-yl pivalate (38), (8S,9R,13S,14S)-9-hydroxy-13-methyl-6,17-dioxo-7,8,9,11,12,13,14,15,16,17-decahydro-6H-cyclopenta[a]phenanthren-3-yl pivalate (39) and (8S,13S,14S)-13-methyl-6,17-dioxo-7,8,12,13,14,15,16,17-octahydro-6H-cyclopenta[a]phenanthren-3-yl pivalate (40). To a solution of 0.303 g (0.856 mmol) of 36, 5.0 mL (0.008 mmol) of Pd/Au-CSPVP-1R nanoclusters (1.6 mM in aqueous solution), 3 mL H₂O and 18 mL of CH₃CN, was added 0.165 mL (1.28 mmol, 1.5 equiv.) of 70% t-BuOOH. After stirring at 70° C. for 4 days, the reaction solution was cooled to 25° C., diluted with 10 mL of saturated aqueous Na₂S₂O₄ solution, and extracted four times with CH₂Cl₂ (20 mL each). The combined extracts were washed with brine, dried (MgSO₄), concentrated, and column chromatographed on silica gel using a gradient mixture of hexane and ethyl acetate as eluent to give 0.161 g of 36 and 37 (consist of 33% recovery of 36 and 20% yield of 37; based on ¹H NMR analysis and weights of the two molecules), 63 mg (20% yield) of 38, 30 mg (9% yield) of 39, and 6 mg (2% yield) of 40. Compound 36 and 37 are inseparable by silica gel column chromatography. Most of the proton NMR signals of these two molecules overlap, however, all ¹³C NMR signals are distinct. Compound 37: ¹H NMR δ 7.59 (d, J=8.8 Hz, 1H), 6.85 (dd, J=8.8, 2.8 Hz, 1H), 6.79 (d, J=2.8 Hz, 1H), 6.24 (dt, J=5.6, 2.8 Hz, 1H, ═CH), 2.94-2.83 (m, 2H), 2.55-2.45 (m, 1H), 2.44-2.35 (m, 1H), 2.32-1.93 (m, 4H), 1.70-1.40 (m, 4H), 1.34 (s, 9H), 0.94 (s, 3H); ¹³C NMR δ 221.5, 177.2, 149.9, 137.3, 135.2, 131.7, 125.1, 121.7, 119.3, 118.9, 47.8, 46.2, 39.1, 38.02, 36.2, 34.0, 29.6, 27.6, 27.6 (3C), 22.5, 14.5. LCMS (ESI, MeOH): m/z=353.122 (M+H⁺; 100%).

The above mixture of 36 and 37 was treated with 5 equivalents of K₂CO₃ and 1 mL of methanol at 25° C. for 3 h to give the corresponding phenols, which were separated by silica gel column chromatography, providing 9,11-dehydroestrone or (8S,13S,14S)-3-hydroxy-13-methyl-7,8,12,13,15,16-hexahydro-6H-cyclopenta[a]phenanthren-17(14H)-one and estrone.

9,11-Dehydroestrone: ¹H NMR δ 7.49 (d, J=8.8 Hz, 1H), 6.65 (dd, J=8.8, 2.8 Hz, 1H), 6.56 (d, J=2.8 Hz, 1H), 6.13 (dt, J=7.6, 2.0 Hz, 1H, ═CH), 4.75-4.60 (bs, 1H, OH), 2.95-2.77 (m, 2H), 2.57-2.46 (m, 1H), 2.37-2.12 (m, 6H), 1.72-1.60 (m, 2H), 1.45 (dq, J=12.4, 5.6 Hz, 1H), 0.94 (s, 3H); ¹³C NMR δ 221.2, 154.5, 137.8, 135.3, 127.2, 125.6, 116.8, 115.1, 113.8, 47.8, 46.3, 38.2, 36.3, 33.9, 29.7, 27.8, 22.6, 14.5. MS (ESI, MeOH): m/z=353.122 (M+H⁺; 100%). The spectral data is in agreement with that reported.

Compound 38: m.p. 171-173° C.; [α]²²_{D}=+60.1 (c 1.38, CHCl₃); ¹H NMR δ 7.73 (d, J=2.8 Hz, 1H, C4-H), 7.45 (d, J=8.4 Hz, 1H, C2-H), 7.25 (dd, J=8.4, 2.8 Hz, 1H, C1-H), 2.88 (dd, J=16.4, 3.2 Hz, 1H), 2.65-2.46 (m, 3H), 2.34 (dd, J=16.4, 13.2 Hz, 1H), 2.23-2.02 (m, 4H), 1.74-1.53 (m, 4H), 1.36 (s, 9H), 0.93 (s, 3H); ¹³C NMR □ 219.6 (C17), 196.5 (C6), 177.0 (CO₂), 149.9, 143.6, 133.5, 127.2, 126.6, 120.0, 47.6, 43.1, 39.2, 39.1, 35.7, 31.2, 27.1 (3C), 25.1, 21.4, 13.6; MS (ESI, MeOH): m/z=369.127 (M+H⁺, 100%). HRMS-ESI: m/z [M+H]⁺ calcd for C₂₃H₂₉O₄⁺: 369.2066, found: 369.2059. The spectral data is similar to that reported for the 3-acetate-6-oxo-estrone.

Compound 39: m.p. 205-207° C.; [α]²²_{D}=+42.0 (c 0.2, CHCl₃); ¹H NMR δ 7.74 (d, J=2.8 Hz, 1H, C4-H), 7.61 (d, J=8.4 Hz, 1H, C1-H), 7.29 (dd, J=8.4, 2.8, 1H, C2-H), 2.90 (dd, J=17.5, 12.8 Hz, 1H), 2.62 (dd, J=17.5, 4 Hz, 1H), 2.55-2.45 (m, 2H), 2.37 (td, J=12, 4.4 Hz, 1H), 2.25-2.14 (m, 2H), 2.16-1.95 (m, 2H), 1.88-1.84 (m, 1H), 1.65-1.56 (m, 2H), 1.36 (s, 9H, t-Bu), 0.93 (s, 3H, Me); ¹³C NMR δ 219.4 (C17), 196.7 (C6), 176.9 (C═O ester), 151.3 (C3), 144.2, 133.1, 127.4, 125.5, 120.8, 69.4 (C9), 47.5, 43.5, 40.9, 39.1, 36.7, 35.8, 32.0, 27.4, 27.1 (3C's), 21.2, 12.8; MS (ESI, MeOH): m/z=385.026 (M+H⁺), 367.005 (M−H₂O+H⁺). HRMS-ESI: m/z [M+H]⁺ calcd for C₂₃H₂₉O₅⁺: 385.2015, found: 385.2021. The spectral data is similar to that reported for the 3-acetate-9-hydroxy-6-oxo-estrone.

Compound 40: [α]²²_{D}=+63.0 (c 0.19, CHCl₃); ¹H NMR □ 7.69 (d, J=2.4 Hz, 1H, C4-H), 7.67 (d, J=8.8 Hz, 1H, C2-H), 7.25 (dd, J=8.8, 2.4, 1H, C1-H), 6.50 (dt, J=5.2, 2.4 Hz, 1H, C11-H), 2.99 (dd, J=15.8, 4.6 Hz, 1H), 2.86-2.77 (m, 1H), 2.57 (dd, J=18.5, 10.4 Hz, 1H), 2.43-2.34 (m, 2H), 2.26 (q, J=9.6 Hz, 1H), 2.24-2.15 (m, 1H), 1.86-1.80 (m, 1H), 1.73-1.67 (m, 1H), 1.43-1.37 (m, 1H), 1.36 (s, 9H, t-Bu), 0.95 (s, 3H, Me); ¹³C NMR □ 220.0 (C17), 196.2 (C6), 176.9 (C═O ester), 150.7 (C3), 137.9, 133.4, 131.7, 127.6, 126.1, 124.5, 119.4, 48.4, 45.9, 42.8, 39.1, 37.8, 36.1, 34.0, 27.1 (3C's), 22.2, 14.2; MS (ESI, MeOH): m/z=367.132 (M+H⁺, 100%). HRMS-ESI: m/z [M+H]⁺ calcd for C₂₃H₂₇O₄⁺: 367.1909, found: 367.1911. Assignment was made by 2D COSY and 2D NOESY spectra.

Similarly, (1) treatment of 36 (0.856 mmol) with 1 mol % of Pd/Au-PVP (40K) and 1.5 equiv. (2.57 mmol) of t-BuOOH in H₂O and CH₃CN at 70° C. for 4 days gave 8% yield of 37, 16% yield of 38, and 9% yield of 39 as well as 58% recovery of 36. (2) Oxidation of 36 (0.856 mmol) with 1 mol % of Pd/Au-1S and 1.5 equiv. (2.57 mmol) of t-BuOOH in H₂O and CH₃CN under similar reaction conditions gave 2% yield of 37, 23% yield of 38, and 17% yield of 39 as well as 46% recovery of 36. (3) Oxidation of 36 (0.856 mmol) with 1 mol % of Cu/Au-PVP (25 mM concentration) and 1.5 equiv. (2.57 mmol) of t-BuOOH under similar reaction conditions produced 20% yield of 38, 18% yield of 39 and 54% recovery of 36. And (4) treatment of 36 with 3 mol % of Cu/Au-PVP (25 mM concentration) and 4 equiv. of t-BuOOH at 50° C. for 18 gave 45% yield of 38 and 24% yield of 38 along with 5% recovery of 36.

N-Acetyl-dehydroabietylamine or N-acetyl leelamine (41). To a solution of 1.71 g (6.0 mmol) of leelamine in 40 mL of dichloromethane under argon at 25° C. were added 2.48 g (18 mmol) of K₂CO₃ and 0.85 mL (9.0 mmol) of acetic anhydride. The mixture was stirred for 24 h, diluted with water, and extracted three times with ethyl acetate. The combined extract was washed with water and brine, dried (MgSO₄), concentrated to give 1.90 g (97% yield) of N-acetyl-dehydroabietylamine (41), which was used in the subsequent oxidation reaction without purification. [α]²²_{D}=+22.0 (c 1.0, CHCl₃); ¹H NMR δ 7.20 (d, J=8 Hz, 1H), 7.02 (dd, J=8, 2 Hz, 1H), 6.92 (d, J=2 Hz, 1H), 5.45-5.36 (bs, 1H, NH), 3.25 (dd, J=13.6, 6.4 Hz, 1H), 3.12 (dd, J=13.6, 6.4 Hz, 1H), 2.94 (dd, J=20, 6.4 Hz, 1H), 2.90-2.78 (m, 2H), 2.34-2.27 (m, 1H), 1.99 (s, 3H), 1.94-1.87 (m, 1H), 1.82-1.65 (m, 2H), 1.46-1.26 (m, 3H), 1.26 (s, 3H), 1.25 (d, J=7 Hz, 6H), 1.03-0.97 (m, 1H), 0.96 (s, 3H), 0.93-0.78 (m, 2H); ¹³C NMR □ 170.1, 147.2, 145.7, 134.8, 127.0, 124.2, 123.9, 49.8, 45.1, 39.5, 38.3, 37.4, 37.3, 36.2, 33.4, 31.1, 30.2, 25.3, 24.0, 23.6, 18.9, 18.8, 18.6; MS (ESI, MeOH): m/z=328.2 (M+H⁺). The spectral data are in agreement with those reported.

Oxidation of N-acetyl-leelamine (41). Formation of N-acetyl-7aR-hydroperoxy-dehydroabietylamine (42), N-acetyl-7aR-hydroxy-dehydroabietylamine (43), N-acetyl-7-oxo-dehydroabeitylamine (44), and N-{[(1R,4aS,10aR)-7-(2-hydroxypropan-2-yl)-1,4a-dimethyl-9-oxo-1,2,3,4,4a,9,10,10a-octahydrophenanthren-1-yl]methyl}acetamide (45). To a solution of 0.30 g (0.92 mmol) of compound 41 in 5 mL of acetonitrile were added 4.5 mL (0.045 mmol; 5 mol %) of Pd/Au (3:1)-PVP (40K) (10 mM aqueous solution) and 0.19 mL (1.37 mmol; 1.5 equiv.) of 70% t-BuOOH. After stirring the solution at 50° C. for 1 day, additional amounts of 4.5 mL of Pd/Au-PVP and 0.19 mL (1.37 mmol; 1.5 equiv.) of t-BuOOH were added to the reaction mixture, and stirred at 50° C. for 2 days. The reaction mixture was cooled to 25° C., diluted with aqueous sodium thiosulfate, acidified with 1N HCl, and extracted three times with ethyl acetate. The combined extracts were washed with water and brine, dried (MgSO₄), concentrated and column chromatographed on silica gel, using a gradient mixture of hexane, diethyl ether and ethyl acetate as eluents to give 23 mg (8% yield) of 42, 180 mg (62% yield) of 44, and 27 mg (10% yield) of 45 along with 42 mg (14% recovery) of 41. Compound 42: [α]²²_{D}=−16.9 (c 0.9, CHCl₃); ¹H NMR δ 7.30 (d, J=2 Hz, 1H), 7.19 (d, J=8 Hz, 1H), 7.15 (dd, J=8, 2 Hz, 1H), 5.95-5.85 (bs, 1H, NH), 5.00 (s, 1H, OH), 4.25 (dd, J=14.4, 10.4 Hz, 1H), 2.88 (hept, J=6.8 Hz, 1H), 2.53 (d, J=12 Hz, 1H), 2.38 (dd, J=14, 4 Hz, 1H), 2.34-2.27 (m, 1H), 2.08 (d, J=12 Hz, 1H), 2.03 (s, 3H, CH₃CO), 1.87-1.63 (m, 2H), 1.40-1.25 (m, 2H), 1.24 (d, J=6.8 Hz, 6H, Me₂), 1.19 (s, 3H), 0.99 (s, 3H), 0.90-0.75 (m, 3H); ¹³C NMR δ 172.6 (C═O), 148.5, 146.1, 130.2, 130.0, 127.2, 123.8, 81.5 (C-0), 48.7, 37.8, 37.6, 37.4, 36.4, 33.4, 24.7, 24.1, 23.9, 23.7, 22.9, 19.8, 18.6. MS (ESI, MeOH): m/z=344.4 (M+H⁺), 341.91 (M−H₂+H⁺; 100%), 326.3 (M−H₂O+H⁺). HRMS-ESI: m/z [M+H]⁺ calcd for C₂₂H₃₄NO₃⁺: 360.2539, found: 360.2519. Compound 43: [α]²²_{D}=−51.1 (c 0.5, CHCl₃); ¹H NMR δ 7.24 (d, J=8 Hz, 1H), 7.17 (d, J=8 Hz, 1H), 7.16 (s, 1H), 6.18-6.10 (bs, 1H, NH), 5.55-5.40 (bs, 1H, OH), 4.87 (s, 1H), 3.23 (d, J=18 Hz, 1H, CH₂N), 3.16 (d, J=18 Hz, 1H, CH₂N), 2.90 (hept, J=6.8 Hz, 1H), 2.33 (d, J=2 Hz, 1H), 2.28 (d, J=12.8 Hz, 1H), 2.04-1.95 (m, 2H), 1.95 (s, 3H, CH₃CO), 1.85-1.68 (m, 2H), 1.45-1.33 (m, 2H), 1.27 (d, J=6.8 Hz, 6H, Me₂), 1.20 (s, 3H), 0.98-0.91 (m, 1H), 0.95 (s, 3H); ¹³C NMR δ 170.8, 147.2, 146.6, 135.9, 127.7, 126.8, 125.0, 68.8 (C-0), 48.6, 38.4, 38.3, 38.1, 37.3, 35.5, 33.5, 27.5, 24.2, 24.1, 23.8, 23.7, 19.5, 18.7. MS (ESI, MeOH): m/z=344.109 (M+H⁺); HRMS-ESI: m/z [M+Na]⁺ calcd for C₂₂H₃₃NO₂Na⁺: 366.2409, found: 366.2412. Compound 44: [α]²²_{D}=−33.0 (c 1.0, CHCl₃); ¹H NMR δ 7.78 (d, J=2 Hz, 1H), 7.39 (dd, J=8.4, 2 Hz, 1H), 7.30 (d, J=8.4 Hz, 1H), 5.99-5.92 (bs, 1H, NH), 3.31 (dd, J=14, 7.6 Hz, 1H, CH₂N), 2.99 (dd, J=14, 5.6 Hz, 1H, CH₂N), 2.88 (hept, J=7 Hz, 1H, CHMe₂), 2.75-2.62 (m, 2H, CH₂CO), 2.35 (d, J=13 Hz, 1H), 2.06-1.97 (m, 1H), 1.96 (s, 3H, CH₃CO), 1.87-1.72 (m, 2H), 1.60-1.47 (m, 2H), 1.37 (td, J=12.8, 5 Hz, 1H), 1.27 (s, 3H), 1.22 (d, J=6.8 Hz, 3H), 1.21 (d, J=6.8 Hz, 3H), 1.03 (s, 3H); ¹³C NMR δ 199.2 (C═O), 170.5 (CONH), 153.5, 146.8, 132.7, 130.5, 124.8, 123.7, 48.9, 44.1, 37.7, 37.6, 37.5, 35.9, 35.6, 33.5, 23.9, 23.8, 23.7, 23.5, 18.6, 18.2. MS (ESI, MeOH): m/z=342.67 (M+H⁺). HRMS-ESI: m/z [M+H]⁺ calcd for C₂₂H₃₂NO₂⁺: 342.2433, found: 342.2455. The spectral data is in agreement with those reported. Compound 45: [α]²²_{D}=−28.8 (c 0.5, CHCl₃); ¹H NMR δ 8.05 (d, J=2.4 Hz, 1H), 7.92-7.87 (bs, 1H, OH), 7.69 (dd, J=8.4, 2.4 Hz, 1H), 7.41 (d, J=8.4 Hz, 1H), 5.75-5.60 (bs, 1H, NH), 3.28 (dd, J=7.6, 2.4 Hz, 1H), 3.03 (dd, J=13.6, 5.6 Hz, 1H), 2.80-2.65 (m, 2H), 2.37 (d, J=12.8 Hz, 1H), 2.05-1.94 (m, 1H), 1.96 (s, 3H, CH₃CO), 1.85-1.65 (m, 2H), 1.60-1.50 (m, 1H), 1.40-1.20 (m, 2H), 1.29 (s, 3H), 1.27 (s, 3H), 1.26 (s, 3H), 1.04 (s, 3H); ¹³C NMR δ 198.8 (C═O), 170.3 (CONH), 154.2, 147.3, 130.6, 130.4, 123.7, 123.2, 72.3, 49.2, 44.4, 37.8, 37.5, 36.0, 35.7, 31.7, 31.6, 29.7, 23.8, 23.5, 18.5, 18.1. HRMS-ESI m/z [M+H]⁺ calcd for C₂₂H₃₂NO₃⁺: 358.2377, found: 358.2384.

Similarly, (1) oxidation of 41 (0.30 mmol) with 5 mol % of Pd/Au-PVP and 1.5 equiv. (0.45 mmol) of t-BuOOH in H₂O and acetonitrile under similar reaction conditions gave 42 (3% yield), 43 (5% yield), 44 (51% yield), and 45 (2% yield) along with recovered 41 (16%); (2) oxidation of 41 (0.30 mmol) with 10 mol % of Cu/Au-PVP and 2 equiv. (0.60 mmol) of 30% H₂O₂ under similar reaction conditions gave 44 (33% yield) and 45 (4% yield) along with recovered 41 (40%); (3) oxidation of 41 (0.30 mmol) with 5 mol % of Pd/Au-1R and 1.5 equiv. (0.45 mmol) of t-BuOOH in H₂O and acetonitrile under similar reaction conditions gave 42 (3% yield), 44 (47% yield), and 45 (3% yield) along with recovered 41 (40%); (4) oxidation of 41 (0.30 mmol) with 5 mol % of Pd/Au-1S and 1.5 equiv. (0.45 mmol) of t-BuOOH in H₂O and acetonitrile under similar reaction conditions gave 42 (2% yield), 44 (22% yield), and 45 (1% yield) along with recovered 41 (57%); (5) oxidation of 41 (0.3 mmol) with 10 mol % of Pd/Au-PVP and 3 equiv. (0.90 mmol) of t-BuOOH (0.9 mmol) in H₂O and acetonitrile at 50° C. for 48 h gave 44 (58% yield) and 45 (20% yield).

Reduction of compound 42 with sodium metabisulfite giving alcohol 43. To a solution of 17.5 mg (0.048 mmol) of hydroperoxide 42 in 1 mL of 1,4-dioxane and water (9:1) was added 0.12 g (0.49 mmol) of sodium metabisulfite (Na₂S₂O₅), and the solution was stirred at 25° C. for 2 days. It was diluted with water and extracted twice with ethyl acetate. The combined extracts were washed with water and brine, dried (MgSO₄), concentrated, and column chromatographed on silica gel using a gradient mixture of hexane and ethyl acetate as eluent to give 15 mg (85% yield) of compound 43, whose ¹H and ¹³C NMR spectra were identical to the authentic sample mentioned above. Notably, the spectral data are different from those reported for the 70-hydroxy isomer, which derived from the NaBH₄ reduction of N-acetyl-7-oxo-dehydroabietylamine (44).

Oxidation of alcohol 43 with IBX and DMSO giving ketone 44. To a solution of 10 mg (0.029 mmol) of alcohol 43 in 1 mL of DMSO under argon was added 16 mg (0.058 mmol) of IBX. The solution was stirred at 25° C. for 3 h, diluted with water, and extracted twice with ethyl acetate. The combined extracts were washed with water and brine, dried (MgSO₄), concentrated, and column chromatographed on silica gel using a gradient mixture of hexane and ethyl acetate as eluent to give 7 mg (70% yield) of ketone 44, whose spectral data are identical to those described above. Similarly, oxidation of 43 (0.029 mmol) with 0.5 mol % of Pd/Au-PVP and 1.5 equiv. (0.045 mmol) of t-BuOOH in acetonitrile and H₂O gave ketone 44.

9-Allogibberic acid (46). A solution of 2.50 g (7.21 mmol) of (+)-gibberellic acid (from Chem-Impex International Inc.) in 25 mL of 1.2 M HCl was stirred at 65° C. for 12 h. White solids (desired product) precipitated out during the reaction. The mixture was cooled to 25° C., filtered, and washed with cold water (75 mL). The solids were dried under vacuum to give 1.74 g of crude product, which was subjected to silica gel column chromatography using a gradient mixture of hexane and ethyl acetate as eluents to give 1.20 g (59% yield) of compound 46: m.p. 192-194° C.; [α]²²_{D}=−88.5 (c 0.94, MeOH); ¹H NMR δ 7.15 (t, J=7.6 Hz, 1H), 7.03 (d, J=7.6 Hz, 1H), 6.94 (d, J=7.6 Hz, 1H), 5.04 (s, 1H, ═CH₂), 4.79 (s, 1H, ═CH₂), 4.01 (s, 1H, C6H), 2.86 (dd, J=12, 4.4 Hz, 1H, C9H), 2.33-2.25 (m, 2H), 2.28 (s, 3H, CH₃), 2.16 (dd, J=19.6, 2 Hz, 1H), 2.02-1.90 (m, 2H), 1.78-1.71 (m, 1H), 1.67-1.56 (m, 2H); ¹³C NMR δ 176.0, 153.7, 144.5, 137.8, 135.2, 129.1, 127.6, 119.8, 103.7, 80.8, 54.4, 53.4, 52.2, 48.4, 39.4, 34.2, 22.0, 20.0. MS (ESI, MeOH): m/z=285.47 (M+H⁺), 284.83 (M⁺; 100%). HRMS-ESI: m/z [M+H]⁺ calcd for C₁₈H₂₁O₃⁺: 285.1491, found: 285.1314. Compound 46 crystallized from diethyl ether to give single crystals, whose structure was determined by a single-crystal X-ray analysis (FIG. 4) and S configuration at C9 was established.

Oxidation of (−)-46. Formation of lactone 47 and 6-oxo-9-allogibberic acid (48). To a solution of 0.50 g (1.76 mmol) of 46 in 17 mL of acetonitrile were added 5.25 mL (0.052 mmol) of Pd/Au/PVP (10 mM in water) and 0.37 mL (2.62 mmol, 1.5 equiv.) of t-BuOOH. The solution was stirred at 70° C. for 48 h, cooled to 25° C., diluted with 50 mL of water and 5 mL of aqueous Na₂S₂O₅, adjusted to pH ˜3 with 1N HCl, and extracted five times with ethyl acetate. The combined organic layer was washed with water and brine, dried (MgSO₄), concentrated, and column chromatographed on silica gel using a gradient mixture of hexane, diethyl ether, and ethyl acetate as eluents to give 80 mg (16% yield) of compound 47 and 25 mg (5% yield) of compound 48 along with 0.19 g (38% recovery) of 46. Compound 47: m.p. 155-156° C.; [α]²²_{D}=−33.5 (c 0.9, CHCl₃); ¹H NMR δ 7.22 (t, J=7.6 Hz, 1H), 7.09 (d, J=7.6 Hz, 1H), 7.02 (d, J=7.6 Hz, 1H), 5.44 (d, J=2 Hz, 1H, ═CH₂), 5.35 (d, J=2 Hz, 1H, ═CH₂), 4.53 (s, 1H, C15H), 3.97 (s, 1H, C6H), 3.07 (dd, J=12, 5.6 Hz, 1H, C9H), 2.44 (s, 3H, CH₃), 2.35 (dtd, J=13.6, 5.6, 1.6 Hz, 1H), 2.20 (dd, J=10.8, 2.8 Hz, 1H), 2.03 (td, J=12.8, 5.6 Hz, 1H), 1.93 (dd, J=10.4, 1.2 Hz, 2H), 1.87-1.80 (m, 1H), 1.44 (qd, J=12.8, 5.6 Hz, 1H); ¹³C NMR δ 174.9, 150.7, 144.4, 137.5, 134.7, 129.8, 128.9, 121.3, 111.6, 81.9, 81.8, 56.6, 52.9, 47.9, 43.8, 38.4, 23.1, 19.4. MS (ESI, MeOH): m/z=283.067 (M+H⁺, 100%). HRMS-ESI: m/z [M+H]⁺ calcd for C₁₈H₁₉O₃⁺: 283.1334, found: 283.1336. Recrystallization of 47 in ethyl acetate and hexane gave single crystals, whose structure was solved by a single-crystal x-ray analysis (FIG. 6). Compound 48: m.p. 111-113° C.; [α]²²_{D}=−10.5 (c 0.82, CHCl₃); IR (neat) v 3525, 2928, 2850, 1695, 1652, 1205, 1100, 890 cm⁻¹; ¹H NMR δ 7.42 (t, J=7.2 Hz, 1H), 7.18 (d, J=7.2 Hz, 1H), 7.10 (d, J=7.2 Hz, 1H), 5.06 (t, J=2.8 Hz, 1H, ═CH₂), 4.80 (t, J=2.8 Hz, 1H, ═CH₂), 3.08 (dd, J=13, 4.8 Hz, 1H, C9H), 2.60 (s, 3H, CH₃), 2.47 (dt, J=17.6, 2.8 Hz, 1H), 2.34 (s, 1H), 2.32 (s, 1H), 2.16 (d, J=17.6 Hz, 1H), 1.99 (td, J=12.4, 4.8 Hz, 1H), 1.85-1.67 (m, 3H); ¹³C NMR δ 207.0, 153.3, 152.8, 139.1, 134.5, 133.9, 129.6, 121.3, 103.5, 81.7, 56.7, 47.1, 44.7, 40.4, 39.9, 21.7, 18.4. MS (ESI, MeOH): m/z=255.10 (M+H⁺). HRMS-ESI: m/z [M+H]⁺ calcd for C₁₇H₁₉O₂⁺: 255.1380, found: 255.1397.

Similarly, treatment of 46 (0.35 mmol) with 1 mol % of Pd/Au-PVP (40K) in DMF (25 mM) and 1.5 equiv. (0.53 mmol) of t-BuOOH at 70° C. for 48 h gave 10% yield of 47, 3% yield of 48, and 32% recovery of 46. Oxidation of 46 (0.35 mmol) with 1 mol % of Pd/Au-1S in DMF (25 mM) and 1.5 equiv. (0.53 mmol) of t-BuOOH at 70° C. for 48 h gave 24% yield of 47, 4% yield of 48, and 30% recovery of 46. Oxidation of 46 (0.35 mmol) with 1 mol % of Pd/Au-1R in DMF (25 mM) and 1.5 equiv. (0.53 mmol) of t-BuOOH at 70° C. for 48 h gave 54% yield of 47 and 15% yield of 48.

Oxidation of indane-1-carboxylic acid (49). Formation of 1-indanone (50). To a solution of 50 mg (0.31 mmol) of 49 in 0.26 mL of acetonitrile were added 0.13 mL (31 μmol) of Pd/Au/PVP (25 mM in water) and 60 μL (0.47 mmol) of t-BuOOH. The solution was stirred at 50° C. for 24 h, cooled to 25° C., diluted with 10 mL of water and 2 mL of aqueous Na₂S₂O₅, and extracted twice with diethyl ether. The combined organic layer was washed with water and brine, dried (MgSO₄), concentrated, and column chromatographed on silica gel using a gradient mixture of hexane and diethyl ether as eluents to give 15 mg (40% yield) of compound 50 and 20 mg (45% recovery) of compound 49. Compound 50: ¹H NMR δ 7.79 (d, J=7.6 Hz, 1H), 7.62 (t, J=7.6 Hz, 1H), 7.51 (d, J=7.5 Hz, 1H), 7.38 (J=7.6 Hz, 1H), 3.18 (t, J=6 Hz, 2H), 2.73 (t, J=6 Hz, 2H); ¹³C NMR δ 207.1, 155.2, 137.3, 134.6, 127.2, 126.5, 123.6, 36.3, 25.8. The spectral data is in agreement with that obtained from commercial 1-indanone.

Oxidation of (+)-sclareolide (17) with Cu Au-1R and 30% H₂O₂. Formation of 2S-2-hydroxy-sclareolide (51), 2-oxo-sclareolide (52), and 1-oxo-sclareolide (53). In a sealable tube, 1.00 g (4 mmol) of (+)-sclareolide (17) and 16.5 mL of CH₃CN were placed. To it were added 8 mL (0.2 mmol, 5 mol %) of 25 mM Cu/Au/1R and 18 mL (0.16 mol; 40 equiv.) of 30% H₂O₂. The resulting solution was stirred at 90° C. for 6 days, cooled to 25° C., diluted with 10% sodium thiosulfate, acidified with 1N HCl, and extracted three times with 100 mL each of ethyl acetate. The combined extracts were washed with water and brine, dried (MgSO₄), concentrated, and column chromatographed on silica gel using a gradient mixture of hexane and ethyl acetate as eluents to give 0.117 g (11% yield) of 51, 84 mg (8% yield) of 52, 42 mg (4% yield) of 53 and 0.57 g (57% recovery) of 17.

(+)-2S-2-Hydroxysclareolide (51): [α]_{D}²²=+33.2 (c 0.025, CHCl₃). ¹H NMR δ 4.02 (tt, J=15.6, 4.4 Hz, 1H), 2.80 (s, 1H, OH), 2.47 (dd, J=16.4, 14.8 Hz, 1H), 2.29 (dd, J=16.4, 6.4 Hz, 1H), 2.12 (dt, J=12, 3.2 Hz, 1H), 2.03 (dd, J=14.8, 6.8 Hz, 1H), 1.94 (dq, J=14.4, 3.2 Hz, 1H), 1.89-1.83 (m, 2H), 1.72 (td, J=12.8, 4.4 Hz, 1H), 1.45-1.37 (m, 1H), 1.36 (s, 3H), 1.27-1.25 (m, 1H), 1.19 (t, J=12.4 Hz, 1H), 1.10 (dd, J=12.8, 2.8 Hz, 1H), 0.99 (s, 3H), 0.98 (s, 3H), 0.91 (s, 3H); ¹³C NMR δ 176.4, 86.0, 64.4, 58.9, 56.2, 51.4, 48.4, 38.5, 37.4, 34.8, 33.2, 28.7, 21.8, 21.7, 20.2, 16.2. MS (ESI, MeOH): m/z=289.731 (M+Na⁺). The spectral data is in agreement with those reported.

2-Oxosclareolide (52): [α]_{D}²²=+16.5 (c 0.026, CHCl₃) {Lit. [α]_{D}²³+44.3° (c 0.5, CHCl₃)}. ¹H NMR δ 2.51-2.43 (m, 1H), 2.35-2.15 (m, 7H), 2.07-2.01 (m, 1H), 1.82 (td, J=12.4, 4 Hz, 1H), 1.71 (dd, J=12.4, 2.8 Hz, 1H), 1.59-1.45 (m, 1H), 1.38 (s, 3H), 1.12 (s, 3H), 0.95 (s, 6H); ¹³C NMR δ 209.2, 175.6, 85.6, 58.3, 56.6, 55.7, 55.0, 40.4, 38.7, 38.1, 33.3, 28.6, 22.6, 21.2, 20.8, 16.2. MS (ESI, MeOH): m/z=265.0 (M+H⁺; 100%). The spectral data is in agreement with those reported.

1-Oxosclareolide (53): m.p. 143-145° C.; [α]_{D}²²=+10.7 (c 0.012, CHCl₃). ¹H NMR δ 2.99 (dd, J=16.8, 6.4 Hz, 1H), 2.70 (ddd, J=14.4, 9.2, 4.8 Hz, 1H), 2.56 (dd, J=16.8, 14 Hz, 1H), 2.31 (ddd, J=13.2, 8.4, 4.8 Hz, 1H), 2.17 (dd, J=14, 6.4 Hz, 1H), 2.11 (dt, J=8.8, 2.8 Hz, 1H), 1.95-1.83 (m, 2H), 1.72-1.61 (m, 2H), 1.55-1.54 (m, 1H), 1.37 (s, 3H), 1.22 (s, 3H), 1.08 (s, 3H), 1.04 (s, 3H), 0.91-0.85 (m, 1H); ¹³C NMR δ 214.2, 176.8, 85.7, 53.8, 52.0, 49.7, 39.2, 37.7, 34.5, 32.4, 31.3, 30.8, 23.2, 21.8, 21.1, 14.4. MS (ESI, MeOH): m/z=265.309 (M+H⁺; 86%). The spectral data is in agreement with those reported.

Similarly, treatment of 17 (0.40 mmol) with 5 mol % of Cu/Au-PVP (40K) in H₂O (25 mM) and 40 equiv. (16 mmol) of 30% H₂O₂ at 90° C. for 6 days gave 10% yield of 51, 8% yield of 52, 3% yield of 53, and 55% recovery of 17. Oxidation of 17 (0.40 mmol) with 5 mol % of Cu/Au-1S in H₂O (25 mM) and 40 equiv. (16 mmol) of 30% H₂O₂ at 90° C. for 6 days gave 2% yield of 51, 1% yield of 52, and 81% recovery of 17.

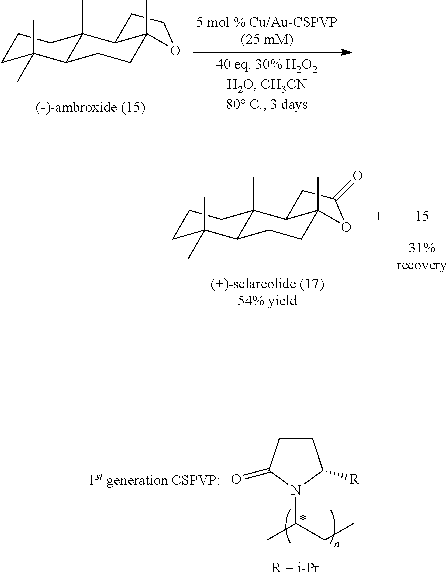

Oxidation of (−)-ambroxide (15) with 5 mol % Cu Au-1^{st} generation CSPVP (R=i-Pr) (25 mM) and 20 equiv. of 30% H₂O₂. Formation of (+)-sclareolide (17). To a sealable tube, 50 mg (0.21 mmol) of (−)-ambroxide (15) and 0.3 mL of acetonitrile were placed. To it, 0.42 mL of (−)-Cu/Au (3:1)-1st generation CSPVP (R=i-Pr) (10.5 μmol; 5 mol %; 25 mM in water) and 0.94 mL (8.4 mmol; 40 equiv.) of 30% H₂O₂ were added. The resulting solution was stirred at 80° C. for 3 days, cooled to 25° C., diluted with 10% sodium thiosulfate, acidified with 1N HCl, and extracted three times with 20 mL each of ethyl acetate. The combined extracts were washed with water and brine, dried (MgSO₄), concentrated, and column chromatographed on silica gel using a gradient mixture of hexane and ethyl acetate as eluents to give 29 mg (54% yield) of 17 and 15.5 mg (31% recovery) of 15.

1. A method of synthesizing a chiral substituted polyvinylpyrrolidinone compound, the method comprising reacting L-(S)-malic acid to produce a chiral vinyl lactam and polymerizing the chiral vinyl lactam to produce the chiral substituted polyvinylpyrrolidinone compound.

2. The method of claim 1, wherein the reacting comprises:
(i) reacting the L-(S)-malic acid to produce a lactone compound 12; and
(ii) reacting the lactone compound 12 to produce the chiral vinyl lactam.

3. The method of claim 2, wherein the reacting (i) comprises reacting the L-(S)-malic acid with 2,2,-dimethoxypropane and a catalytic amount of D-10-camphorsulfonic acid (CSA), followed by borane reduction, ring closure under acidic medium, and alkylation with chloromethyl methyl ether (MOMCl).

4. The method of claim 2, wherein the reacting (ii) comprising reacting the lactone compound 12 with sodium azide, followed by hydrogen reduction over palladium/carbon, annulation under sublimation conditions, and vinylation by n-butyl vinyl ether.

5. The method of claim 2, wherein the chiral vinyl lactam comprises a C3 substituted chiral vinyl lactam compound (−)-13.

6. The method of claim 1, wherein the chiral substituted polyvinylpyrrolidinone compound has the formula 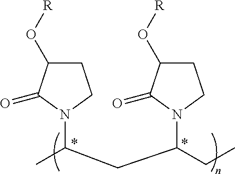
wherein each R is independently selected from OH, and aliphatic or aromatic functional groups, and n is greater than 50.

7. The method of claim 6, wherein the chiral substituted polyvinylpyrrolidinone compound has the formula 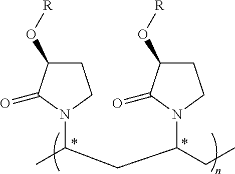
wherein each R is individually selected from the group consisting of OH and C1-C30 aliphatic and aromatic functional groups, and n is greater than 50.

8. The method of claim 7, wherein each R is CH₂OCH₃.

9. The method of claim 1, wherein the chiral substituted polyvinylpyrrolidinone compound has a molecular weight of at least 50,000 g/mol.

10. The method of claim 1, further comprising forming a complex comprising the chiral substituted polyvinylpyrrolidinone compound bound to a core species selected from the group consisting of nanoparticle materials, proteins, DNA, siRNA, and dsRNA.

11. The method of claim 10, wherein the complex comprises a nanoparticle cluster.

12. The method of claim 11, wherein the nanoparticle cluster comprises one or more metals selected from the group consisting of Au, Pd, Cu, Rh, Ce, Mo, Ni, Ru, W, and Fe.

13. The method of claim 12, wherein the nanoparticle cluster is bimetallic.

14. The method of claim 13, wherein the bimetallic nanoparticle cluster is selected from the group consisting of Pd/Au, Cu/Au, Rh/Au, Ce/Au, Mo/Au, W/Au, Ru/Au, and Fe/Au.

15. The method of claim 11, wherein the nanoparticle cluster is produced by one or more of molecular beams, chemical reduction, thermal decomposition of transition metal complexes, ion implantation, electrochemical synthesis, radiolysis, sonochemical synthesis, and/or biosynthesis.

16. The method of claim 11, wherein the nanoparticle cluster has diameter of about 1 to about 10 nm.

17. The method of claim 10, wherein the complex does not degrade at reaction temperatures of at least 50° C. for a period of 2 days.

18. The method of claim 10, wherein the complex exhibits a shelf-life at room temperature of at least 6 months.

19. A method of producing an oxidized product by contacting a bioactive natural material with a catalyst comprising the bimetallic nanoparticle cluster formed according to the method of claim 14.

20. The method of claim 19, wherein the bioactive natural material is selected from the group consisting of ambroxide, menthofuran, boldine, adamantanol, N-acetyl-amantadine, N-acetyl-memantine, 3-O-pivaloyl estrone, N-acetyl-dehydroabietylamine, 9-allogivveric acid, and indane-1-carboxylic acid.
